(19) United States
(12) Patent Application Publication
(10) Pub. No.: US 2015/0178823 A1
(43) Pub. Date: Jun. 25, 2015

(54) INFORMATION PROCESSING SYSTEM, INFORMATION PROCESSING METHOD, INFORMATION PROCESSING APPARATUS, AND CONTROL METHOD AND CONTROL PROGRAM OF INFORMATION PROCESSING APPARATUS

(71) Applicant: NEC Corporation, Minato-ku, Tokyo (JP)

(72) Inventors: Rie Tanaka, Tokyo (JP); Taku Konishi, Minato-ku (JP); Shinichi Doi, Minato-ku (JP); Satoko Itaya, Minato-ku (JP)

(21) Appl. No.: 14/414,160

(22) PCT Filed: Jun. 19, 2013
(86) PCT No.: PCT/JP2013/066820

§ 371 Date: Jan. 12, 2015

(30) Foreign Application Priority Data
Jul. 12, 2012 (JP) 2012-156934

(51) Int. Cl. G06Q 30/08; G06Q 10/08

(52) U.S. Cl. CPC G06Q 30/08; G06Q 10/087

(57) ABSTRACT

An apparatus of this invention is directed to an information processing apparatus that auctions and delivers merchandise in consideration of quality degradation caused by delivery of the merchandise, and implements both an increase in profit and an increase in delivery efficiency. The information processing apparatus includes a first receiver that receives the current position of merchandise from a communication terminal used for delivery of the merchandise, a first transmitter that transmits, to a communication terminal of each user, a reserve price representing the lower limit of a bid price according to prediction of quality degradation caused by delivery of the merchandise predicted based on a current position of each user and the received current position of the merchandise, a selector that receives bid prices for the merchandise from communication terminals of a plurality of users and selects a delivery destination candidate, and a second transmitter that transmits the selected delivery destination candidate to the communication terminal located at the current position of the merchandise.

### TECHNICAL FIELD

The present invention relates to a technique of managing physical distribution of merchandise whose quality changes along with the elapse of time.

### BACKGROUND ART

In the above technical field, patent literature 1 discloses a technique of, in flower auction, giving a discount on the highest bid price in accordance with the freshness of flowers at the time of contract. Also suggested is changing the start price depending on the freshness of flowers at the start to auction.

### CITATION LIST

### Patent Literature

Patent literature 1: Japanese Patent Laid-Open No. 2012-022524

### SUMMARY OF THE INVENTION

### Technical Problem

In the technique described in the above literature, however, freshness loss during delivery of flowers to the highest bidder cannot be reflected on auction.

The present invention enables to provide a technique of solving the above-described problem.

### Solution to Problem

One aspect of the present invention provides an information processing apparatus comprising:

a first receiver that receives a current position of merchandise from a communication terminal used for delivery of the merchandise;

a first transmitter that transmits, to a communication terminal of each user, a reserve price representing a lower limit of a bid price according to prediction of quality degradation caused by delivery of the merchandise predicted based on a current position of each user and the received current position of the merchandise;

a selector that receives bid prices for the merchandise from communication terminals of a plurality of users and selects a delivery destination candidate; and

a second transmitter that transmits the selected delivery destination candidate to the communication terminal located at the current position of the merchandise.

Another aspect of the present invention provides a control method of an information processing apparatus, comprising:

receiving a current position of merchandise from a communication terminal used for delivery of the merchandise;

transmitting, to a communication terminal of each user, a reserve price representing a lower limit of a bid price according to prediction of quality degradation caused by delivery of the merchandise predicted based on a current position of each user and the received current position of the merchandise;

receiving bid prices for the merchandise from communication terminals of a plurality of users and selecting a delivery destination candidate; and

transmitting the selected delivery destination candidate to the communication terminal located at the current position of the merchandise.

Still other aspect of the present invention provides a control program of an information processing apparatus, which causes a computer to execute:

receiving a current position of merchandise from a communication terminal used for delivery of the merchandise;

transmitting, to a communication terminal of each user, a reserve price representing a lower limit of a bid price according to prediction of quality degradation caused by delivery of the merchandise predicted based on a current position of each user and the received current position of the merchandise;

receiving bid prices for the merchandise from communication terminals of a plurality of users and selecting a delivery destination candidate; and

transmitting the selected delivery destination candidate to the communication terminal located at the current position of the merchandise.

Still other aspect of the present invention provides an information processing apparatus comprising:

an acquirer that acquires a current position of merchandise under delivery;

a transmitter that sets a first reserve price representing a lower limit of a bid price in accordance with quality degradation of the merchandise caused by delivery, which is predicted based on a current position of each user and the acquired current position of the merchandise and transmits the first reserve price to a communication terminal of each user;

a selector that receives bid prices for the merchandise from communication terminals of a plurality of users and selects a delivery destination candidate based on the bid prices; and

a notifier that notifies the selected delivery destination candidate.

Still other aspect of the present invention provides a control method of an information processing apparatus, comprising:

acquiring a current position of merchandise under delivery;

setting a first reserve price representing a lower limit of a bid price in accordance with quality degradation of the merchandise caused by delivery, which is predicted based on a current position of each user and the acquired current position of the merchandise and transmitting the first reserve price to a communication terminal of each user;

receiving bid prices for the merchandise from communication terminals of a plurality of users and selecting a delivery destination candidate based on the bid prices; and

notifying the selected delivery destination candidate.

Still other aspect of the present invention provides a control program of an information processing apparatus, which causes a computer to execute:

acquiring a current position of merchandise under delivery;

setting a first reserve price representing a lower limit of a bid price in accordance with quality degradation of the merchandise caused by delivery, which is predicted based on a current position of each user and the acquired current position of the merchandise and transmitting the first reserve price to a communication terminal of each user;

receiving bid prices for the merchandise from communication terminals of a plurality of users and selecting a delivery destination candidate based on the bid prices; and

notifying the selected delivery destination candidate.

Still other aspect of the present invention provides an information processing system including communication terminals of a plurality of users, a communication terminal used for delivery of merchandise, and an information processing apparatus configured to manage delivery of the merchandise,

the information processing apparatus comprising:

a first receiver that receives a current position of the merchandise from the communication terminal used for delivery of the merchandise;

a first transmitter that transmits, to a communication terminal of each user, a reserve price representing a lower limit of a bid price according to prediction of quality degradation caused by delivery of the merchandise predicted based on a current position of each user and the received current position of the merchandise;

a selector that receives bid prices for the merchandise from the communication terminals of the plurality of users and selects a delivery destination candidate; and

a second transmitter that transmits the selected delivery destination candidate to the communication terminal located at the current position of the merchandise,

the communication terminal used for delivery of the merchandise comprising:

a third transmitter that transmits the current position of the merchandise to the information processing apparatus; and

a second receiver that receives the delivery destination candidate selected by the selector from the information processing apparatus, and

each of the communication terminals of the plurality of users comprising:

a third receiver that receives the set reserve price from the information processing apparatus; and

a fourth transmitter that transmits the bid price input by the user to the information processing apparatus.

Still other aspect of the present invention provides an information processing method of an information processing system including communication terminals of a plurality of users, a communication terminal used for delivery of merchandise, and an information processing apparatus configured to manage delivery of the merchandise,

the information processing apparatus comprising:

receiving a current position of the merchandise from the communication terminal used for delivery of the merchandise;

transmitting, to a communication terminal of each user, a reserve price representing a lower limit of a bid price according to prediction of quality degradation caused by delivery of the merchandise predicted based on a current position of each user and the received current position of the merchandise;

receiving bid prices for the merchandise from the communication terminals of the plurality of users and selecting a delivery destination candidate; and

a second transmitter configured to transmit the selected delivery destination candidate to the communication terminal located at the current position of the merchandise,

the communication terminal used for delivery of the merchandise comprising:

transmitting the current position of the merchandise to the information processing apparatus; and

receiving the delivery destination candidate selected by the selector from the information processing apparatus, and

each of the communication terminals of the plurality of users comprising:

receiving the set reserve price from the information processing apparatus; and

transmitting the bid price input by the user to the information processing apparatus.

Still other aspect of the present invention provides an information processing system including communication terminals of a plurality of users, and an information processing apparatus used for delivery of merchandise and configured to manage delivery of the merchandise,

the information processing apparatus comprising:

an acquirer that acquires a current position of the merchandise under delivery;

a transmitter that sets a first reserve price representing a lower limit of a bid price in accordance with quality degradation of the merchandise caused by delivery, which is predicted based on a current position of each user and the acquired current position of the merchandise and transmits the first reserve price to a communication terminal of each user;

a selector that receives bid prices for the merchandise from the communication terminals of the plurality of users and selects a delivery destination candidate based on the bid prices; and

a notifier that notifies the selected delivery destination candidate, and

each of the communication terminals of the plurality of users comprising:

a second receiver that receives the set reserve price from the information processing apparatus; and

a third transmitter that transmits the bid price input by the user to the information processing apparatus.

Still other aspect of the present invention provides an information processing method of an information processing system including communication terminals of a plurality of users, and an information processing apparatus used for delivery of merchandise and configured to manage delivery of the merchandise,

the information processing apparatus comprising:

acquiring a current position of the merchandise under delivery;

setting a first reserve price representing a lower limit of a bid price in accordance with quality degradation of the merchandise caused by delivery, which is predicted based on a current position of each user and the acquired current position of the merchandise and transmitting the first reserve price to a communication terminal of each user;

receiving the bid prices for the merchandise from the communication terminals of the plurality of users and selecting a delivery destination candidate based on the bid prices; and

notifying the selected delivery destination candidate, and

each of the communication terminals of the plurality of users comprising:

receiving the set reserve price from the information processing apparatus; and

transmitting the bid price input by the user to the information processing apparatus.

### Advantageous Effects of Invention

According to the present invention, since the auction and delivery of merchandise are done in consideration of quality degradation caused by delivery of the merchandise, both an increase in profit and an increase in delivery efficiency can be implemented.

### BRIEF DESCRIPTION OF DRAWINGS

FIG. 1 is a block diagram showing the arrangement of an information processing apparatus according to the first embodiment of the present invention;

FIG. 2A is a view for explaining the concept of an information processing system according to the second embodiment of the present invention;

FIG. 2B is a view for explaining delivery management in the information processing system according to the second embodiment of the present invention;

FIG. 2C is a view for explaining an auction participation area in the information processing system according to the second embodiment of the present invention;

FIG. 2D is a view for explaining a reserve price in the information processing system according to the second embodiment of the present invention;

FIG. 3 is a block diagram showing the arrangement of the information processing system according to the second embodiment of the present invention;

FIG. 4 is a sequence chart showing the operation procedure of the information processing system according to the second embodiment of the present invention;

FIG. 5 is a block diagram showing the functional arrangement of a cloud server according to the second embodiment of the present invention;

FIG. 6 is a block diagram showing the functional arrangement of user terminals according to the second embodiment of the present invention;

FIG. 7 is a block diagram showing the functional arrangement of a client terminal according to the second embodiment of the present invention;

FIG. 8A is a view showing the arrangement of a user registration DB according to the second embodiment of the present invention;

FIG. 8B is a view showing the arrangement of a client registration DB according to the second embodiment of the present invention;

FIG. 9 is a view showing the arrangement of a merchandise DB according to the second embodiment of the present invention;

FIG. 10 is a view showing the arrangement of a traffic information DB according to the second embodiment of the present invention;

FIG. 11 is a block diagram showing the hardware arrangement of the cloud server according to the second embodiment of the present invention;

FIG. 12 is a view showing the arrangement of a price setting table according to the second embodiment of the present invention;

FIG. 13 is a view showing the arrangement of a bid price table according to the second embodiment of the present invention;

FIG. 14 is a view for explaining the concept of a delivery destination candidate selection table according to the second embodiment of the present invention;

FIG. 15 is a view for explaining the concept of a merchandise quality table according to the second embodiment of the present invention;

FIG. 16 is a flowchart showing the processing procedure of the cloud server according to the second embodiment of the present invention;

FIG. 17A is a flowchart showing the procedure of price setting transmission processing according to the second embodiment of the present invention;

FIG. 17B is a flowchart showing a procedure of delivery destination candidate selection processing according to the second embodiment of the present invention;

FIG. 17C is a flowchart showing another procedure of delivery destination candidate selection processing according to the second embodiment of the present invention;

FIG. 18 is a block diagram showing the hardware arrangement of the user terminal according to the second embodiment of the present invention;

FIG. 19 is a flowchart showing the processing procedure of the user terminal according to the second embodiment of the present invention;

FIG. 20 is a block diagram showing the hardware arrangement of the client terminal according to the second embodiment of the present invention;

FIG. 21 is a view showing the arrangement of a operation management table according to the second embodiment of the present invention;

FIG. 22 is a flowchart showing the processing procedure of the client terminal according to the second embodiment of the present invention;

FIG. 23 is a flowchart showing the procedure of price setting transmission processing according to the third embodiment of the present invention;

FIG. 24 is a flowchart showing the procedure of price setting transmission processing according to the fourth embodiment of the present invention;

FIG. 25A is a view for explaining the concept of an information processing system according to the fifth embodiment of the present invention;

FIG. 25B is a view for explaining delivery management in the information processing system according to the fifth embodiment of the present invention;

FIG. 25C is a view for explaining an auction participation area in the information processing system according to the fifth embodiment of the present invention;

FIG. 25D is a view for explaining the concept of a bid price table according to the fifth embodiment of the present invention;

FIG. 26 is a sequence chart showing the operation procedure of the information processing system according to the fifth embodiment of the present invention;

FIG. 27 is a block diagram showing the functional arrangement of a cloud server according to the fifth embodiment of the present invention;

FIG. 28A is a view showing the arrangement of a merchandise request DB according to the fifth embodiment of the present invention;

FIG. 28B is a view showing the arrangement of a merchandise management DB according to the fifth embodiment of the present invention;

FIG. 29 is a flowchart showing the processing procedure of the cloud server according to the fifth embodiment of the present invention;

FIG. 30A is a view for explaining the concept of a time zone in an information processing system according to the sixth embodiment of the present invention;

FIG. 30B is a view for explaining the concept of a price setting table according to the sixth embodiment of the present invention;

FIG. 31 is a block diagram showing the functional arrangement of a cloud server according to the sixth embodiment of the present invention;

FIG. 32A is a view showing the arrangement of the price setting table according to the sixth embodiment of the present invention;

FIG. 32B is a view for explaining the concept of the price setting table according to the sixth embodiment of the present invention;

FIG. 33 is a flowchart showing the processing procedure of the cloud server according to the sixth embodiment of the present invention;

FIG. 34 is a flowchart showing the procedure of price setting transmission processing according to the sixth embodiment of the present invention;

FIG. 35 is a view for explaining the concept of an information processing system according to the seventh embodiment of the present invention;

FIG. 36 is a sequence chart showing the operation procedure of the information processing system according to the seventh embodiment of the present invention;

FIG. 37 is a block diagram showing the functional arrangement of a client terminal according to the seventh embodiment of the present invention;

FIG. 38 is a flowchart showing the processing procedure of the client terminal according to the seventh embodiment of the present invention;

FIG. 39 is a view for explaining the concept of an information processing system according to the eighth embodiment of the present invention;

FIG. 40A is a sequence chart showing the operation procedure of the information processing system according to the eighth embodiment of the present invention;

FIG. 40B is a sequence chart showing the operation procedure of the information processing system according to the eighth embodiment of the present invention;

FIG. 40C is a sequence chart showing the operation procedure of the information processing system according to the eighth embodiment of the present invention;

FIG. 41 is a block diagram showing the functional arrangement of a cloud server according to the eighth embodiment of the present invention;

FIG. 42 is a view showing the arrangement of a price transmission table according to the eighth embodiment of the present invention;

FIG. 43 is a flowchart showing the processing procedure of the cloud server according to the eighth embodiment of the present invention;

FIG. 44 is a flowchart showing the procedure of price setting transmission processing according to the eighth embodiment of the present invention;

FIG. 45 is a view for explaining the concept of an information processing system according to the ninth embodiment of the present invention;

FIG. 46 is a sequence chart showing the operation procedure of the information processing system according to the ninth embodiment of the present invention;

FIG. 47 is a block diagram showing the functional arrangement of a cloud server according to the ninth embodiment of the present invention;

FIG. 48 is a view showing the arrangement of a price standardization table according to the ninth embodiment of the present invention;

FIG. 49 is a flowchart showing the processing procedure of the cloud server according to the ninth embodiment of the present invention;

FIG. 50 is a flowchart showing the procedure of price setting transmission processing according to the ninth embodiment of the present invention;

FIG. 51 is a view for explaining the concept of an auction in an information processing system according to the 10th embodiment of the present invention;

FIG. 52 is a block diagram showing the functional arrangement of a cloud server according to the 10th embodiment of the present invention;

FIG. 53 is a view showing the arrangement of a price transmission table according to the 10th embodiment of the present invention;

FIG. 54 is a view showing the arrangement of a bid price table according to the 10th embodiment of the present invention;

FIG. 55A is a view for explaining the concept of an information processing system according to the 11th embodiment of the present invention;

FIG. 55B is a view for explaining a location condition in the information processing system according to the 11th embodiment of the present invention;

FIG. 56 is a block diagram showing the arrangement of the information processing system according to the 11th embodiment of the present invention;

FIG. 57 is a sequence chart showing the operation procedure of the information processing system according to the 11th embodiment of the present invention;

FIG. 58 is a block diagram showing the functional arrangement of a cloud server according to the 11th embodiment of the present invention;

FIG. 59 is a block diagram showing the functional arrangement of a user terminal according to the 11th embodiment of the present invention;

FIG. 60A is a view showing the arrangement of a price history DB according to the 11th embodiment of the present invention;

FIG. 60B is a view showing the arrangement of a quality history DB according to the 11th embodiment of the present invention;

FIG. 61 is a view showing the arrangement of a price/quality correspondence table according to the 11th embodiment of the present invention;

FIG. 62 is a flowchart showing the processing procedure of the cloud server according to the 11th embodiment of the present invention; and

FIG. 63 is a flowchart showing the procedure of location proposal processing according to the 11th embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Note that in this embodiment, “reserve price” is the lowest unit price of merchandise that allows each user to participate in the auction of it. “Profit” is an amount obtained by subtracting at least the cost price and the delivery expense (including labor cost, carbon tax, and the like) from “bid price”. “User” indicates a participant in an auction. On the other hand, “client” indicates a merchandise deliverer or a merchandise delivery company, which is the user of an auction system according to this embodiment.

Merchandise which causes quality degradation and to which this embodiment is applicable includes perishable foods and frozen foods such as fish and vegetables, delivery meals, living things such as animals and plants, chemical substances such as drugs, and other merchandise affected by environments such as temperature, humidity, and sunlight. Merchandise affected by delivery situations or environmental changes may also be included. The delivery situations can be, for example, road situations or vibrations caused by a train, ship, or airplane. In general, external causes that degrade the quality of merchandise are temperature, humidity, shock, light, wind, microorganisms, gases, and the like.

### First Embodiment

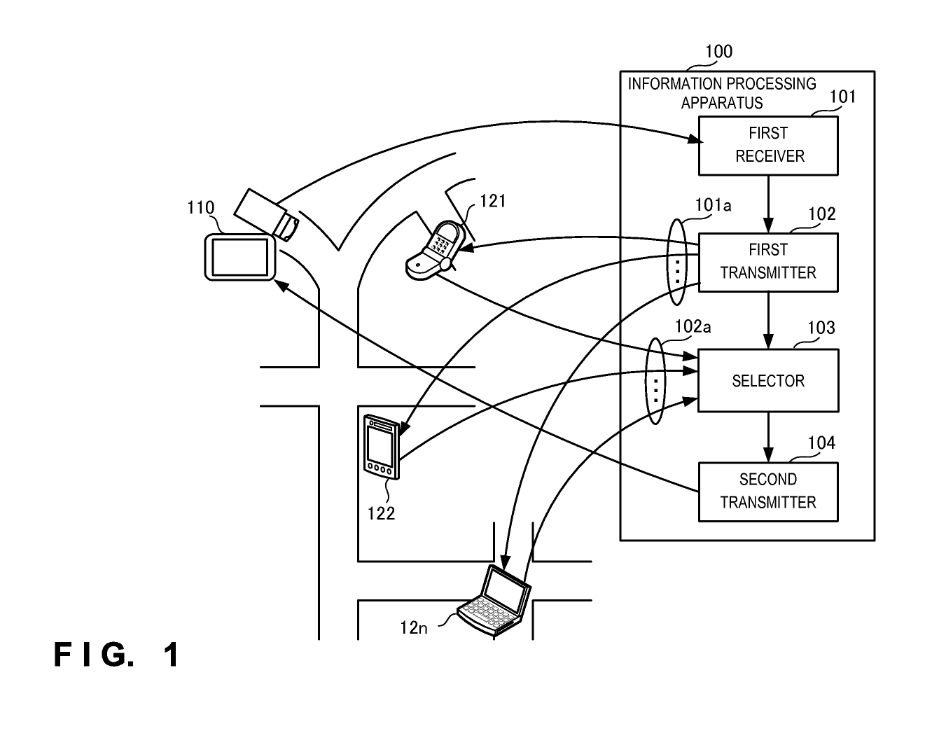

An information processing apparatus 100 according to the first embodiment of the present invention will be described with reference to FIG. 1. The information processing apparatus 100 is an apparatus that controls an auction of merchandise with quality degradation.

As shown in FIG. 1, the information processing apparatus 100 includes a first receiver 101, a first transmitter 102, a selector 103, and a second transmitter 104. The first receiver 101 receives the current position of merchandise from a communication terminal 110 used for merchandise delivery. The first transmitter 102 transmits, to communication terminals 121 to 12n of users, a reserve price 101a representing the lower limit of the bid price according to quality degradation predicted, based on the current position of each user and the received current position of the merchandise, to be caused by merchandise delivery. The selector 103 receives bid prices 102a of the merchandise from the communication terminals 121 to 12n of the plurality of users and selects a delivery destination candidate. The second transmitter 104 transmits the selected delivery destination candidate to the communication terminal 110 located at the current position of the merchandise.

According to this embodiment, since the auction and delivery of merchandise are done in consideration of quality degradation caused by delivery of the merchandise, both an increase in profit and an increase in delivery efficiency can be implemented.

### Second Embodiment

An information processing system according to the second embodiment of the present invention will be described next. In the information processing system according to this embodiment, a cloud server that is an information processing apparatus for managing merchandise delivery sets the reserve price of bidding in correspondence with the prediction of quality degradation caused by delivery from the current position of a merchandise delivery van that delivers merchandise, and notifies the communication terminals of a plurality of users of it. After that, the cloud server receives bid prices from the plurality of users and selects a delivery destination candidate to which the merchandise is delivered. The selected delivery destination candidate is notified to the communication terminal of the merchandise delivery van as needed, thereby managing merchandise delivery. When the merchandise is sold to the delivery destination candidate, the auction ends.

Note that there are various auction methods. In this embodiment, an example will be explained in which an auction continues during delivery of one piece of merchandise by a merchandise delivery van. When the one piece of merchandise is sold, the auction ends. However, the merchandise delivery is not limited to the merchandise delivery van. For example, the embodiment is also applicable or merchandise delivery or merchandise sale by man power.

According to this embodiment, since the auction and delivery of merchandise are done in consideration of quality degradation caused by delivery of the merchandise, both an increase in profit and an increase in delivery efficiency can be implemented while satisfying the user.

<<Explanation of Information Processing System>>

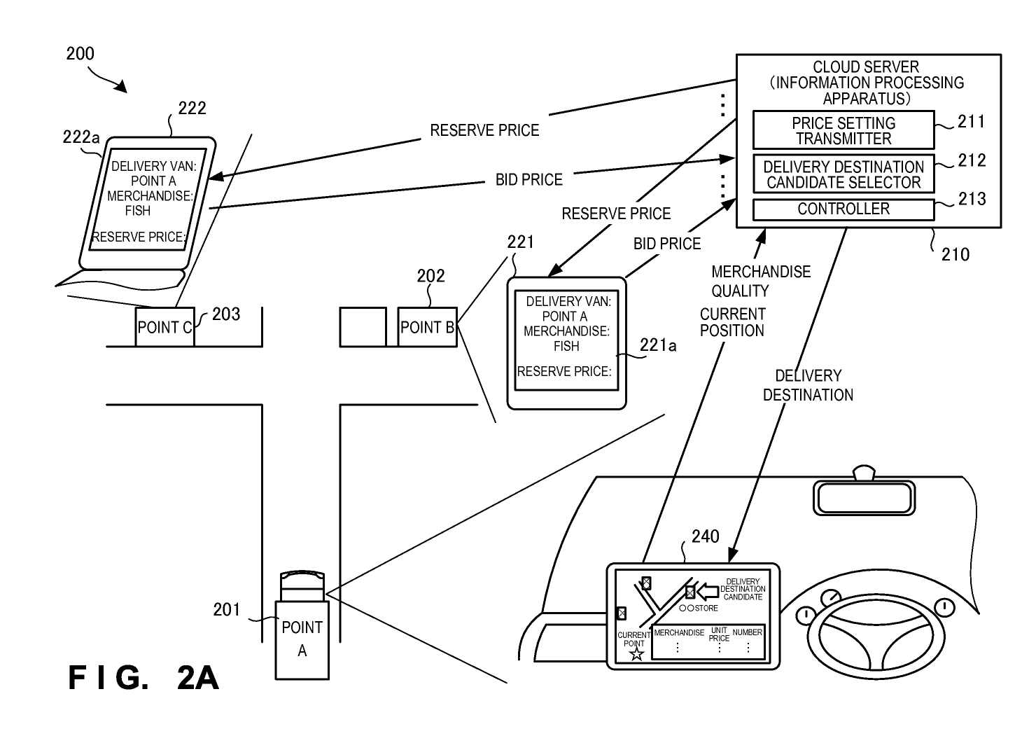

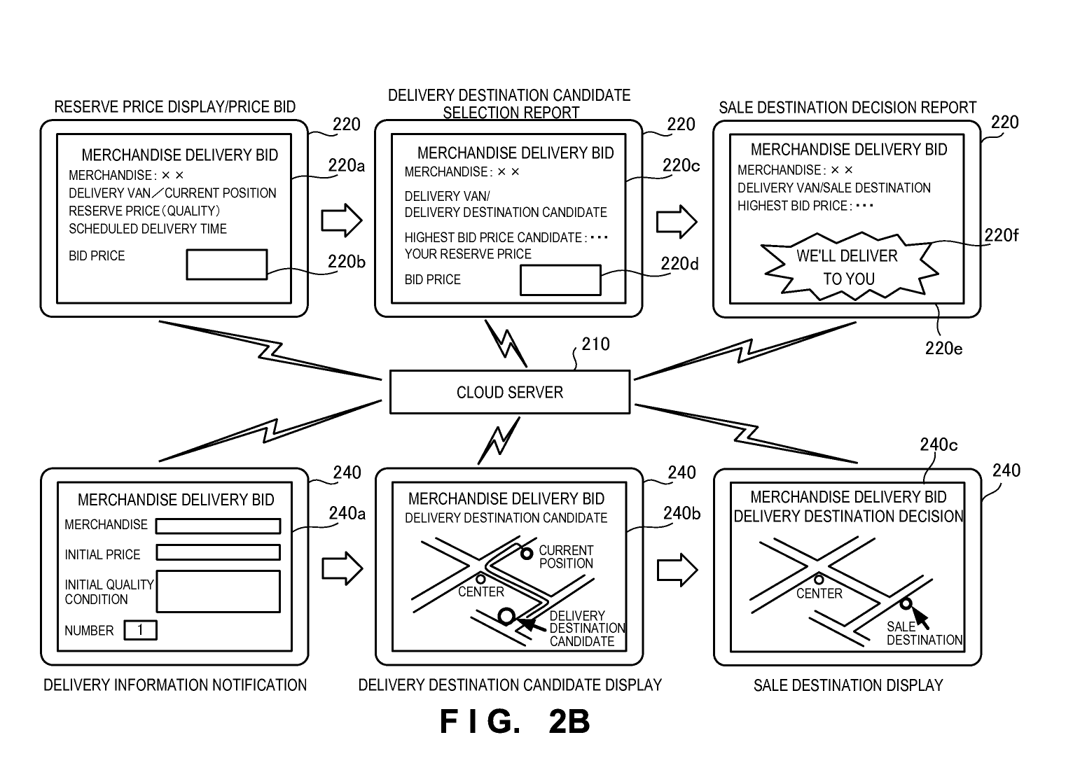

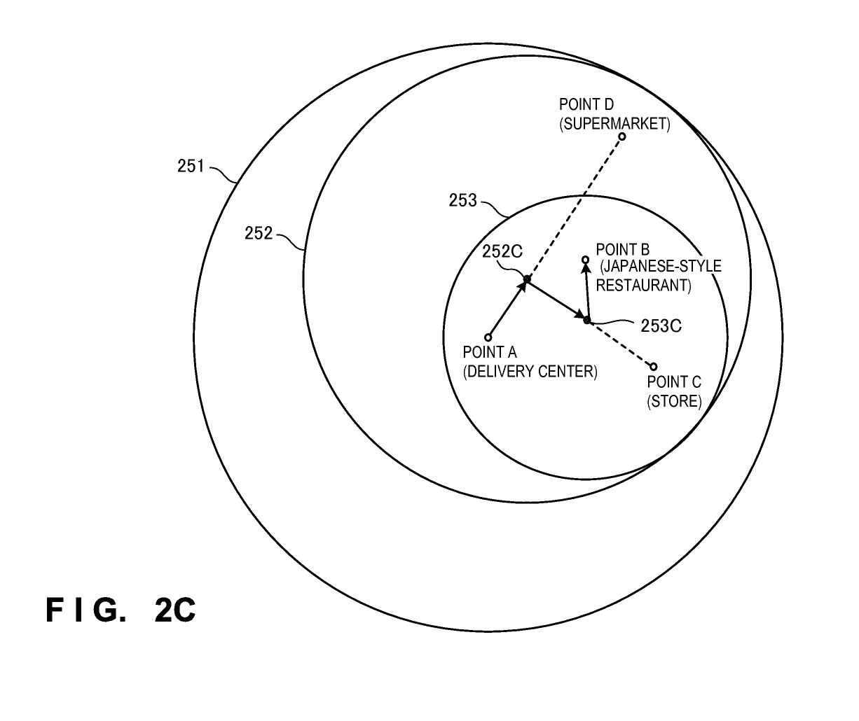

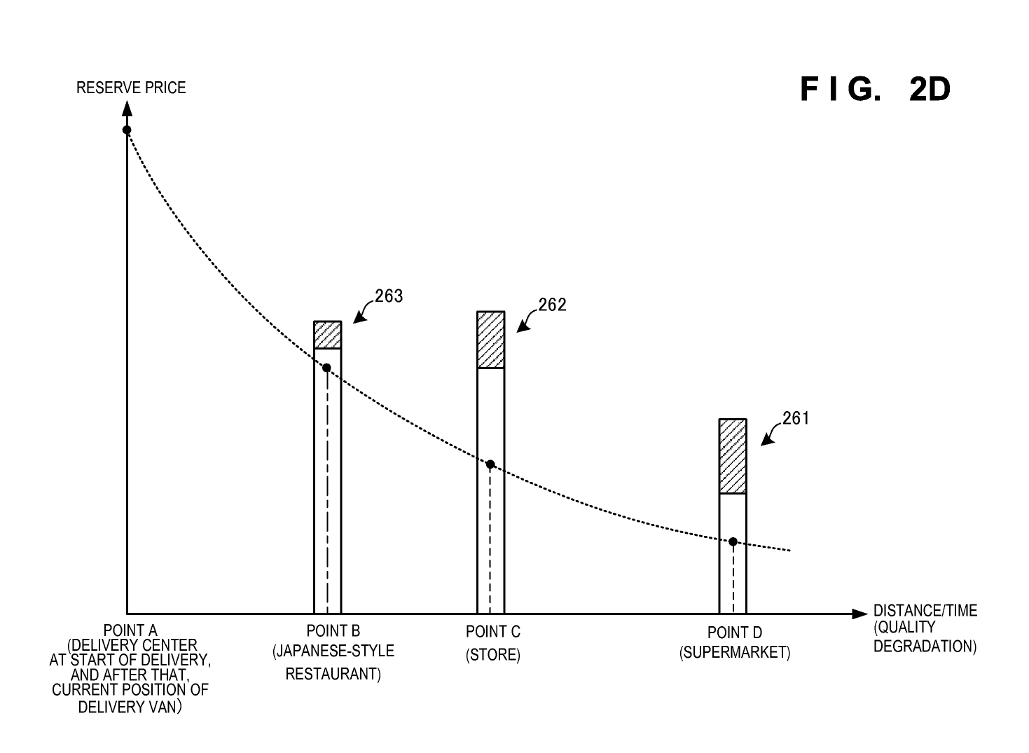

The information processing system according to this embodiment will be described with reference to FIGS. 2A to 2D.

(Explanation of Concept)

FIG. 2A is a view for explaining the concept of an information processing system 200 according to this embodiment.

FIG. 2A illustrates an example in which a merchandise delivery van departs from a point A 201 and delivers merchandise “fish” to users. The users exist at a point B 202 and a point C 203. The user at the point B 202 participates, via a user terminal 221, in the bid to purchase the fish delivered by the merchandise delivery van. The user at the point C 203 participates, via a user terminal 222, in the bid to purchase the fish delivered by the merchandise delivery van. The merchandise delivery van is equipped with a client terminal 240. The client terminal 240 navigates the merchandise delivery van to the delivery destination.

When the bid starts, a controller 213 of a cloud server 210 serving as an information processing apparatus predicts quality degradation upon delivery to the point B 202 or the point C 203 using the quality (freshness of fish) of the fish as the merchandise at the point A 201 as a reference. A price setting transmitter 211 of the cloud server 210 sets the reserve price of the bid corresponding to the quality degradation in accordance with the position of each user, and transmits it to the user terminal 221. The reserve price at the point B 202 is transmitted to the user terminal 221 at the point B 202 and displayed on a display screen 221a. On the other hand, the reserve price at the point C 203 is transmitted to the user terminal 222 at the point C 203 and displayed on a display screen 222a. Note that in this embodiment, the reserve price is set as a predetermined price independently of the number or weight of merchandise. However, the present invention is not limited to this, and the cloud server 210 may set a reserve price considering the number or weight.

Each user transmits a bid price more than the reserve price to the cloud server 210. Note that the bid price corresponds to the product of the unit price of the merchandise and the number or weight of the merchandise. A delivery destination candidate selector 212 of the cloud server 210 collects the bid prices of the users, compares profits obtained by subtracting the merchandise cost price, delivery expense, labor cost, and the like, selects the user of highest profit as the delivery destination candidate, and notifies the client terminal 240 of the merchandise delivery van of it.

Referring to FIG. 2A, assume that the user terminal 221 presents the bid price of highest profit. The point B 202 is selected as the delivery destination candidate of the merchandise delivery van at the point A 201. The merchandise delivery van drives from the point A 201 to the point B 202. Assume that the user terminal 222 presents a bid price of larger profit on the way. If not arrived at the point B 202 yet, the merchandise delivery van changes the delivery destination candidate to the point C 203 and drives to the point C 203. This control is executed by the controller 213.

(Delivery Management)

FIG. 2B is a view for explaining delivery management in the information processing system 200 according to this embodiment. The upper stage of FIG. 2B shows an example of display of a user terminal 220 that participates in a bid. The lower stage of FIG. 2B shows an example of display of the client terminal 240 of a deliverer who delivers merchandise.

In the left view of the lower stage, the merchandise deliverer transmits, to the cloud server 210, a screen 240a of the start of delivery in which the information of merchandise to be delivered is input. The cloud server 210 sets a reserve price considering merchandise delivery and transmits a bid screen 220a including the reserve price to the user terminals 220, as shown in the left view of the upper stage. The bid screen is provided with an area 220b used to input a bid price.

The cloud server 210 collects the bid prices from the user terminals 220, selects the user of highest profit as the delivery destination candidate, and transmits, to the client terminal 240, a delivery destination candidate display screen 240b that shows the delivery route to the delivery destination candidate, as shown in the central view of the lower stage. At the same time, the cloud server 210 transmits a delivery destination candidate selection screen 220c including the delivery destination candidate to the user terminal 220 of each user who is participating in the auction. The delivery destination candidate selection screen 220c may include the highest bid price candidate. The delivery destination candidate selection screen 220c is provided with an area 220d used by the user to update the bid price.

Note that during the time the auction continues, the current highest bid price is displayed as the highest bid price candidate in the central view of the upper stage, and the user's bid is repeated. The central view of the lower stage displays the delivery destination candidate updated upon receiving presentation of a higher bid price.

As shown in the right view of the lower stage, if the merchandise delivery van arrives at the delivery destination candidate without a bid price of higher profit, information that decides the sale destination as the delivery destination candidate is transmitted from the client terminal 240 to the cloud server 210. The cloud server 210 transmits a bid result screen 220e including the highest bid price to the user terminal 220 of each user who is participating in the auction. In FIG. 2B, the user terminal 220 of a user who has made a successful bid also displays a message 220f “We'll deliver to you” representing that the highest bidder is the user. On the other hand, the user terminal 220 of a user whose bid has failed displays a message, for example, “Another person has made a successful bid” (not shown) representing that the highest bidder is not the user.

Note that in this embodiment, delivery starts using transmission of delivery information from the client terminal 240 as a trigger. However, the cloud server 210 may trigger the start of delivery based on a delivery history accumulated in the cloud server 210.

(Auction Participation Area)

FIG. 2C is a view for explaining an auction participation area in the information processing system 200 according to this embodiment.

Referring to FIG. 2C, a first auction participation area 251 represents an area having the point A (delivery center) as the center, in which the minimum quality of merchandise can be maintained. That is, it is an area that allows users to participate in an auction when the merchandise delivery van departs from the point A (delivery center). Note that the first auction participation area 251 becomes small if the quality has already degraded based on the elapsed time or environment until the merchandise delivery van departs from the point A (delivery center). For example, when merchandise is a perishable food, quality degradation at the time of departure changes depending on whether it has been placed in a freezer.

A second auction participation area 252 represents an area in which the minimum quality of merchandise can be maintained and which has, as the center, a halfway point 252C of the route of the merchandise delivery van from the point A (delivery center) to a point D (supermarket) that has transmitted the bid price of highest profit. That is, since the merchandise delivery van has already departed from the point A (delivery center) and moved up to the halfway point 252C, the merchandise quality degrades, and the second auction participation area 252 becomes smaller than the first auction participation area 251. Note that in FIG. 2C, the merchandise delivery van is assumed to have moved at a moving speed predicted when generating the first auction participation area 251. However, if a time more than predicted has elapsed due to, for example, a traffic jam, the second auction participation area 252 becomes smaller. On the other hand, for example, if the merchandise delivery van reaches the halfway point 252C via an expressway ahead of the predicted time, the second auction participation area 252 becomes larger. When the bid price of highest profit changes to the point C (store), the merchandise delivery van drives from the halfway point 252C to the point C (store).

A third auction participation area 253 represents an area in which the minimum quality of merchandise can be maintained and which has, as the center, a halfway point 253C of the route of the merchandise delivery van from the halfway point 252C to the point C (store). That is, since the merchandise delivery van has already departed from the point A (delivery center), and moved up to the halfway point 253C via the halfway point 252C, the merchandise quality further degrades, and the third auction participation area 253 becomes smaller than the second auction participation area 252. As for the size of the third auction participation area 253, the above description of the second auction participation area 252 applies. When the bid price of highest profit changes, at the halfway point 253C, to the point B (Japanese-style restaurant), the merchandise delivery van drives from the halfway point 253C to the point B (Japanese-style restaurant).

In the example of FIG. 2C, assume that since no bid price of higher profit is transmitted from any user terminal in the third auction participation area 253 until the merchandise delivery van arrives at the point B (Japanese-style restaurant), the merchandise delivery van arrives at the point B (Japanese-style restaurant) and sells the merchandise to the point B (Japanese-style restaurant). Note that the auction participation areas can be updated continuously as the merchandise delivery van moves or intermittently according to the moving distance, elapsed time, or the like. Alternatively, the auction participation areas may be updated when the delivery destination candidate changes. It is important to update the auction participation areas in accordance with the position of the merchandise delivery van and the event history after the departure as the merchandise delivery van moves. The updating method and the updating timing are not particularly limited.

(Reserve Price)

FIG. 2D is a view for explaining the reserve price in the information processing system 200 according to this embodiment.

As shown in FIG. 2D, the reserve price is the highest at the point A that is the current position of merchandise, and gradually lowers because quality degrades as the delivery distance or delivery time becomes long. For example, at the start of delivery, the point A is the delivery center. During delivery, the point A is the current position of the merchandise delivery van. Note that the curve of the reserve price shown in FIG. 2D is merely a schematic example and is not limited to this, although the reserve price gradually lowers. A curve corresponding to merchandise or environmental situations in the vicinity is used. Actually, the reserve price for the merchandise delivery van during delivery is lower than the reserve price at the delivery center by quality degradation caused by the delivery time or delivery distance.

FIG. 2D shows bid prices 263, 262, and 261 of the point B (Japanese-style restaurant), the point C (store), and the point D (supermarket). Each hatched portion represents a delivery expense including the labor cost, carbon tax, and the like. A user of highest price except the hatched portion is the delivery destination candidate. Referring to FIG. 2C, the point D (supermarket) presents the bid price 261, and the merchandise delivery van drives to the point D (supermarket). The point C (store) presents the bid price 262 at the halfway point 252C, and the merchandise delivery van drives to the point C (store). The point B (Japanese-style restaurant) presents the bid price 263 at the halfway point 253C, and the merchandise delivery van drives to the point B (Japanese-style restaurant). In this case, the bid price 262 is higher than the bid price 263. However, when subtracting the delivery expense, the bid price 263 is higher. Hence, the merchandise delivery van drives to the point B (Japanese-style restaurant). Note that an amount obtained by subtracting the delivery expense and the cost price (cost price does not change) from the bid price is profit.

<<Arrangement of Information Processing System>>

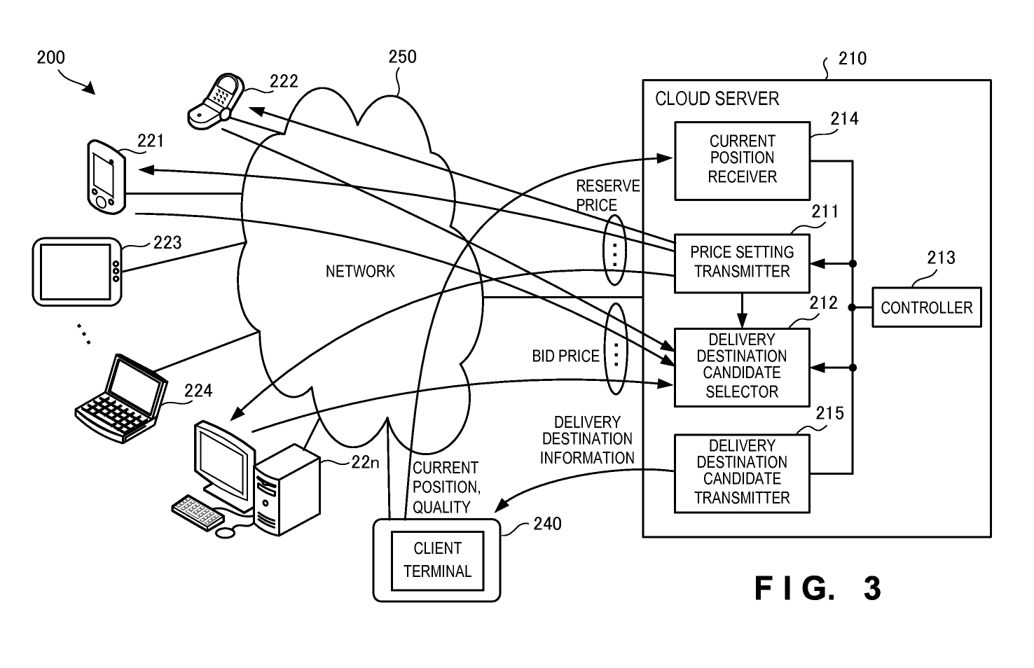

FIG. 3 is a block diagram showing the arrangement of the information processing system 200 according to this embodiment.

The information processing system 200 includes the cloud server 210, the user terminals 221 to 22n of a plurality of users who participate in a bid, and the client terminal 240 of the merchandise delivery van which are connected via a network 250.

The cloud server 210 includes a current position receiver 214 that receives the current position of the merchandise delivery van from the client terminal 240 of the merchandise delivery van. The cloud server 210 also includes the price setting transmitter 211 that sets a reserve price corresponding to predicted quality after delivery of merchandise and transmits it to the user terminals 221 to 22n. The cloud server 210 also includes the delivery destination candidate selector 212 that collects bid prices transmitted from the user terminals 221 to 22n and selects the user of highest profit as the delivery destination candidate. The cloud server 210 also includes a delivery destination candidate transmitter 215 that notifies the client terminal 240 of the delivery destination candidate. The cloud server 210 also includes the controller 213 that controls the functional components and manages an auction.

<<Operation Procedure of Information Processing System>>

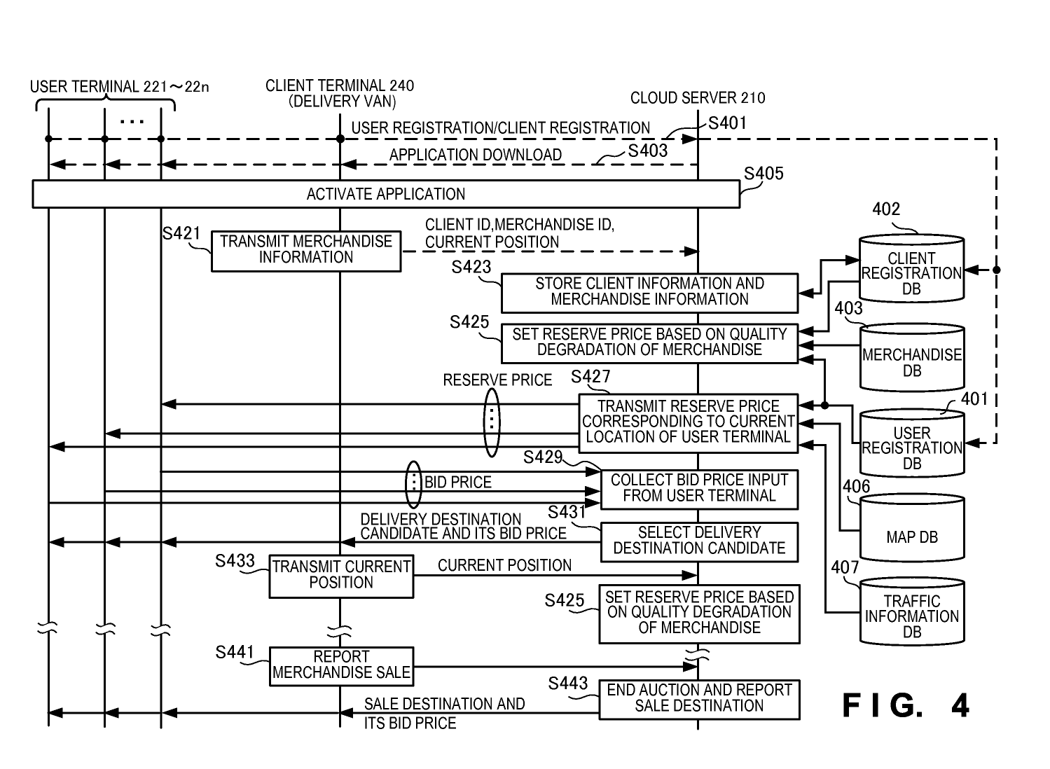

FIG. 4 is a sequence chart showing the operation procedure of the information processing system 200 according to this embodiment. In FIG. 4, after departure of the merchandise delivery van, an auction continues until one piece of merchandise is sold, and the auction ends. Note that the reserve price is changed as needed as the merchandise delivery van moves.

In step S401, the user terminals 221 to 22n of the users or the client terminal 240 of the merchandise delivery van transmits user information or client information to the cloud server 210. The cloud server 210 registers the users or client in a user registration DB 401 or client registration DB 402. In step S403, the cloud server 210 downloads an auction application according to this embodiment to the user terminals 221 to 22n and the client terminal 240. In step S405, the cloud server 210, the user terminals 221 to 22n, and the client terminal 240 activate the auction application.

In step S421, the client terminal 240 transmits, to the cloud server 210, the merchandise information of merchandise whose delivery is to start. The merchandise information includes a client ID, a merchandise ID, and the current position of the client terminal. In step S423, the cloud server 210 authenticates the client, and registers the current position.

In step S425, the cloud server 210 predicts degradation of merchandise based on the current position of the client (merchandise delivery van) by referring to merchandise degradation conditions and the like stored in a merchandise DB 403, and sets the reserve price of the auction with respect to the current position as the center using a map DB 406. In step S427, the cloud server 210 sets reserve prices corresponding to the current positions of the user terminals 221 to 22n and notifies them. Note that traffic situations such as a traffic jam in the delivery route or during delivery are preferably taken into consideration by referring to a traffic information DB 407.

In step S429, the cloud server 210 collects bid prices as a unit price more than the reserve price from the user terminals 221 to 22n. The bid price is a unit price more than the reserve price. In step S431, the cloud server 210 compares the collected bid prices in consideration of the delivery expense and the like, selects the user of highest profit as the delivery destination candidate, and transmits the delivery destination candidate and its bid price to the user terminals 221 to 22n and the client terminal 240. The user terminals 221 to 22n make new bids with reference to reception of the delivery destination candidate and the bid price. At the same time, the client (merchandise delivery van) drives to the selected delivery destination candidate. Note that the bid price of the delivery destination candidate need not always be transmitted.

In step S433, the client terminal 240 transmits the current position of the merchandise delivery van to the cloud server 210. In step S425, the cloud server 210 newly predicts degradation of the merchandise based on the new current position of the merchandise delivery van by referring to merchandise degradation conditions and the like stored in the merchandise DB 403, and sets the reserve price of the auction with respect to the current position as the center using the map DB 406. The same operation procedure as described above is continued until the merchandise delivery van reaches any one delivery destination candidate.

When the merchandise deliverer reaches the delivery destination candidate, the client terminal 240 transmits a report of merchandise sale to the cloud server 210 in step S441. In step S443, the cloud server 210 ends the auction and transmits an auction end and the sale destination that has made a successful bid to the client terminal 240 and the user terminals 221 to 22n.

<<Functional Arrangement of Cloud Server>>

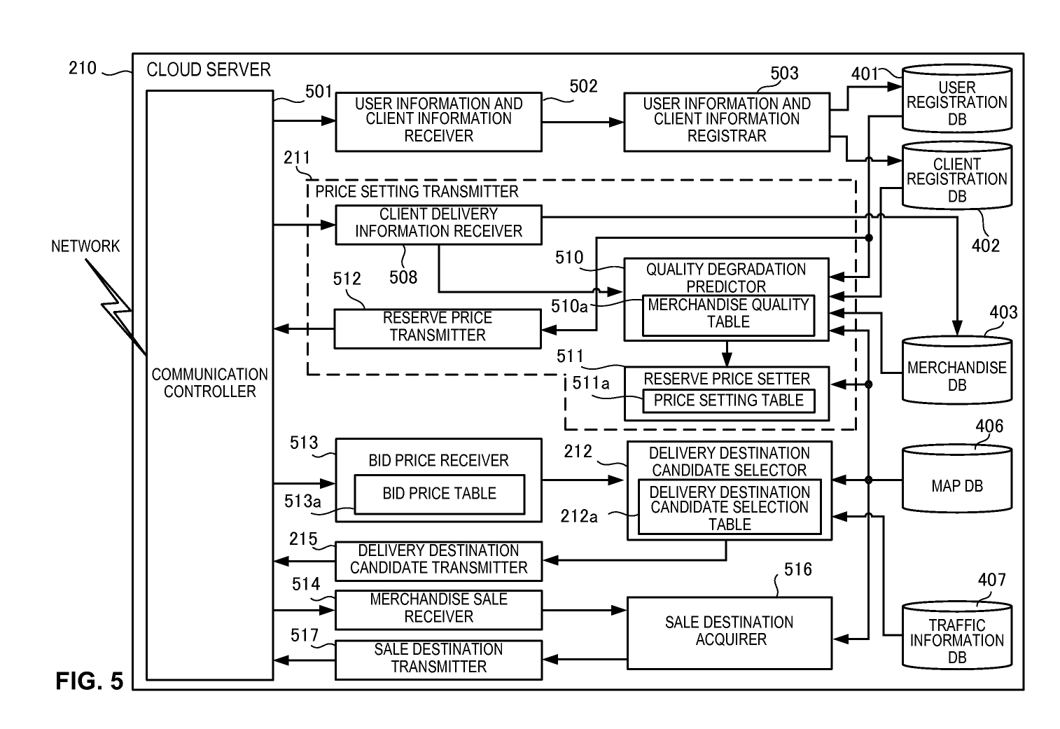

FIG. 5 is a block diagram showing the functional arrangement of the cloud server 210 according to this embodiment.

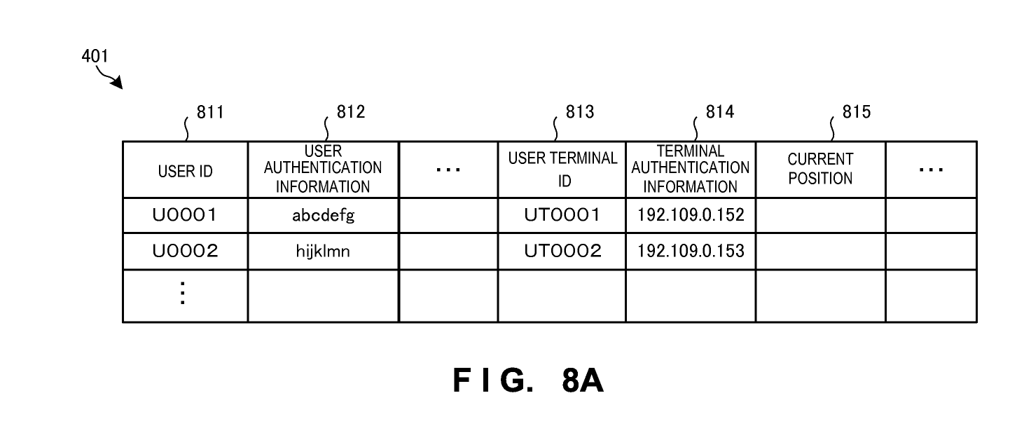

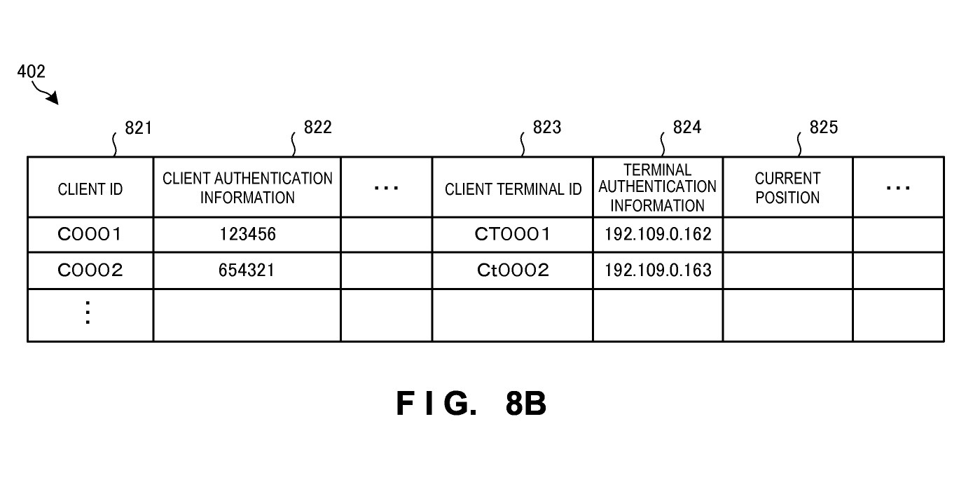

The cloud server 210 includes a communication controller 501 that communicates with the user terminal 220 or the client terminal 240 via the network 250. A user information and client information receiver 502 receives user information such as a user ID and authentication information and user terminal information such as a user terminal ID and authentication information from the user terminal 220 via the communication controller 501. The user information and client information receiver 502 also receives client information such as a client ID and authentication information and client terminal information such as a client terminal ID and authentication information from the client terminal 240 via the communication controller 501. A user information and client information registrar 503 registers the user in the user registration DB 401 based on the user information and the user terminal information (see FIG. 8A). The user information and client information registrar 503 also registers the client in the client registration DB 402 based on the client information and the client terminal information (see FIG. 8B).

The price setting transmitter 211 includes a client delivery information receiver 508, a quality degradation predictor 510, a reserve price setter 511, and a reserve price transmitter 512. The client delivery information receiver 508 receives information about merchandise to be delivered by the client (merchandise delivery van) from the client terminal 240 via the communication controller 501. The quality degradation predictor 510 includes a merchandise quality table 510a, and predicts merchandise quality at a position on the map by referring to the map DB 406 as well. The reserve price setter 511 includes a price setting table 511a, and sets a reserve price corresponding to the merchandise quality predicted at the position on the map. The reserve price transmitter 512 refers to the reserve price set at the position on the map, and transmits the reserve price of the bid at the current position of each user to the user terminal. Note that in an arrangement that detects data about quality of merchandise in real time, the cloud server is provided with a quality receiver (not shown) that receives quality associated information via the communication terminal of the merchandise delivery van or directly from a sensor.

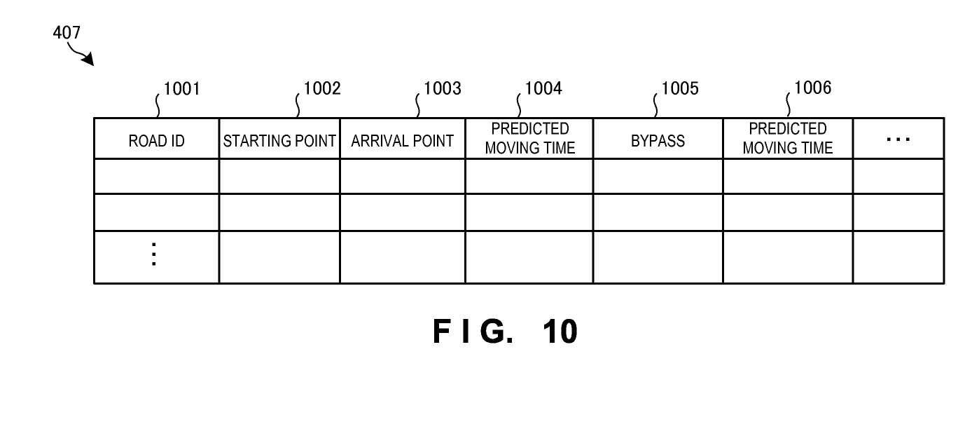

A bid price receiver 513 includes a bid price table 513a, and receives a bid price from each user terminal 220 via the communication controller 501. The delivery destination candidate selector 212 includes a delivery destination candidate selection table 212a, and selects the user of highest bid price as the delivery destination candidate in consideration of the delivery expense and the like. The delivery expense is calculated by referring to the map DB 406 or the traffic information DB 407 (see FIG. 10). A delivery destination candidate transmitter 215 transmits the selected delivery destination candidate to the user terminal 220 and the client terminal 240 via the communication controller 501.

A merchandise sale receiver 514 receives a merchandise sale result from the client terminal 240 via the communication controller 501. A sale destination acquirer 516 acquires a sale destination from the merchandise sale result received by the merchandise sale receiver 514. A sale destination transmitter 517 transmits the sale destination to the user terminal 220 and the client terminal 240 via the communication controller 501 together with an auction end.

<<Functional Arrangement of User Terminal>>

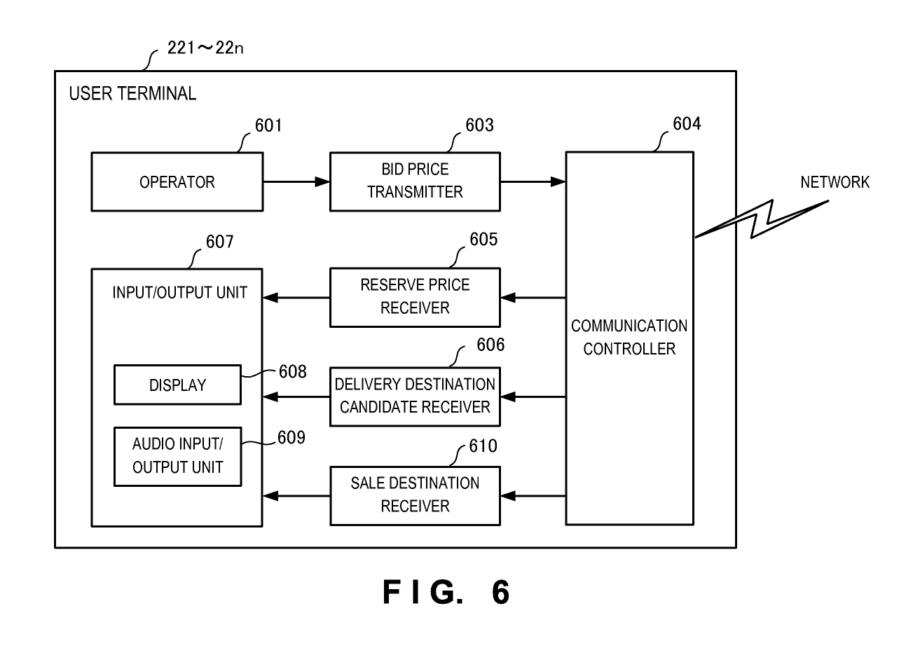

FIG. 6 is a block diagram showing the functional arrangement of the user terminals 221 to 22n according to this embodiment. Note that the user terminals 221 to 22n can have various functions. FIG. 6 shows typical functions in this embodiment. However, the arrangement of the user terminals 221 to 22n is not limited to those. That is, the user terminals 221 to 22n may include functions that are not illustrated in FIG. 6.

An operator 601 accepts a user operation on the user terminals 221 to 22n. A bid price transmitter 603 transmits the bid price of merchandise out of operations input to the operator 601 to the cloud server 210 via a communication controller 604.

A reserve price receiver 605 receives a bid reserve price to the user from the cloud server 210 via the communication controller 604. A delivery destination candidate receiver 606 receives a selected merchandise delivery destination candidate from the cloud server 210 via the communication controller 604. A sale destination receiver 610 receives a decided merchandise sale destination from the cloud server 210 via the communication controller 604 together with auction end information. An input/output unit 607 includes a display 608 and an audio input/output unit 609. The display 608 displays the bid reserve price and a bid price input field for the user. The audio input/output unit 609 may output a bid guidance to the user as an audio.

<<Functional Arrangement of Client Terminal>>

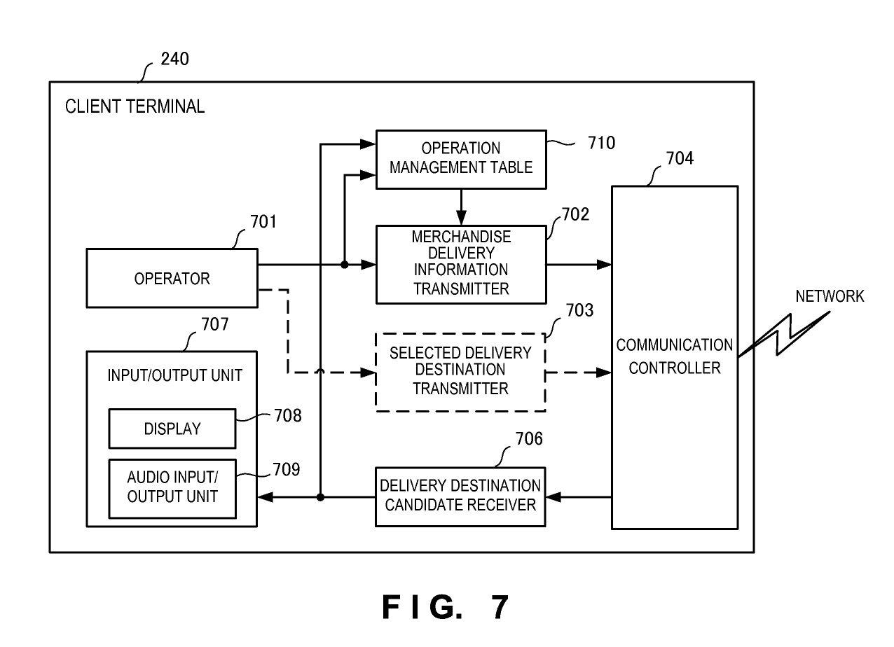

FIG. 7 is a block diagram showing the functional arrangement of the client terminal 240 according to this embodiment. Note that the client terminal 240 can have various functions. FIG. 7 shows typical functions in the present invention. However, the arrangement of the client terminal 240 is not limited to those. That is, the client terminal 240 may include functions that are not illustrated in FIG. 7.

An operator 701 accepts a client operation on the client terminal 240. A merchandise delivery information transmitter 702 transmits the merchandise delivery information of the client out of operations input to the operator 701 to the cloud server 210 via a communication controller 704. Note that the current position may be transmitted together with the merchandise delivery information. A selected delivery destination transmitter 703 is an optional function. In an arrangement that selects a delivery destination desired by the client from a plurality of delivery destination candidates, the selected delivery destination transmitter 703 transmits delivery destination selection information out of operations input to the operator 701 to the cloud server 210 via the communication controller 704. Such an optical function of delivery destination selection does not necessarily select the user of maximum profit as the delivery destination of highest priority, and adds a selection function by the client based on the relationship with users and the like. Note that in an arrangement that detects quality of merchandise in real time and transmits it to the cloud server 210, the client terminal is provided with a freshness data receiver that receives data from a freshness sensor and a quality transmitter that transmits the data to the cloud server 210, although not illustrated in FIG. 7.

A delivery destination candidate receiver 706 receives a selected merchandise delivery destination candidate from the cloud server 210 via the communication controller 704. An input/output unit 707 includes a display 708 and an audio input/output unit 709. The display 708 displays the selected delivery destination together with a navigation. The audio input/output unit 709 may output a delivery destination guidance to the client as an audio.

(User Registration DB)

FIG. 8A is a view showing the arrangement of the user registration DB 401 according to this embodiment. The user registration DB 401 registers users who participate in the merchandise bid/delivery application according to this embodiment. Note that the arrangement of the user registration DB 401 is not limited to FIG. 8A.

The user registration DB 401 stores user information such as user authentication information 812 in association with a user ID 811. The user registration DB 401 also stores user terminal information such as a user terminal ID 813 and terminal authentication information 814. Additionally, a current position 815 detected by a GPS (Global Positioning System) or the like in the user terminal is stored.

(Client Registration DB)

FIG. 8B is a view showing the arrangement of the client registration DB 402 according to this embodiment. The client registration DB 402 registers clients who use the merchandise bid/delivery application according to this embodiment. Note that the arrangement of the client registration DB 402 is not limited to FIG. 8B.

The client registration DB 402 stores user information such as client authentication information 822 in association with a client ID 821. The client registration DB 402 also stores client terminal information such as a client terminal ID 823 and terminal authentication information 824. Additionally, a current position 825 detected by a GPS or the like in the client terminal is stored.

Note that the user registration DB 401 and the client registration DB 402 may be stored as one database.

(Merchandise DB)

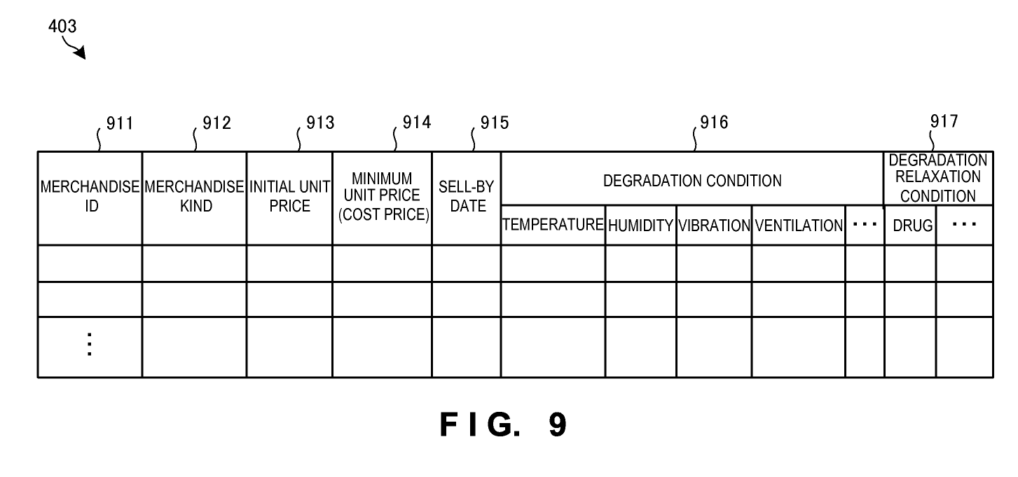

FIG. 9 is a view showing the arrangement of the merchandise DB 403 according to this embodiment. The merchandise DB 403 stores pieces of merchandise that use the merchandise bid/delivery application according to this embodiment and cause quality degradation by delivery. Note that the arrangement of the merchandise DB 403 is not limited to FIG. 9.

The merchandise DB 403 stores a merchandise kind 912 that specifies merchandise, an initial unit price 913 for sale, a minimum unit price (cost price) 914 that is the production cost of the merchandise, a sell-by date 915 of the merchandise, a degradation condition 916 of the merchandise, and a degradation relaxation condition 917 in association with a merchandise ID 911. The degradation condition 916 includes a degradation condition by temperature, a degradation condition by humidity, a degradation condition by vibration, a degradation condition by ventilation, and the like. The degradation relaxation condition 917 includes degradation relaxation by a drug and the like. Note that the degradation condition 916 and the degradation relaxation condition 917 are not limited to FIG. 9A.

(Traffic Information DB)

FIG. 10 is a view showing the arrangement of the traffic information DB 407 according to this embodiment. The traffic information DB 407 stores current traffic information of a delivery region used in the merchandise bid/delivery application according to this embodiment. Note that the arrangement of the traffic information DB 407 is not limited to FIG. 10.

The traffic information DB 407 stores current states such as a starting point 1002 and an arrival point 1003 of a road, a predicted moving time 1004 when using the road, a bypass 1005, and a predicted moving time 1006 when using the bypass in association with a road ID 1001. Note that the starting point 1002 and the arrival point 1003 of each road are preferably stored even in a replaced state.

Note that various known map DBs are usable as the map DB 406, and a description thereof will be omitted here.

<<Hardware Arrangement of Cloud Server>>

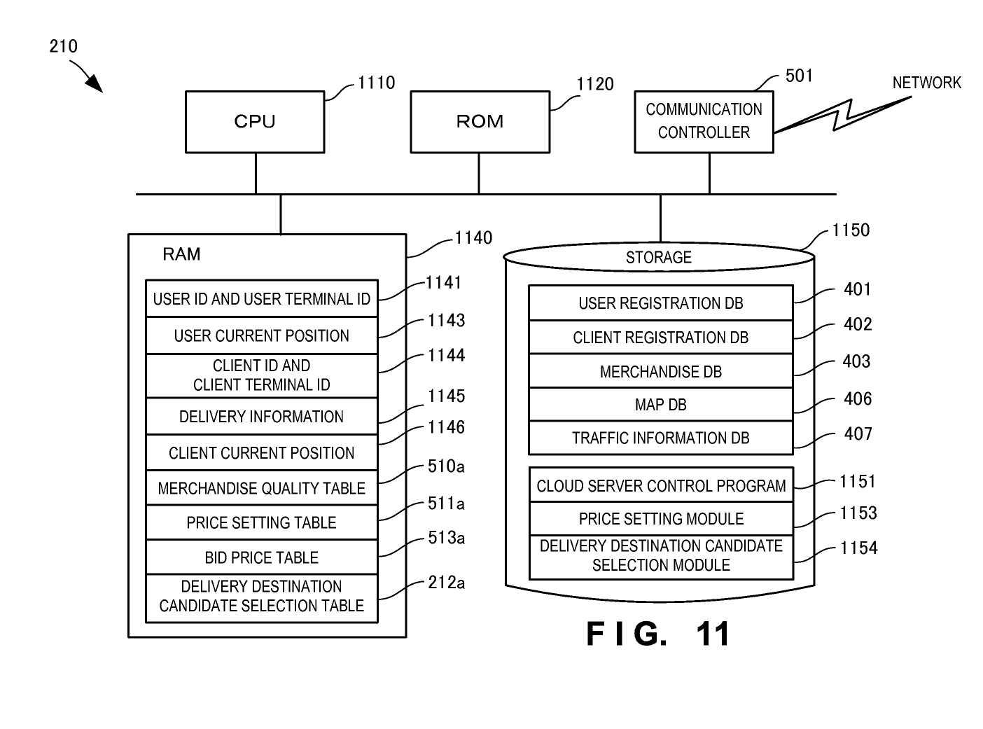

FIG. 11 is a block diagram showing the hardware arrangement of the cloud server 210 according to this embodiment.

Referring to FIG. 11, a CPU 1110 is a processor for arithmetic control, and implements each functional component of the cloud server 210 shown in FIG. 5 by executing a program. A ROM 1120 stores initial data, permanent data of programs and the like, and programs. The communication controller 501 communicates with the user terminals 221 to 22n and the client terminal 240 via the network. Note that the number of CPUs 1110 is not limited to one, and the CPU 1110 may include a plurality of CPUs or a GPU (Graphics Processing Unit) for image processing.

A RAM 1140 is a random access memory used by the CPU 1110 as a work area for temporary storage. An area to store data necessary for implementation of the embodiment is allocated to the RAM 1140. A user ID and user terminal ID 1141 includes the identifiers of a user terminal and a user who participates in an auction of merchandise to be delivered. A user current position 1143 is the current position of the user (user terminal) acquired from each user terminal. A client ID and client terminal ID 1144 includes the identifiers of a client terminal and a client (merchandise delivery van) that delivers merchandise for which users make bids. Delivery information 1145 is information about merchandise to be delivered by the client. A client current position 1146 is the current position of the client (client terminal) acquired from the client terminal.

The merchandise quality table 510a is a table used to predict quality degradation of merchandise under the current environment. The price setting table 511a is a table used to set a bid reserve price based on quality degradation prediction of merchandise with respect to the current position of the client (merchandise delivery van) as the center. The bid price table 513a is a table used to collect bid prices more than the reserve price which are offered by the users. The delivery destination candidate selection table 212a is a table used to select the user of highest profit as the delivery destination candidate of merchandise based on the collected bid prices of the users.

The RAM 1140 also stores transmission/reception data to be transmitted/received via the communication controller 501, although not illustrated in FIG. 11. The contents of the RAM 1140 and a storage 1150 may replace each other by swap of the OS or the like.

The storage 1150 stores databases, various kinds of parameters, and following data and programs necessary for implementation of the embodiment. The user registration DB 401 is the database shown in FIG. 8A. The client registration DB 402 is the database shown in FIG. 8B. The merchandise DB 403 is the database shown in FIG. 9. The map DB 406 is a database to be referred to know the distance, the delivery route, and the like from the location of a user or the location of the client. The traffic information DB 407 is the database shown in FIG. 10.

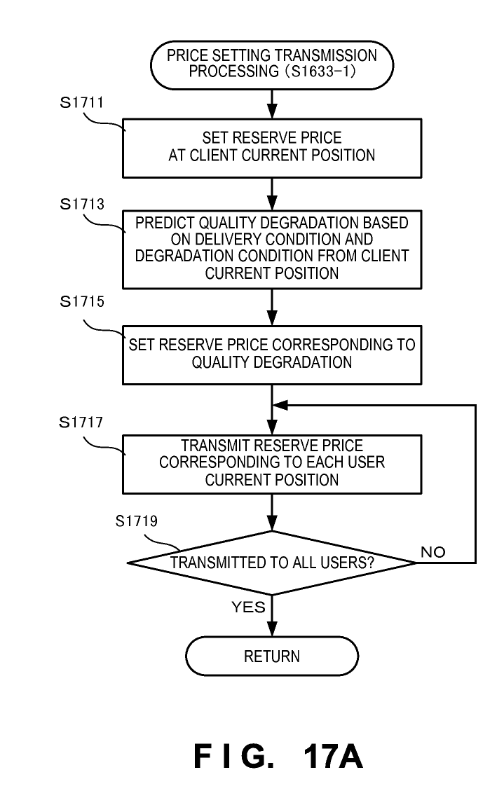

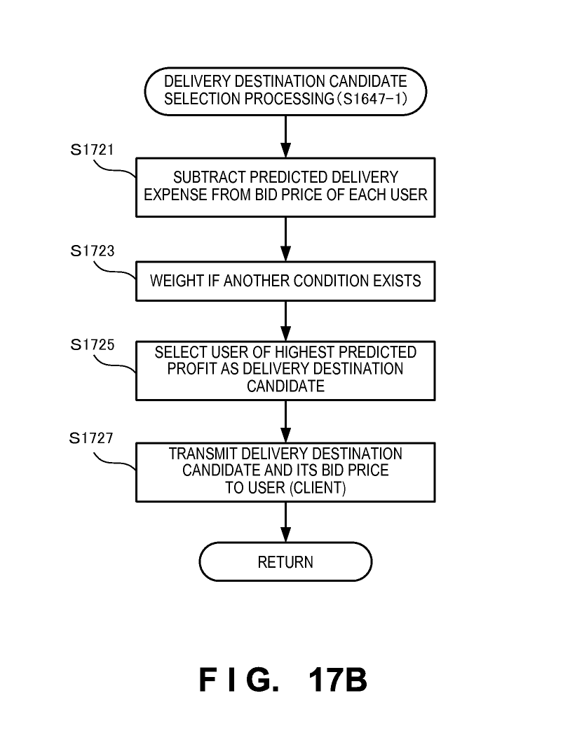

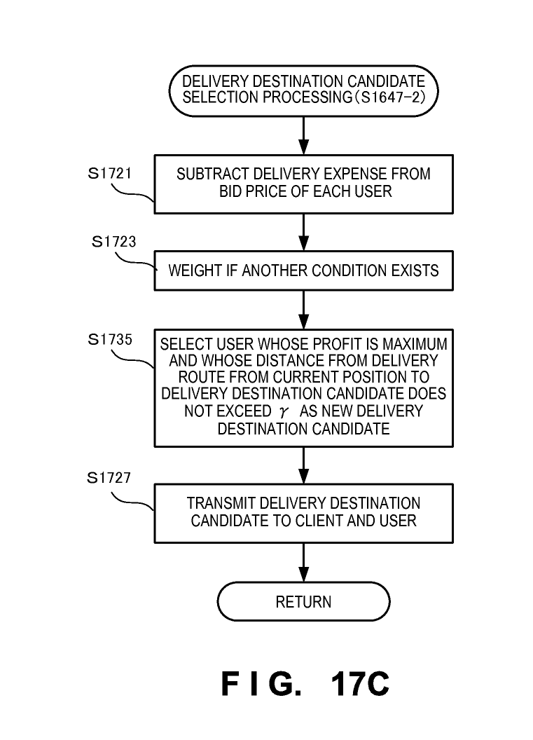

The storage 1150 stores the following programs. A cloud server control program 1151 is a program that controls the entire cloud server 210. A price setting module 1153 is a module configured to set a bid reserve price corresponding to quality degradation prediction of merchandise to be delivered while holding a bid in the cloud server control program 1151 (see FIG. 17A). A delivery destination candidate selection module 1154 is a module configured to collect bid prices of merchandise from the users and select the user of highest profit as the delivery destination candidate in the cloud server control program 1151 (see FIGS. 17B and 17C).

Note that programs and data associated with general-purpose functions and other implementable functions of the cloud server 210 are not shown in the RAM 1140 or the storage 1150 of FIG. 11.

(Price Setting Table)

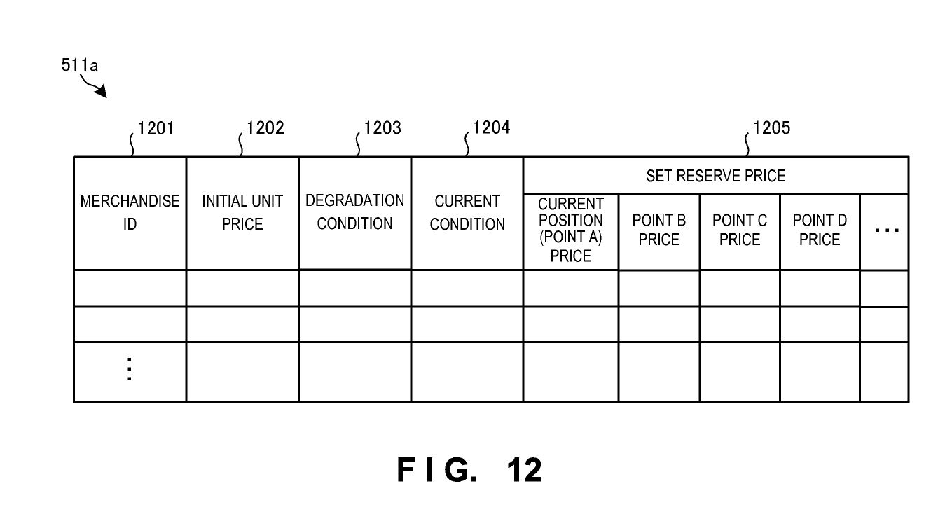

FIG. 12 is a view showing the arrangement of the price setting table 511a according to this embodiment. The price setting table 511a is used to set a reserve price that is the lower limit of the bid price based on the current position of the client (merchandise delivery van) and the prediction of quality degradation of merchandise caused by delivery. Note that in this example, to simplify the processing, the reserve price is set not by a curve as shown in FIG. 2D but for the current position of each user.

The price setting table 511a stores an initial unit price 1202 at the start of delivery of merchandise, a degradation condition (and degradation relaxation condition) 1203 from the merchandise DB 403, a current condition (measured temperature and the like) 1204, and a reserve price 1205 set in consideration of the conditions in association with a merchandise ID 1201. In the set reserve price 1205, assuming that the reserve price at the current position of the merchandise delivery van is the reserve price at, for example, the point A, the reserve price at the point B, the reserve price at the point C, the reserve price at the point D, and the like are stored based on the degradation condition 1203 and the current condition 1204 of merchandise.

(Bid Price Table)

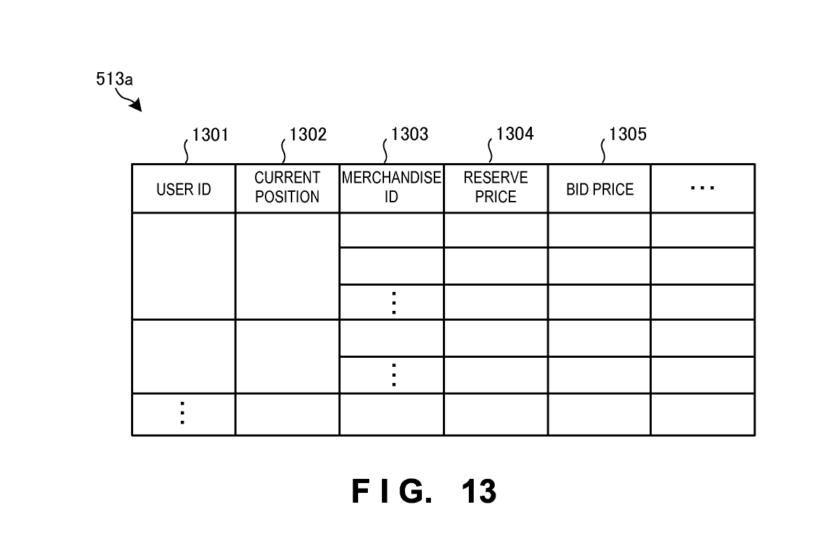

FIG. 13 is a view showing the arrangement of the bid price table 513a according to this embodiment. The bid price table 513a is a table that stores the bid price offered from each user terminal.

The bid price table 513a stores a current position 1302 of a user and a merchandise ID 1303 of merchandise for which the user has made a bid in association with a user ID 1301. The bid price table 513a also stores a set reserve price 1304, a bid unit price 1305 of the user, a number 1306 of merchandise, and a bid price 1307 in association with each merchandise ID 1303. Note that the condition of bid acceptance is that the bid unit price 1305 exceeds the reserve price 1304.

(Delivery Destination Candidate Selection Table)

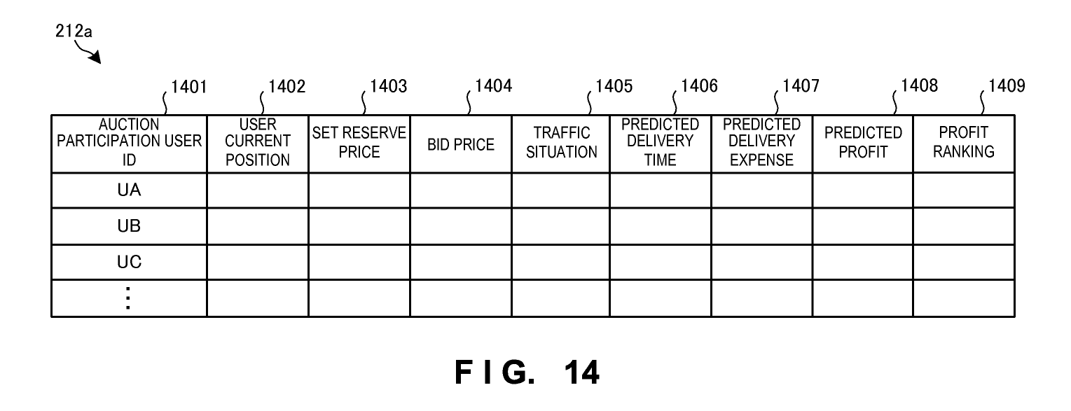

FIG. 14 is a view showing the arrangement of the delivery destination candidate selection table 212a according to this embodiment. The delivery destination candidate selection table 212a is a table used to select the next delivery destination candidate based on bid prices collected from the users.

The delivery destination candidate selection table 212a stores a user current position 1402, a set reserve price 1403, a bid price 1404, a traffic situation 1405, a predicted delivery time 1406, a predicted delivery expense 1407, and a predicted profit 1408 in association with an auction participation user ID 1401. A profit ranking 1409 is stored based on which user's bid generates a high profit. The user who has the top position in the profit ranking 1409 is selected as the delivery destination candidate.

(Merchandise Quality Table)

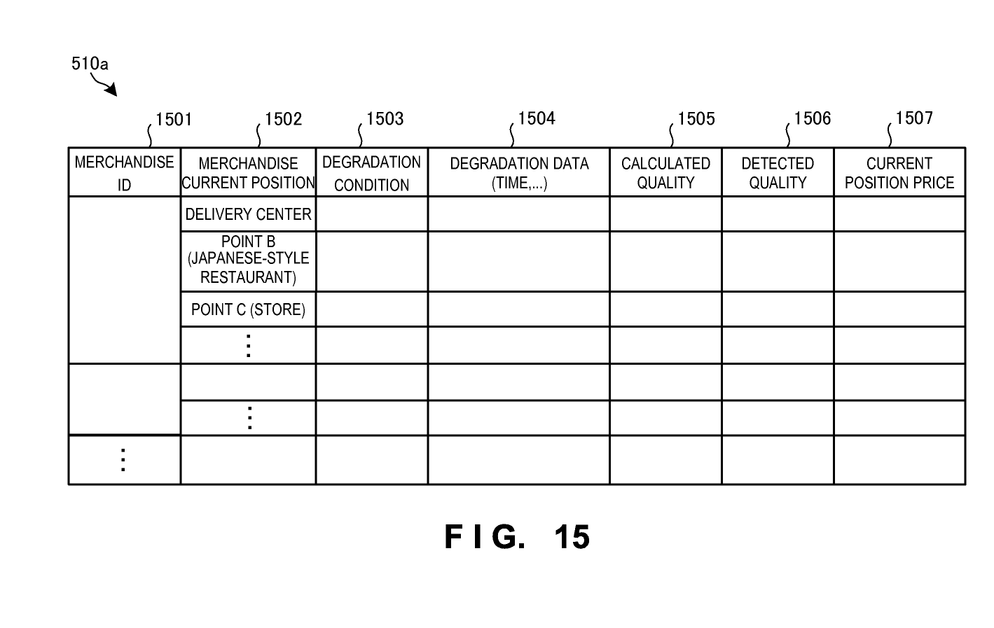

FIG. 15 is a view for explaining the concept of the merchandise quality table 510a according to this embodiment. The merchandise quality table 510a is a table that sequentially stores and updates the current state of each piece of merchandise to be delivered and is referred to as information for reserve price setting.

The merchandise quality table 510a stores a merchandise current position 1502 also serving as the current position of the client (merchandise delivery van) in association with a merchandise ID 1501. In FIG. 15, for example, the delivery center at the starting point, the point B (Japanese-style restaurant), and the point C (store) are sequentially stored as the merchandise current position 1502. Note that the merchandise current position may be overwritten as the client moves.

The merchandise quality table 510a also stores a degradation condition 1503 at that point of time, degradation data 1504 affecting the degradation condition, calculated quality 1505 that is predicted quality, detected quality 1506 actually detected by a sensor, and a current position price 1507 that is the reserve price at the current position in association with each merchandise current position 1502. Note that the calculated quality 1505 is calculated by reflecting the degradation data 1504 on the degradation condition 1503.

<<Processing Procedure of Cloud Server>>

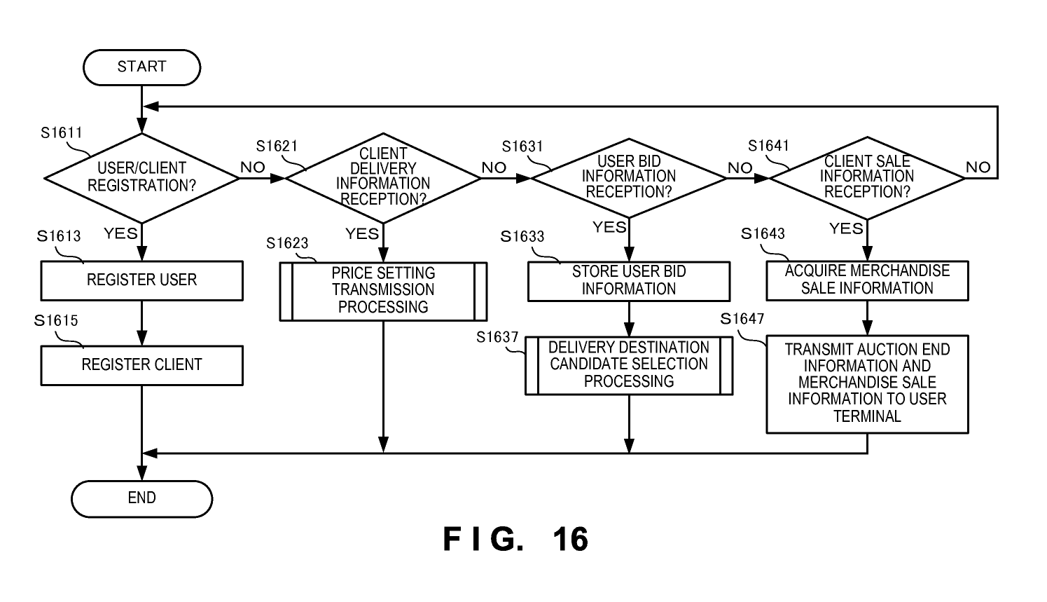

FIG. 16 is a flowchart showing the processing procedure of the cloud server 210 according to this embodiment. This flowchart is executed by the CPU 1110 shown in FIG. 11 using the RAM 1140 and implements the functional components shown in FIG. 5.

In step S1611, the cloud server 210 determines whether to register a user or a client. In step S1621, the cloud server 210 determines whether to receive delivery information of a client. In step S1631, the cloud server 210 determines whether to receive bid information of a user. In step S1641, the cloud server 210 determines whether to receive sale information of a client.

To register a user or a client, the process advances to step S1613. When registering a user, the cloud server 210 registers the user in the user registration DB 401 in step S1613. When registering a client, the cloud server 210 registers the client in the client registration DB 402 in step S1615.

To receive client delivery information, the process advances to step S1623, and the cloud server 210 sets a reserve price considering quality degradation caused by delivery with respect to the current position of the client as the center and transmits it to user terminals (see FIG. 17A).

To receive user bid information, the process advances to step S1633, and the cloud server 210 stores user bid information including a bid price to collet it. In step S1637, the cloud server 210 selects, based on the profit, the delivery destination candidate from the bid prices collected so far (see FIG. 17B or 17C).

To receive client sale information, the process advances to step S1643, and the cloud server 210 acquires merchandise sale information. Next, the process advances to step S1647, and the cloud server 210 transmits auction end information and the merchandise sale information to the user terminals 221 to 22n (client terminal 240).

(Price Setting Transmission Processing)

FIG. 17A is a flowchart showing a procedure S1633-1 of price setting transmission processing (S1633) according to this embodiment.

In step S1711, the cloud server 210 sets a reserve price at the current position of the client (merchandise delivery van). In step S1713, the cloud server 210 predicts quality degradation in the region or at each point based on the delivery conditions and the degradation conditions from the current position of the client. The delivery conditions include the distance and delivery time from the current position of the client. In step S1715, the cloud server 210 sets a reserve price considering the quality degradation (see FIG. 2C or 12B). In step S1717, the cloud server 210 transmits the reserve price corresponding to the current position of each user to the user terminal. In step S1719, the cloud server 210 controls to transmit the corresponding reserve price to each user in step S1717 until the reserve price is transmitted to all users capable of making a bid.

Note that the quality of merchandise used to set the reserve price at the current position of the client can be obtained based on events in delivery from the delivery center, based on quality degradation prediction considering the degradation conditions, or by actually measuring the current merchandise quality. When measuring the quality, detection data obtained by detecting the state of merchandise in the merchandise delivery by a sensor or quality data obtained by calculating the quality is transmitted from the client terminal 240 of the merchandise delivery van to the cloud server 210 as needed. Note that for more details about quality detection, see the literature below.

For example, when measuring the freshness of fish/vegetables, chemical substances generated in fish and the like and serving as indices of freshness are detected by detecting colors using an infrared detection sensor, or UV rays generated from chemical substances generated in fish and the like and serving as indices of freshness are detected. Also exists a technique of collecting signals from the sensor via a network. Measurement by infrared detection is described in, for example, “Masao Nakamura, “Technological Trends in Infrared Detection Elements”, Sensor Technology, 1989 March Issue (Vol. 9, No. 3), pp. 61-64” or “Sumio Kawano, “The Handbook of Non-Destructive Detection for Foods”, SCIENCE FORUM, pp. 34-4(5) JP 2011-146725 A 2011.7.28”. Measurement by UV detection is described in, for example, Japanese Patent No. 4291381. As system management, distribution quality traceability, temperature traceability, and the like are known (see http://www.nec.co.jp/rfid/solution/traceability_saas.html or http://www.nec.co.jp/library/jirei/kyushutsu/contents.html).

(Delivery Destination Candidate Selection Processing)

FIG. 17B is a flowchart showing a procedure (S1647-1) of delivery destination candidate selection processing (S1647) according to this embodiment.

In step S1721, the cloud server 210 subtracts predicted expenses such as the predicted delivery expense from the bid price of each user. In step S1723, if another delivery destination candidate selection condition exists, the cloud server 210 weights the bid price of each user. In step S1725, the cloud server 210 selects, as the delivery destination candidate, the user of highest profit out of all users who have made a bid. In step S1727, the cloud server 210 transmits the selected delivery destination candidate and its bid price to the user terminals (client terminal).

FIG. 17C is a flowchart showing another procedure (S1647-2) of delivery destination candidate selection processing (S1647) according to this embodiment. In FIG. 17C, change of the delivery destination candidate is limited in consideration of the distance from the delivery route of the client (merchandise delivery van) when selecting the delivery destination candidate. The procedure of FIG. 17C is effective when change of the delivery destination candidate may frequently occur. Note that FIG. 17C shows a flowchart changed from FIG. 17B, the same step numbers as in FIG. 17B denote the same steps, and a description thereof will be omitted.

In the flowchart of FIG. 17C, step S1735 replaces step S1725 of FIG. 17B. In step S1735, the cloud server 210 selects a new delivery destination candidate under not only the condition that the profit is maximum but also the condition that the distance from the delivery route of the client does not exceed a threshold γ.

<<Hardware Arrangement of User Terminal>>

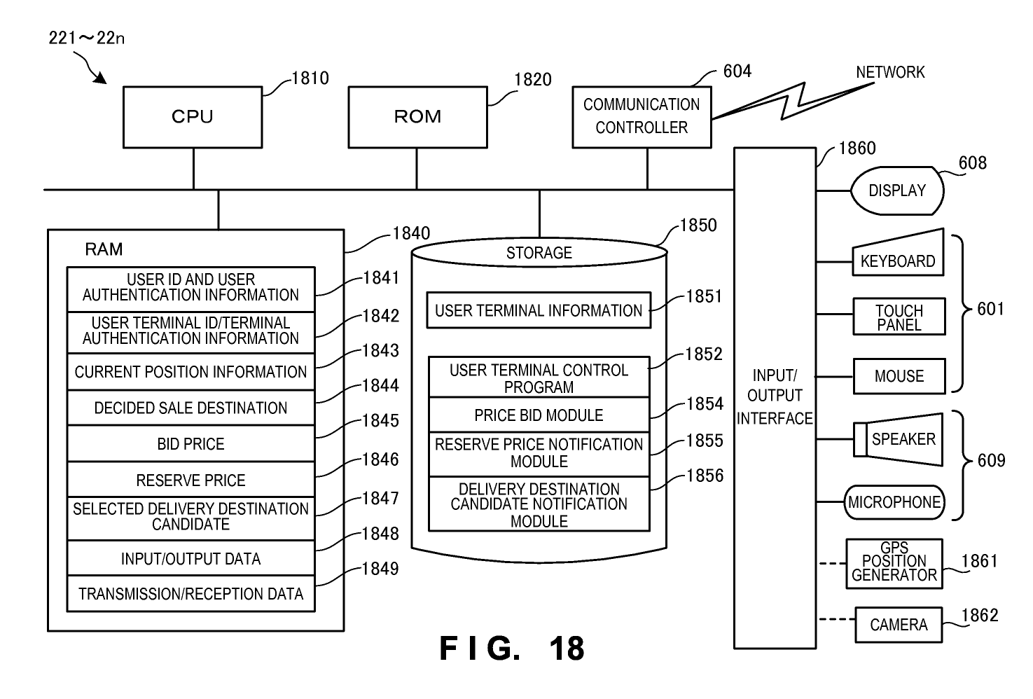

FIG. 18 is a block diagram showing the hardware arrangement of the user terminals 221 to 22n according to this embodiment.

Referring to FIG. 18, a CPU 1810 is a processor for arithmetic control, and implements each functional component of the user terminals 221 to 22n shown in FIG. 6 by executing a program. A ROM 1820 stores initial data, permanent data of programs and the like, and programs. The communication controller 604 communicates with the cloud server 210 via the network. Note that the number of CPUs 1810 is not limited to one, and the CPU 1810 may include a plurality of CPUs or a GPU for image processing.

A RAM 1840 is a random access memory used by the CPU 1810 as a work area for temporary storage. An area to store data necessary for implementation of the embodiment is allocated to the RAM 1840. User ID and user authentication information 1841 includes the identifier of a user who is operating a user terminal and the authentication information of the user. User terminal ID/terminal authentication information 1842 includes the identifier of the user terminal and the authentication information of the user terminal. Current position information 1843 is information representing the current position of the user terminal. A decided sale destination 1844 is the information of decision (auction end) of a sale destination received from the cloud server 210. A bid price 1845 is a bid price that is the product of the input unit price input by the user and the number of merchandise. A reserve price 1846 is a minimum unit price that is transmitted from the cloud server 210 and is to be offered by the user. A selected delivery destination candidate 1847 is a delivery destination candidate transmitted from the cloud server 210. Note that the selected delivery destination candidate 1847 includes the bid price of the delivery destination candidate. Input/output data 1848 indicates input/output data to be input/output via an input/output interface 1860. Transmission/reception data 1849 indicates transmission/reception data to be transmitted/received via the communication controller 604.

A storage 1850 stores databases, various kinds of parameters, and following data and programs necessary for implementation of the embodiment. User terminal information 1851 is the information of the local user terminal. The storage 1850 stores the following programs. A user terminal control program 1852 is a control program that controls the entire user terminals 221 to 22n. A price bid module 1854 is a module configured to control input of a bid price and transmission of the bid price to the cloud server 210 in the user terminal control program 1852. A reserve price notification module 1855 is a module configured to control reception of a reserve price and notification to the user in the user terminal control program 1852. A delivery destination candidate notification module 1856 is a module configured to receive a selected delivery destination candidate from the cloud server 210 and control notification to the user in the user terminal control program 1852.

The input/output interface 1860 interfaces input/output data from/to input/output devices. The display 608 and the operator 601 such as a keyboard, a touch panel, or a pointing device are connected to the input/output interface 1860. The audio input/output unit 609 such as a speaker and a microphone is also connected. In addition, a GPS (Global Positioning System) position generator 1861, a camera 1862, and the like are connected.

Note that programs and data associated with general-purpose functions and other implementable functions of the user terminals 221 to 22n are not shown in the RAM 1840 or the storage 1850 of FIG. 18.

<<Processing Procedure of User Terminal>>

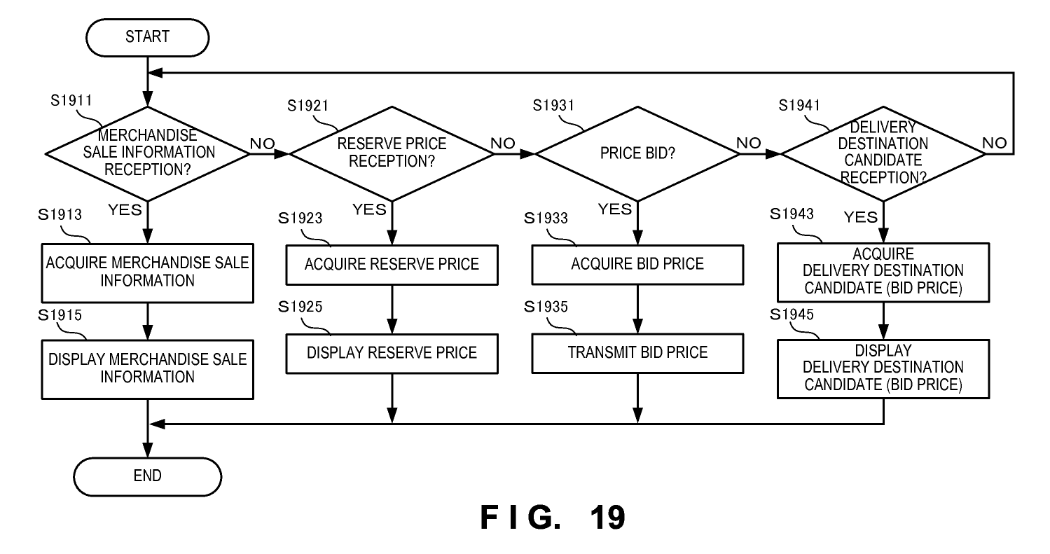

FIG. 19 is a flowchart showing the processing procedure of the user terminals 221 to 22n according to this embodiment. This flowchart is executed by the CPU 1810 shown in FIG. 18 using the RAM 1840 and implements the functional components shown in FIG. 6. Note that in FIG. 19, the procedure of user registration is omitted.

In step S1911, the user terminals 221 to 22n determine whether to receive merchandise sale information from the cloud server 210. In step S1921, the user terminals 221 to 22n determine whether to receive a reserve price from the cloud server 210. In step S1931, the user terminals 221 to 22n determine whether to transmit a bid price to the cloud server 210. In step S1941, the user terminals 221 to 22n determine whether to receive a selected delivery destination candidate from the cloud server 210.

To receive merchandise sale information, the process advances to step S1913, and the user terminals 221 to 22n acquire merchandise sale information from a message received from the cloud server 210. In step S1915, the user terminals 221 to 22n display the merchandise sale information and auction end on the display 608.

To receive a reserve price, the process advances to step S1923, and the user terminals 221 to 22n acquire a reserve price from a message received from the cloud server 210. In step S1925, the user terminals 221 to 22n display the reserve price on the display 608. Note that at this time, the user terminals 221 to 22n may output the reserve price as an audio.

To transmit a bid price, the process advances to step S1933, and the user terminals 221 to 22n acquire the bid price input by the user. In step S1935, the user terminals 221 to 22n transmit the bid price to the cloud server 210.

To receive a delivery destination candidate, the process advances to step S1943, and the user terminals 221 to 22n acquire a delivery destination candidate including a bid price from a message received from the cloud server 210. In step S1945, the user terminals 221 to 22n display the selected delivery destination candidate on the display 608. Note that the user terminals 221 to 22n may output the delivery destination candidate as an audio.

<<Hardware Arrangement of Client Terminal>>

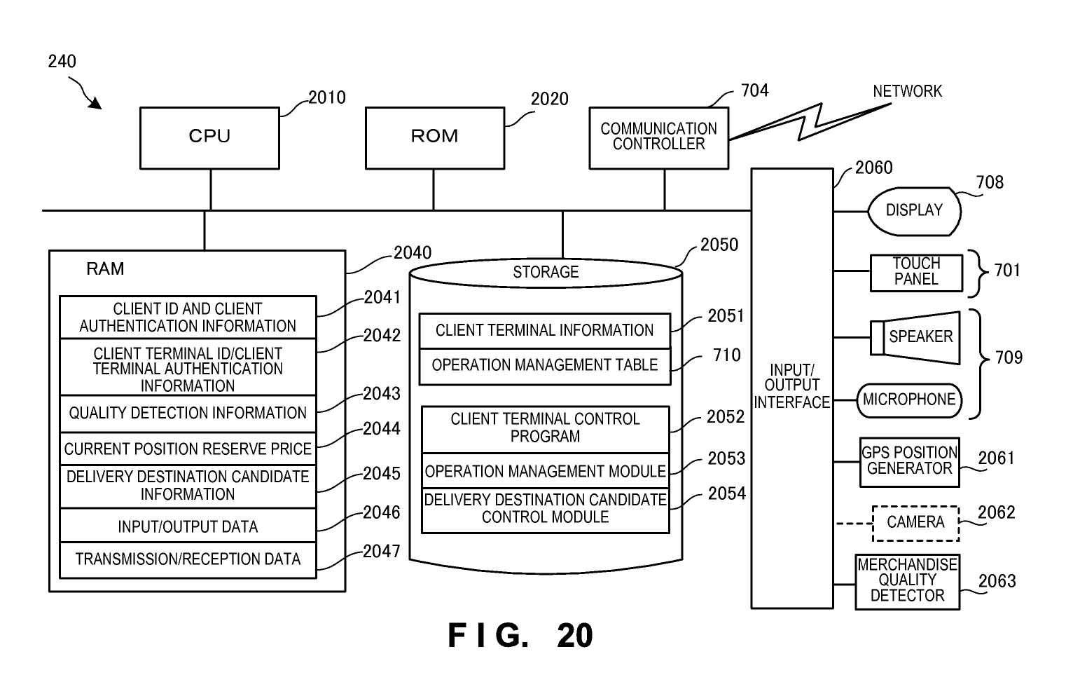

FIG. 20 is a block diagram showing the hardware arrangement of the client terminal 240 according to this embodiment.

Referring to FIG. 20, a CPU 2010 is a processor for arithmetic control, and implements each functional component of the client terminal 240 shown in FIG. 7 by executing a program. A ROM 2020 stores initial data, permanent data of programs and the like, and programs. The communication controller 704 communicates with the cloud server 210 (or the user terminals 221 to 22n in the seventh embodiment) via the network. Note that the number of CPUs 2010 is not limited to one, and the CPU 2010 may include a plurality of CPUs or a GPU for image processing.

A RAM 2040 is a random access memory used by the CPU 2010 as a work area for temporary storage. An area to store data necessary for implementation of the embodiment is allocated to the RAM 2040. Client ID and client authentication information 2041 includes the identifier of a client who is operating a client terminal and the authentication information of the client. Client terminal ID/client terminal authentication information 2042 includes the identifier of the client terminal and the authentication information of the client terminal. Quality detection information 2043 is merchandise quality information predicted based on data detected from merchandise by a merchandise quality detector 2063. A current position reserve price 2044 is the reserve price of merchandise at the current position of the client (merchandise delivery van), which is set in consideration of quality degradation caused by delivery up to the current position. Delivery destination candidate information 2045 is information about a delivery destination candidate received from the cloud server 210. Input/output data 2046 indicates input/output data to be input/output via an input/output interface 2060. Transmission/reception data 2047 indicates transmission/reception data to be transmitted/received via the communication controller 704.

A storage 2050 stores databases, various kinds of parameters, and following data and programs necessary for implementation of the embodiment. Client terminal information 2051 is the information of the local client terminal. An operation management table 710 is a table used to manage the merchandise delivery van used for delivery. The storage 2050 stores the following programs. A client terminal control program 2052 is a control program that controls the entire client terminal 240. An operation management module 2053 is a module configured to manage the operation of the merchandise delivery van while referring to the operation management table 710 in the client terminal control program 2052. A delivery destination candidate control module 2054 is a module configured to control reception of a selected delivery destination candidate from the cloud server 210 or delivery to the delivery destination candidate in the client terminal control program 2052.

The input/output interface 2060 interfaces input/output data from/to input/output devices. The display 708 and the operator 701 such as a touch panel are connected to the input/output interface 2060. The audio input/output unit 709 such as a speaker and a microphone is also connected. In addition, a GPS position generator is connected as a current position acquirer. A camera 2062 and the like may also be connected. Furthermore, the merchandise quality detector 2063 that detects the quality of merchandise delivered by the merchandise delivery van is connected.

Note that programs and data associated with general-purpose functions and other implementable functions of the client terminal 240 are not shown in the RAM 2040 or the storage 2050 of FIG. 20.

(Operation Management Table)

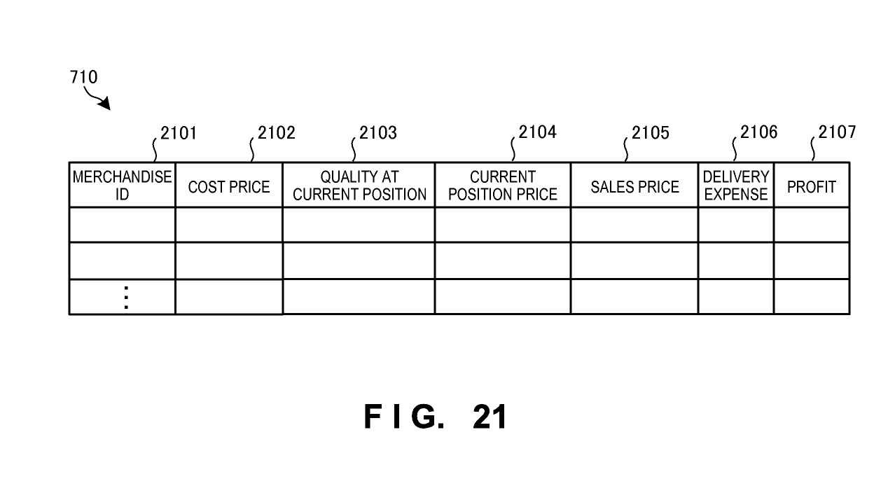

FIG. 21 is a view showing the arrangement of the operation management table 710 according to this embodiment. The operation management table 710 is used to manage an operation for the client (merchandise delivery van) to deliver merchandise.

The operation management table 710 stores a cost price 2102, quality 2103 at each delivery point, a current position price 2104 at each delivery point, a sales price 2105, a delivery expense 2106, and a profit 2107 in association with a merchandise ID 2101.

<<Processing Procedure of Client Terminal>>

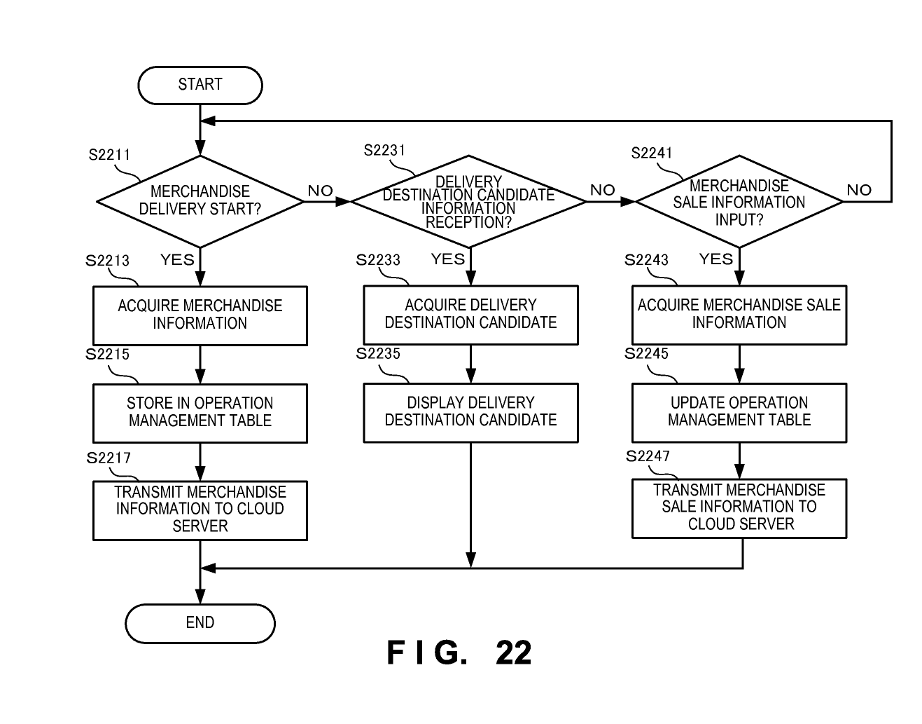

FIG. 22 is a flowchart showing the processing procedure of the client terminal 240 according to this embodiment. This flowchart is executed by the CPU 2010 shown in FIG. 20 using the RAM 2040 and implements the functional components shown in FIG. 7. Note that in FIG. 22, the procedure of client registration is omitted.

In step S2211, the client terminal 240 determines whether to load merchandise and start merchandise delivery. In step S2231, the client terminal 240 determines whether to receive a selected delivery destination candidate from the cloud server 210. In step S2241, the client terminal 240 determines whether to input a merchandise sale result in the delivery destination candidate.

To start merchandise delivery, the process advances to step S2213, and the client terminal 240 acquires merchandise information input by the client to start delivery. In step S2215, the client terminal 240 stores the merchandise information in the operation management table 710. In step S2217, the client terminal 240 transmits the merchandise information to the cloud server 210.

To receive a delivery destination candidate, the process advances to step S2233, and the client terminal 240 acquires the selected delivery destination candidate from a message received from the cloud server 210. In step S2235, the client terminal 240 displays the delivery destination candidate on the display 708. Note that an audio may be output.

To input a merchandise sale result, the process advances to step S2243, and the client terminal 240 acquires merchandise sale information input by the user. In step S2245, the client terminal 240 updates the operation management table 710. In step S2247, the client terminal 240 transmits the merchandise sale result to the cloud server 210.

### Third Embodiment

An information processing system according to the third embodiment of the present invention will be described next. The information processing system according to this embodiment is different from the second embodiment in that update of a delivery destination candidate is limited by a predetermined condition. As the condition according to this embodiment, when the merchandise delivery van is already at a short distance from the delivery destination candidate, the delivery destination candidate is decided as the sale destination and is not updated even when the bid price is high. The rest of the components and operations is the same as in the second embodiment. Hence, the same reference numerals denote the same components and operations, and a detailed description thereof will be omitted.

According to this embodiment, when the merchandise delivery van is already close to the delivery destination candidate in terms of distance, update of the delivery destination candidate is limited. This makes it possible to reduce an excess delivery time and increase the profit while achieving a higher level of user satisfaction.

Note that this embodiment is different from the second embodiment only in price setting transmission processing of the processing procedure of a cloud server 210, and a description of remaining portions will be omitted.

(Price Setting Transmission Processing)

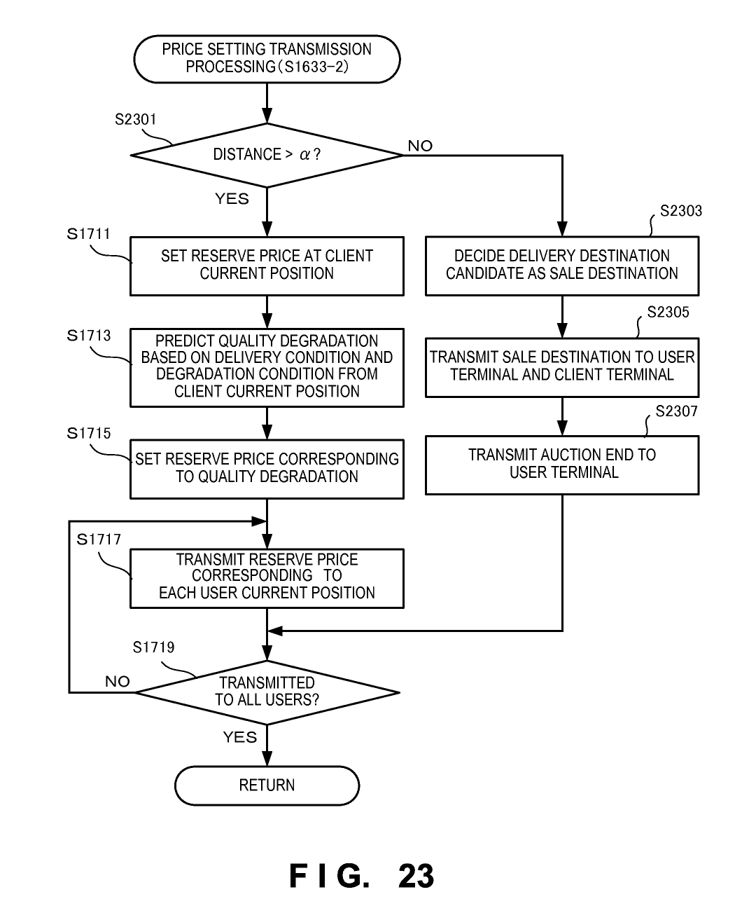

FIG. 23 is a flowchart showing a procedure (S1633-2) of price setting transmission processing (S1633) according to this embodiment. Note that the same step numbers as in FIG. 17A of the second embodiment denote the same steps in FIG. 23, and a description thereof will be omitted.

In step S2301, the cloud server 210 determines whether the distance between the merchandise delivery van and the delivery destination candidate exceeds a threshold α. If the distance exceeds the threshold α, the cloud server 210 performs the same processing as in FIG. 17A. If the distance does not exceed the threshold α, the cloud server 210 advances to step S2303 and decides the current delivery destination candidate as the sale destination. In step S2305, the cloud server 210 transmits the decided sale destination to user terminals 221 to 22n and a client terminal 240. In step S2307, the cloud server 210 transmits an auction end to the user terminals 221 to 22n. Note that steps S2305 and S2307 may be executed in a reverse order or simultaneously.

### Fourth Embodiment

An information processing system according to the fourth embodiment of the present invention will be described next. The information processing system according to this embodiment is different from the third embodiment in the condition to limit update of the delivery destination candidate. In this embodiment, when the merchandise delivery van is already at a location of short delivery time to the delivery destination candidate, the delivery destination candidate is decided as the sale destination and is not updated even when the bid price is high. The rest of the components and operations is the same as in the second embodiment. Hence, the same reference numerals denote the same components and operations, and a detailed description thereof will be omitted.

According to this embodiment, when the merchandise delivery van is already close to the delivery destination candidate in terms of time, update of the delivery destination candidate is limited. This makes it possible to reduce an excess delivery time and increase the profit while achieving a higher level of user satisfaction.

Note that this embodiment is different from the second embodiment only in price setting transmission processing of the processing procedure of a cloud server 210, and a description of remaining portions will be omitted.

(Price Setting Transmission Processing)

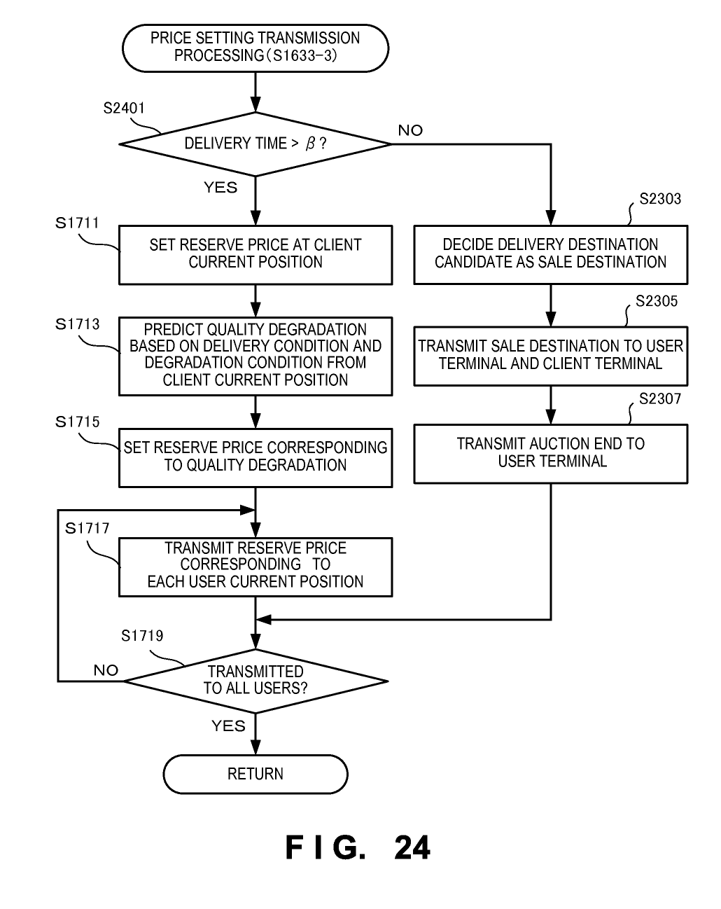

FIG. 24 is a flowchart showing a procedure (S1633-3) of price setting transmission processing (S1633) according to this embodiment. Note that the same step numbers as in FIG. 17A of the second embodiment or FIG. 23 of the third embodiment denote the same steps in FIG. 24, and a description thereof will be omitted.

In step S2401, the cloud server 210 determines whether the delivery time needed for the merchandise delivery van to drive from the current position to the delivery destination candidate exceeds a threshold β. If the delivery time exceeds the threshold β, the cloud server 210 performs the same processing as in FIG. 17A. If the delivery time does not exceed the threshold β, the cloud server 210 advances to step S2303 and performs the same processing as in FIG. 23 in steps S2303 to S2307. Note that steps S2305 and S2307 may be executed in a reverse order or simultaneously.

### Fifth Embodiment

An information processing system according to the fifth embodiment of the present invention will be described next. The information processing system according to this embodiment is different from the second to fourth embodiments in that the merchandise delivery van delivers a plurality of pieces of merchandise. More specifically, after reaching one delivery destination candidate and selling a predetermined number of merchandise, an auction is held for the remaining number of merchandise, and the next delivery destination candidate is continuously selected. The selected delivery destination candidate is notified to the communication terminal of the merchandise delivery van as needed to manage merchandise delivery. At the same time, when the sale destination is decided, it is notified to the communication terminal of each user. The bid is temporarily stopped, the bid price of the sale destination is deleted, and the auction is resumed.

Note that in this embodiment, instead of using a bid price corresponding to the unit price of merchandise or, in sale by weight, the quantity unit price (price of a unit quantity), a price obtained by integrating the unit price (quantity unit price) and the number of merchandise to be purchased is used. That is, bid price=unit price (quantity unit price)×number of merchandise to be purchased (quantity). In this case, even distant from the current position of merchandise, a higher profit can be generated by a bid for a large number (quantity) of merchandise than by a bid of a nearby user for a small number (quantity) of merchandise. Since the distant user is selected as the delivery destination candidate, the profit can be increased.

As described above, according to this embodiment, an auction and delivery of a plurality of pieces of merchandise are efficiently done in consideration of quality degradation caused by delivery of the merchandise. This can implement both an increase in profit and an increase in delivery efficiency.

<<Explanation of Information Processing System>>

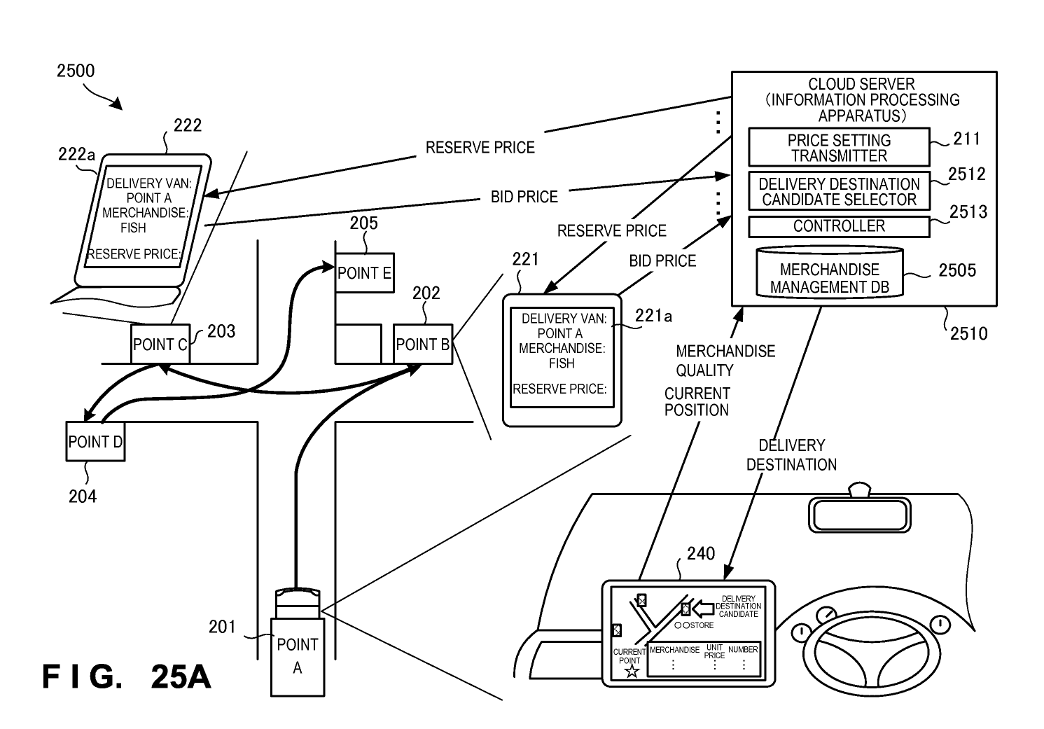

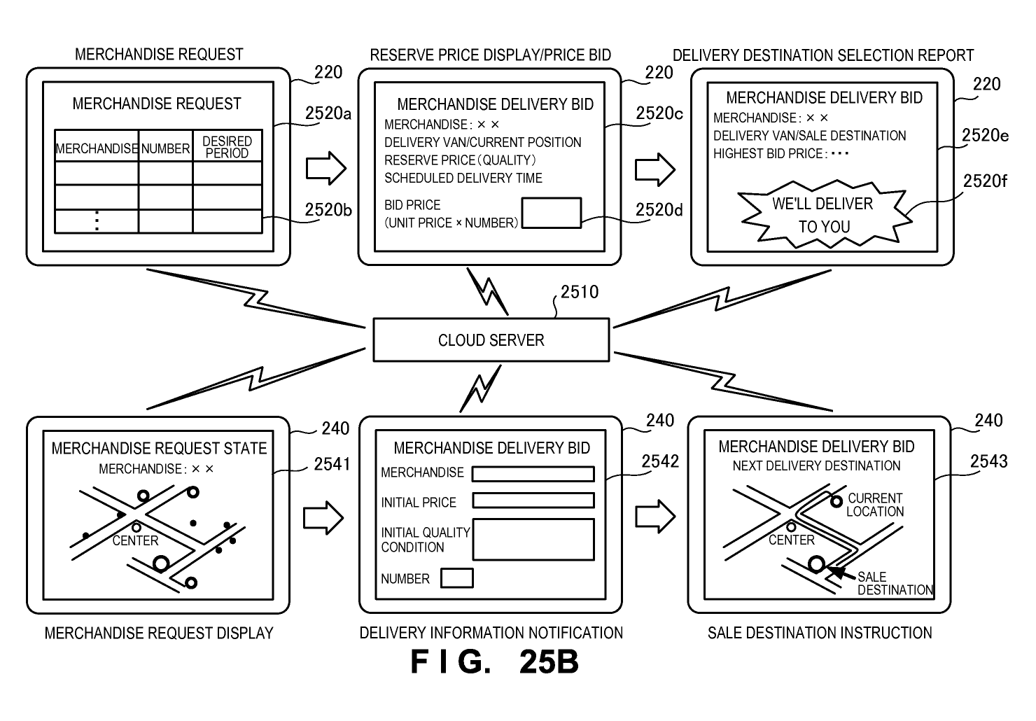

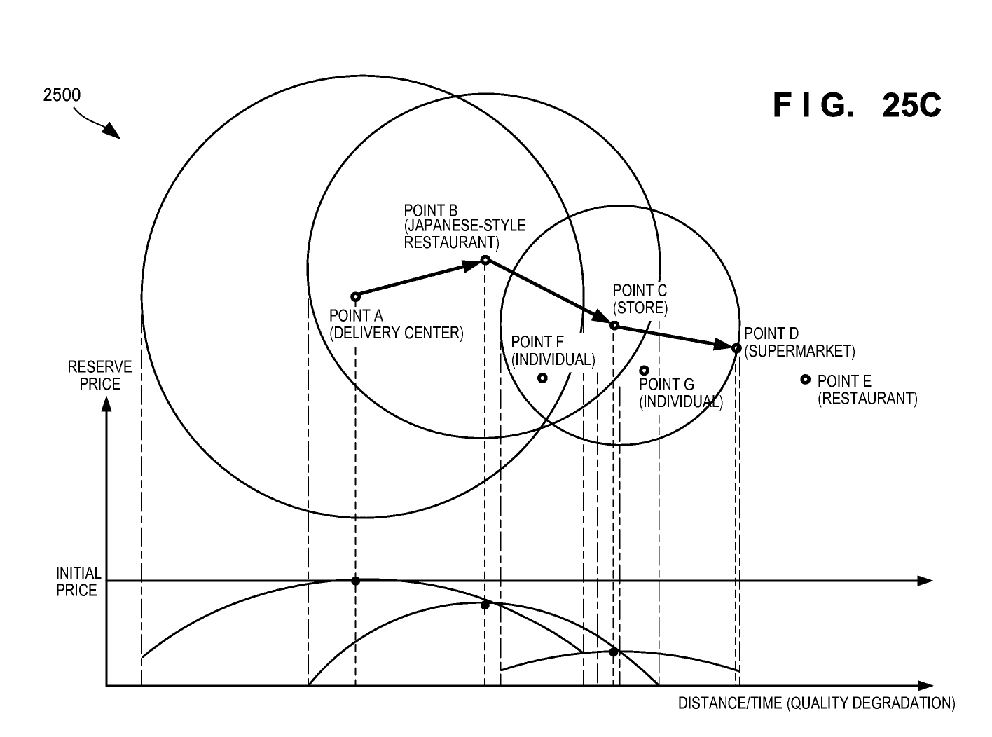

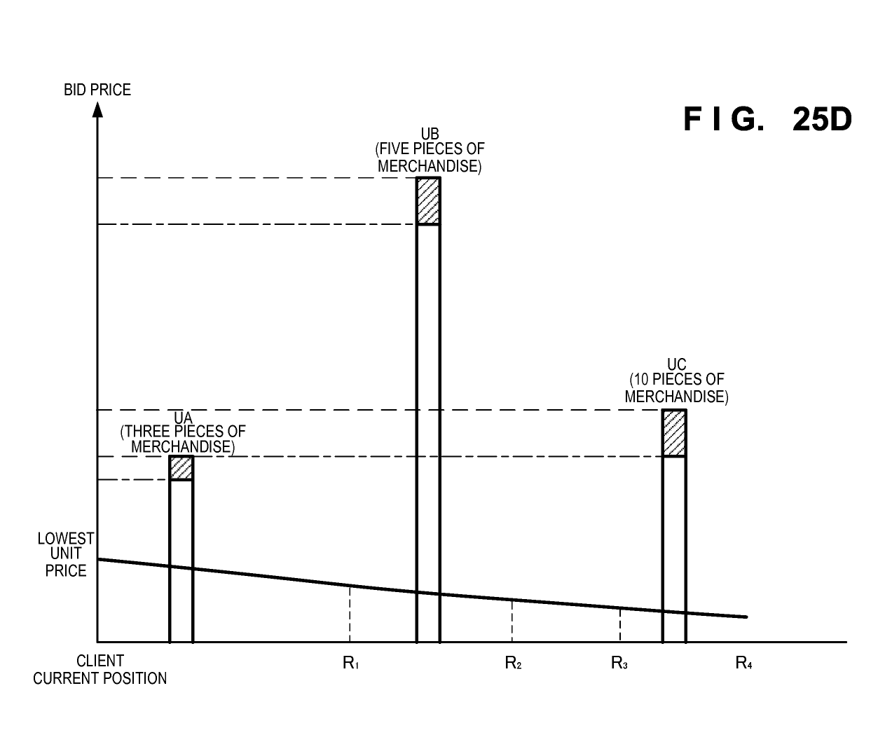

The information processing system according to this embodiment will be described with reference to FIGS. 25A to 25D.

(Explanation of Concept)

FIG. 25A is a view for explaining the concept of an information processing system 2500 according to this embodiment. Note that the same reference numerals as in FIG. 2A of the second embodiment denote the same constituent elements in FIG. 25A.

FIG. 25A illustrates an example in which a merchandise delivery van departs from a point A 201 and delivers a plurality of “fish” as merchandise to users. The users exist at a point B 202, a point C 203, a point D 204, and a point E 205. The user at the point B 202 participates, via a user terminal 221, in the bid to purchase the fish delivered by the merchandise delivery van. The user at the point C 203 participates, via a user terminal 222, in the bid to purchase the fish delivered by the merchandise delivery van. The user terminals at the point D 204 and the point E 205 are not illustrated. The merchandise delivery van is equipped with a client terminal 240. The client terminal 240 navigates the merchandise delivery van to the delivery destination.

When the auction starts, a cloud server 2510 serving as an information processing apparatus predicts quality degradation upon delivery to the points B 202 to the point E 205 using the quality (freshness of fish) of the plurality of fish as the merchandise at the point A 201 as a reference. A price setting transmitter 211 of the cloud server 2510 sets and transmits the reserve price of the bid corresponding to the quality degradation in accordance with the position of each user. The reserve price at the point B 202 is transmitted to the user terminal 221 at the point B 202 and displayed on a display screen 221a. On the other hand, the reserve price at the point C 203 is transmitted to the user terminal 222 at the point C 203 and displayed on a display screen 222a. Note that in this embodiment, the reserve price will be described as the unit price of merchandise. However, the reserve price may be set in consideration of the number or weight of the merchandise.

Each user transmits a bid price to the cloud server 2510 to present the bid price more than the reserve price. Note that the bid price corresponds to the product of the unit price of the merchandise and the number or weight of the merchandise. A delivery destination selector 2512 of the cloud server 2510 collects the bid prices of the users, compares profits obtained by subtracting the merchandise cost price, delivery expense, labor cost, and the like, selects the user of highest profit as the delivery destination candidate, and notifies the client terminal 240 of the merchandise delivery van of it.

Referring to FIG. 25A, since the user terminal 221 presents the bid price of highest profit, the point B 202 is selected as the delivery destination candidate from the point A 201. The point B 202 becomes the sale destination, and a desired number of merchandise are sold. In the auction of remaining merchandise after that, the user terminal 222 presents the bid price of high profit, and the point C 203 is therefore selected as the delivery destination candidate. In this way, the fish are sequentially sold to the point D 204 and the point E 205. When the fish are sold out, or the freshness of the fish falls below the standard of the merchandise, the auction ends.

(Delivery Management)

FIG. 25B is a view for explaining delivery management in the information processing system 2500 according to this embodiment. The upper stage of FIG. 25B shows an example of display of a user terminal 220 that participates in a bid. The lower stage of FIG. 25B shows an example of display of the client terminal 240 of a deliverer who delivers merchandise.

The left view of the upper stage shows a screen 2520a in which a merchandise purchase request is input from the user terminal 220 and transmitted to the cloud server 2510. Merchandise, the number of merchandise, and a desired period are input to a request list 2520b. The left view of the lower stage shows a screen 2541 in which the cloud server 2510 collects the merchandise requests from the user terminals 220 and presents them to the client terminal 240. The size of each circle in the screen 2541 represents the number of requested merchandise.

Upon determining from the screen 2541 that the amount of merchandise requests from the users exceeds the amount capable of generating a profit by delivery, the merchandise deliverer transmits a screen 2542 for the start of delivery to the cloud server 2510, as shown in the central view of the lower stage. The cloud server 2510 sets a reserve price considering merchandise delivery and transmits a bid screen 2520c including the reserve price to the user terminals 220, as shown in the central view of the upper stage. The bid screen is provided with an area 2520d used to input a bid price.

The cloud server 2510 collects the bid prices from the user terminals 220, selects the user of highest profit as the delivery destination candidate, and transmits the delivery destination candidate to the client terminal 240 and the user terminals 220. An example of the display screen on the client terminal 240 and the user terminals 220 at that time is shown in the central view of the upper stage of FIG. 2B of the second embodiment (not shown in this embodiment).

When the delivery destination candidate changes to the sale destination, a sale destination instruction screen 2543 that shows the delivery route to the sale destination is transmitted, as shown in the right view of the lower stage. At the same time, the cloud server 2510 transmits a bid result screen 2520e including the highest bid price to the user terminal 220 of the user decided as the sale destination. In FIG. 25B, a message 2520f “We'll deliver to you next” representing that the highest bidder is the user is also displayed.

Note that cases where the auction temporarily stops, and the delivery destination candidate changes to the sale destination are the cases as described in the second to fourth embodiments. That is, the cases are the case where the merchandise delivery van arrives at the delivery destination candidate without a bid price of higher profit (second embodiment), the case where the distance between the merchandise delivery van and the delivery destination candidate becomes equal to or less than the threshold α (third embodiment), and the case where the delivery time of the merchandise delivery van to the delivery destination candidate becomes equal to or less than the threshold β (fourth embodiment). Note that the present invention is not limited to these examples.

In this embodiment, delivery starts when the amount of merchandise requests from the users exceeds the amount capable of generating a profit by delivery. However, the delivery may start without merchandise requests from the users. Alternatively, the cloud server 2510 may trigger the start of delivery based on a delivery history accumulated in the cloud server 2510.

(Auction Participation Area)

FIG. 25C is a view for explaining an auction participation area in the information processing system 2500 according to this embodiment. Note that in FIG. 25C, the auction participation area at the current position of each merchandise delivery van is set small for the illustrative and descriptive convenience. Note that in actuality, contrivance can be made to do sale within a range as short as possible with short delivery distance or delivery time by setting the auction participation area small in this way.

Referring to FIG. 25C, assume that the point A is provided as the delivery center, and one merchandise delivery van delivers merchandise.

An auction participation area at the time of departure from the delivery center of the point A and a bid price that is the highest at the delivery center of the point A and lowers as the merchandise delivery van moves away are illustrated. Assume that the merchandise delivery van that has departed from the delivery center of the point A decides the Japanese-style restaurant of the point B as the first sale destination by the auction. An auction participation area with respect to the Japanese-style restaurant of the point B corresponding to the current position of the merchandise delivery van as the center and a bid price that is the highest at the Japanese-style restaurant of the point B and lowers as the merchandise delivery van moves away are illustrated. Next, assume that the merchandise delivery van that has departed from the Japanese-style restaurant of the point B decides the store of the point C as the next sale destination by the auction. An auction participation area with respect to the store of the point C corresponding to the current position of the merchandise delivery van as the center and a bid price that is the highest at the store of the point C and lowers as the merchandise delivery van moves away are illustrated. Next, assume that the merchandise delivery van that has departed from the store of the point C decides the supermarket of the point D as the next sale destination by the auction. In this way, the auction participation area becomes small along with the elapse of time, and the bid price also lowers in accordance with quality degradation. For example, if the merchandise is sold out upon arrival of the merchandise delivery van at the point D (supermarket), or no merchandise can be sold any more from then on due to quality degradation, the auction ends.

(Bid Price)

FIG. 25D is a view for explaining the concept of a bid price according to this embodiment. As shown in FIG. 25D, users UA, UB, and UC will be exemplified. The reserve price gradually lowers from the current position of the client (merchandise delivery van). Assume that the users UA, UB, and UC offer the reserve price.

The user UA closest to the client makes a bid for three pieces of merchandise. That is, the bid price is (reserve price)×3. The user UB makes a bid for five pieces of merchandise. That is, the bid price is (reserve price)×5. The user UC makes a bid for 10 pieces of merchandise. That is, the bid price is (reserve price)×10. Each hatched portion in FIG. 25D represents a necessary expense such as a delivery expense. Hence, an amount obtained by subtracting the hatched portion and the cost price is the profit for the client. Hence, in the example of FIG. 25D, the user UB is selected as the delivery candidate for the client (merchandise delivery van). The next delivery destination is thus selected based on the magnitude of the profit for the client.

<<Operation Procedure of Information Processing System>>

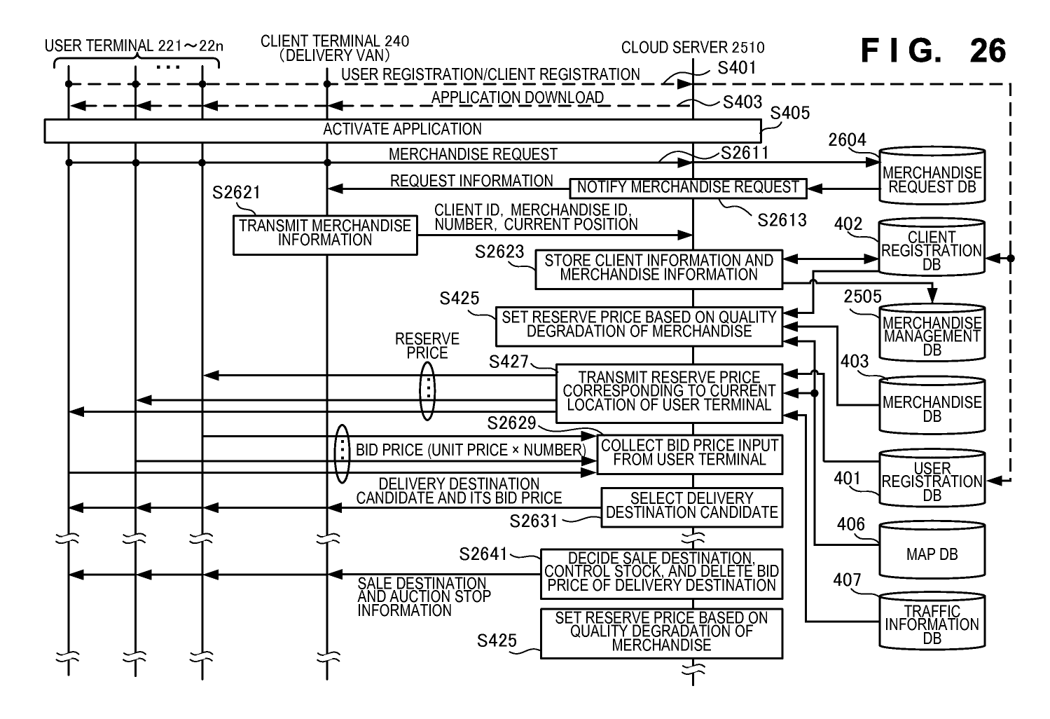

FIG. 26 is a sequence chart showing the operation procedure of the information processing system 2500 according to this embodiment. Note that the same step numbers as in FIG. 4 denote the same steps in FIG. 26, and a description thereof will be omitted.

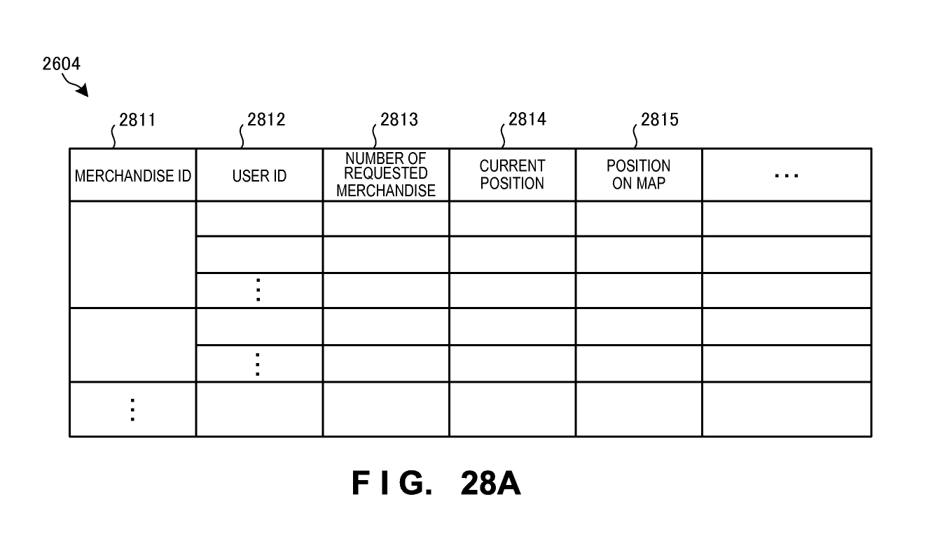

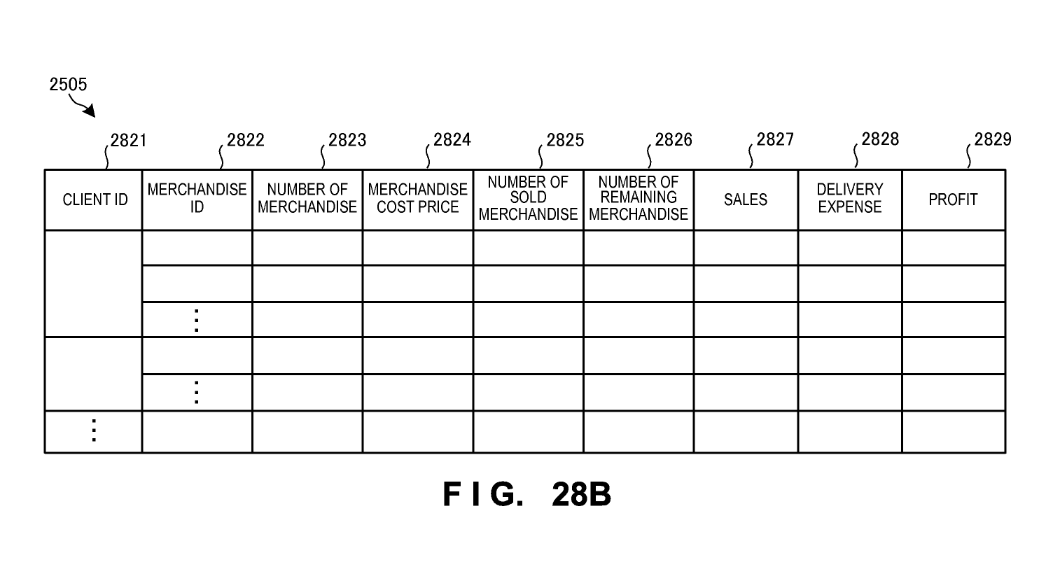

In step S2611, the user terminals 221 to 22n transmit merchandise requests to the cloud server 2510. The cloud server 2510 accumulates the merchandise requests in a merchandise request DB 2604 (see FIG. 28A). In step S2613, the cloud server 2510 transmits the accumulated merchandise request information to the client terminal 240.

In step S2621, the client terminal 240 transmits merchandise information of merchandise whose delivery is to start to the cloud server 2510 based on the merchandise request information. The merchandise information includes a client ID, a merchandise ID, the number of merchandise, and the current position of the client terminal. In step S2623, the cloud server 2510 authenticates the client, registers the current position, and stores the client information and the merchandise information in a merchandise management DB 2505 to manage subsequent merchandise delivery (see FIG. 28B).

In step S2629, the cloud server 2510 collects bid prices based on a unit price more than the reserve price from the user terminals 221 to 22n. The bid price is the product of the merchandise unit price more than the reserve price and the number of merchandise. In step S2631, the cloud server 2510 compares the collected bid prices in consideration of the delivery expense and the like, selects the user of highest profit as the delivery destination candidate, and transmits the delivery destination candidate and its bid price to the user terminals 221 to 22n and the client terminal 240. The user terminals 221 to 22n make new bids with reference to reception of the delivery destination candidate and the bid price. At the same time, the client (merchandise delivery van) drives to the delivery destination candidate. Note that the bid price of the delivery destination candidate need not always be transmitted.

After that, the cloud server 2510 repeats reserve price setting of step S425 to delivery destination candidate selection of step S2631 until the sale destination is decided. When the sale destination is decided in step S2641, the cloud server 2510 performs stock control of subtracting the number of sold merchandise from the quantity of stock, and transmits the decided sale destination and temporary stop information of auction to the user terminals 221 to 22n and the client terminal 240. The cloud server 2510 then deletes the bid price of the delivery destination. After that, in step S425, the cloud server 2510 sets the reserve price based on merchandise degradation prediction with respect to the new current position of the merchandise delivery van as the center again, and continues the next auction.

<<Functional Arrangement of Cloud Server>>

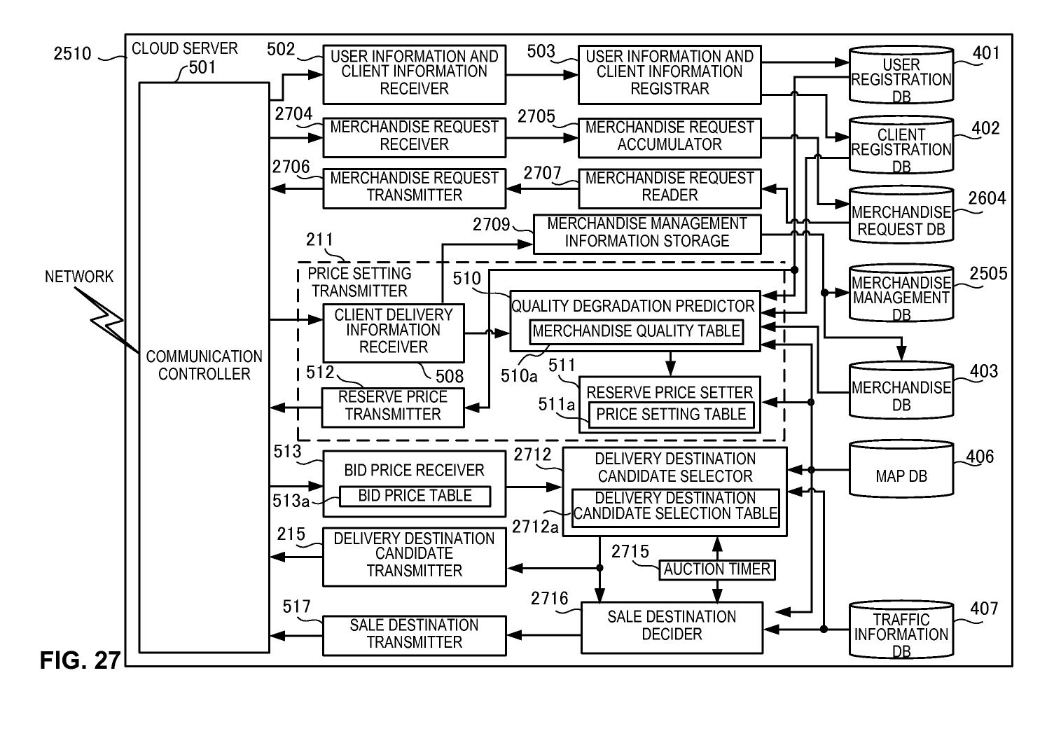

FIG. 27 is a block diagram showing the functional arrangement of the cloud server 2510 according to this embodiment. Note that the same reference numerals as in FIG. 5 denote the same functional constituent elements in FIG. 27, and a description thereof will be omitted.

A merchandise request receiver 2704 receives a merchandise request from the user terminal 220 via a communication controller 501. A merchandise request accumulator 2705 accumulates the merchandise request from the user terminal 220 in the merchandise request DB 2604 (see FIG. 28A). A merchandise request reader 2707 reads out the merchandise request from the user terminal 220, which is accumulated in the merchandise request DB 2604. A merchandise request transmitter 2706 transmits the readout merchandise request from the user terminal 220 to the client terminal 240 via the communication controller 501.

A delivery destination selector 2712 includes a delivery destination candidate selection table 2712a, and selects the user of highest bid price as the delivery destination in consideration of the delivery expense and the like. Note that in this embodiment, reference numerals different from FIG. 5 are added because the delivery destination candidate is selected based on not the unit price of one piece of merchandise but the profit from the bid price of (unit price×number of) a plurality of pieces of merchandise. However, the delivery destination candidate selector 2712 and the delivery destination candidate selection table 2712a are basically the same as the delivery destination candidate selector 212 and the delivery destination candidate selection table 212a shown in FIG. 5, and a description thereof will not be repeated.

A sale destination decider 2716 decides the delivery destination candidate at the time of auction stop as the sale destination. A sale destination transmitter 517 transmits the decided sale destination to the user terminals 221 to 22n and the client terminal 240 via the communication controller 501. Note that an auction timer 2715 is prepared for a case where the auction is to be ended according to the elapsed time. For another end condition, a functional component for it is prepared.

(Merchandise Request DB)

FIG. 28A is a view showing the arrangement of the merchandise request DB 2604 according to this embodiment. The merchandise request DB 2604 accumulates merchandise requests from users who participate in the merchandise bid/delivery application according to this embodiment. Note that the arrangement of the merchandise request DB 2604 is not limited to FIG. 28A.

In association with a merchandise ID 2811, the merchandise request DB 2604 stores a user ID 2812 of a user who has requested the merchandise. The merchandise request DB 2604 also stores a number 2813 of requested merchandise, a current position 2814 of the user, and a position 2815 on a map in association with each user ID 2812.

(Merchandise Management DB)

FIG. 28B is a view showing the arrangement of the merchandise management DB 2505 according to this embodiment. The merchandise management DB 2505 stores the management information of merchandise to be delivered by a client who uses in the merchandise bid/delivery application according to this embodiment. Note that the arrangement of the merchandise management DB 2505 is not limited to FIG. 28B.

In association with a client ID 2821, the merchandise management DB 2505 stores a merchandise ID 2822 of merchandise to be delivered by the client. Note that in this embodiment, a description will be made while limiting the number of kinds of merchandise to be delivered by the client (merchandise delivery van) to one to avoid complexity.

The merchandise management DB 2505 stores a number 2823 of merchandise to be delivered, a merchandise cost price 2824, a number 2825 of sold merchandise, a number 2826 of current remaining merchandise, a current sales 2827, an accumulated delivery expense 2828, and a current profit 2829 in association with each merchandise ID 2822.

<<Processing Procedure of Cloud Server>>

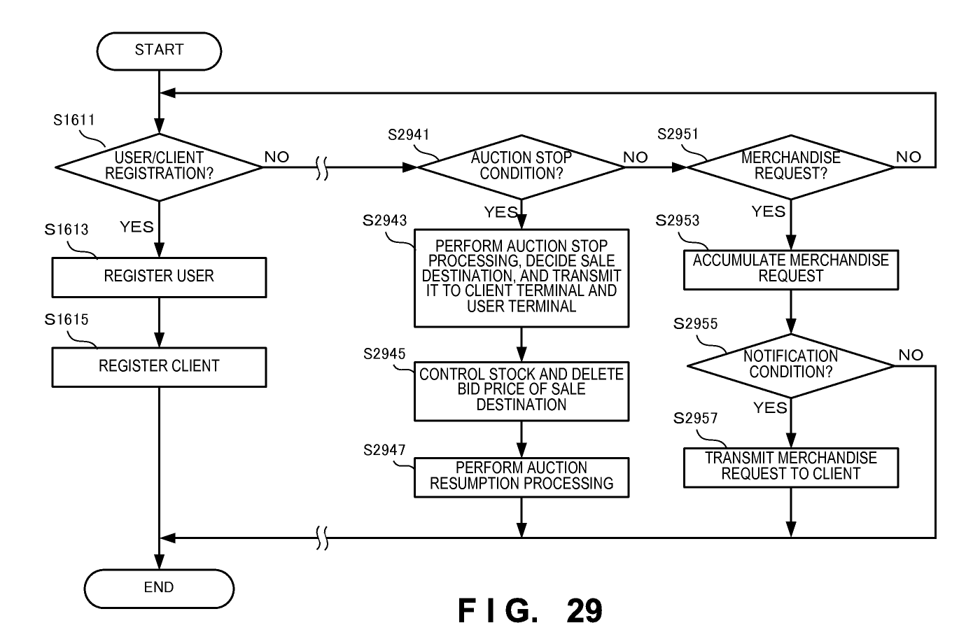

FIG. 29 is a flowchart showing the processing procedure of the cloud server 2510 according to this embodiment. Note that the same step numbers as in FIG. 16 of the second embodiment denote the same steps in FIG. 29, and a description thereof will be omitted.

In FIG. 29, the branches of steps S1621 and S1631 of FIG. 16 and the steps of the processing are omitted. The branch of step S1641 of FIG. 16 and the steps of the processing indicate the procedure for one piece of merchandise and are therefore deleted in FIG. 29. Instead, the branch of step S2941 and the steps of the processing for a plurality of pieces of merchandise replace them. In addition, the branch of step S2951 of merchandise request and the steps of the processing are added.

Upon determining in step S2941 that the auction stop condition is met, the cloud server 2510 advances to step S2943. In step S2943, the cloud server 2510 performs auction stop processing, decides the current delivery destination candidate as the sale destination, and transmits the auction stop and the sale destination that has made a successful bid to the client terminal 240 and the user terminals 221 to 22n. Next, the cloud server 2510 performs stock control and deletes the bid price of the sale destination. In step S2947, the cloud server 2510 resumes the auction to decide the next sale destination.

For a merchandise request from a user, the cloud server 2510 advances from step S2951 to step S2953. In step S2953, the cloud server 2510 accumulates the merchandise request from the user in the merchandise request DB 2604. In step S2955, the cloud server 2510 determines whether the notification condition to the client is met. If the notification condition is met, the cloud server 2510 advances to step S2957 and transmits the merchandise request to the client terminal. Note that the notification condition can be a time interval or a condition that the number of accumulated merchandise request exceeds a threshold. The client terminal of the transmission destination may be selected in correspondence with the kind of merchandise. Alternatively, the merchandise request may be transmitted in response to a request from the client terminal.

### Sixth Embodiment

An information processing system according to the sixth embodiment of the present invention will be described next. The information processing system according to this embodiment is different from the second to fifth embodiments in that the reserve price is set in consideration of an environmental change such as the season or time zone that affects quality degradation. The rest of the components and operations is the same as in the second to fifth embodiments. Hence, the same reference numerals denote the same components and operations, and a detailed description thereof will be omitted.

According to this embodiment, it is possible to implement both an increase in profit and an increase in delivery efficiency appropriately corresponding to a change in environment of quality degradation such as the season or the time zone of a day.

Note that in this embodiment, an example will be described in which reserve price setting according to a change in the degradation condition is prepared in advance. However, the reserve price setting may be changed in real time while hourly detecting the actual degradation condition. It is also possible to accumulate the history of degradation condition and change the reserve price while predicting the variation in degradation condition.

<<Information Processing System>>

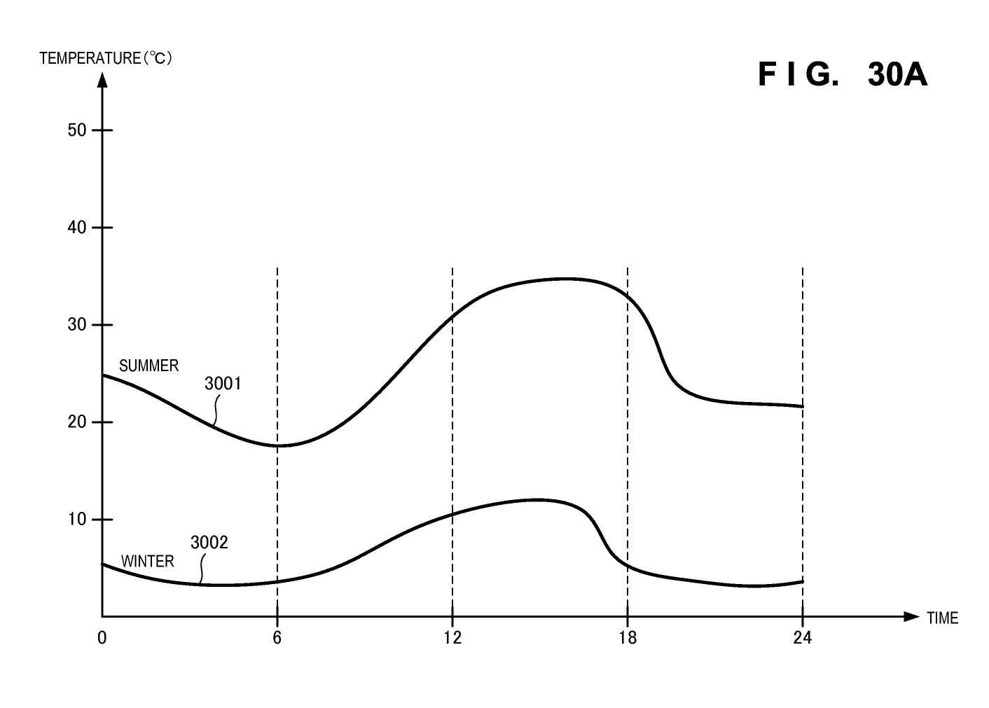

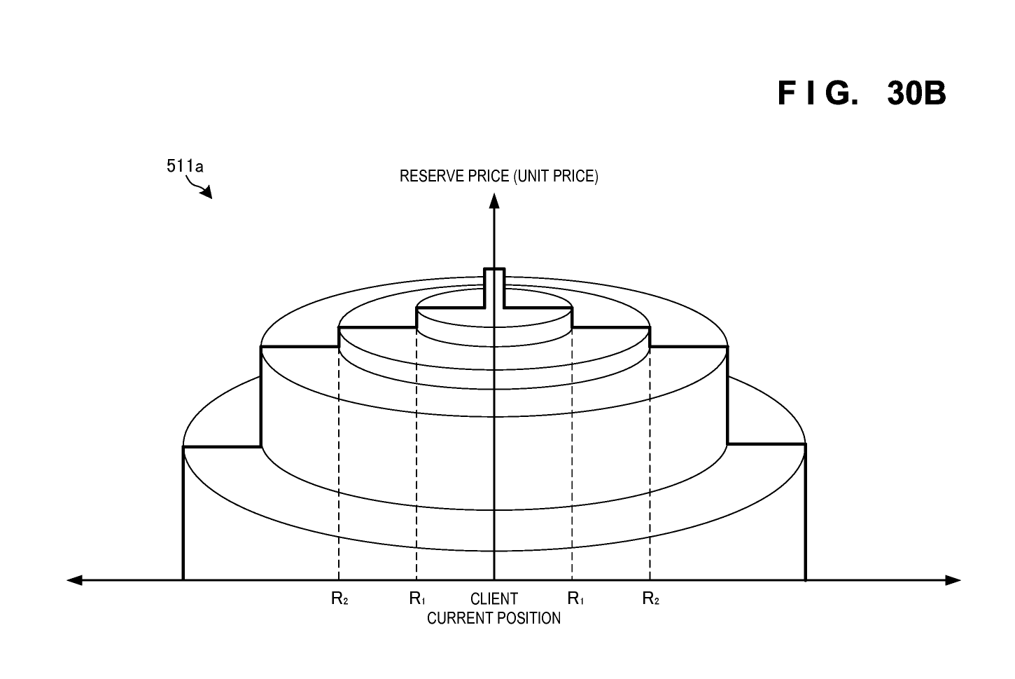

The information processing system according to this embodiment will be described with reference to FIGS. 30A and 30B.

(Explanation of Time Zone)

FIG. 30A is a view for explaining the concept of the time zone in the information processing system according to this embodiment.

As shown in FIG. 30A, for example, when merchandise to be delivered is fish that is a perishable food, the influence of quality degradation by temperature is large. In this case, the temperature changes depending on the season. FIG. 30A shows an example of daily temperature changes in summer and winter. The temperature also changes in one day depending on the time zone.

As the tendency, the temperature is high from sunrise to sunset and in particular tends to be highest in early afternoon. The temperature abruptly lowers after sunset and tends to gradually lower up to a little after dawn.

In this embodiment, stock control is done in consideration of the difference in factor affecting quality degradation of merchandise. Alternatively, stock control is done so as to achieve a higher level of user satisfaction and increase the profit simultaneously. Note that in this example, the factor of quality degradation is limited to temperature. This example is applied even for another factor or even when a plurality of factors affect.

(Reserve Price)

FIG. 30B is a view for explaining the concept of reserve price setting according to this embodiment. In this embodiment, to simplify the processing, the reserve price is set not by a curve as shown in FIG. 2D but for each of regions segmented by concentric circles with respect to the client as the center, unlike the second to fifth embodiments.

As shown in FIG. 30B, the setting is done such that the reserve price of the bid lowers stepwise with respect to the current position of the client as the center. Note that the reserve price is basically the unit price of merchandise. The regions of the reserve prices are set concentrically with respect to the current position of the client as the center. However, regions more adaptive to delivery and quality degradation are preferably set in consideration of roads and the traffic situations of the roads.

<<Functional Arrangement of Cloud Server>>

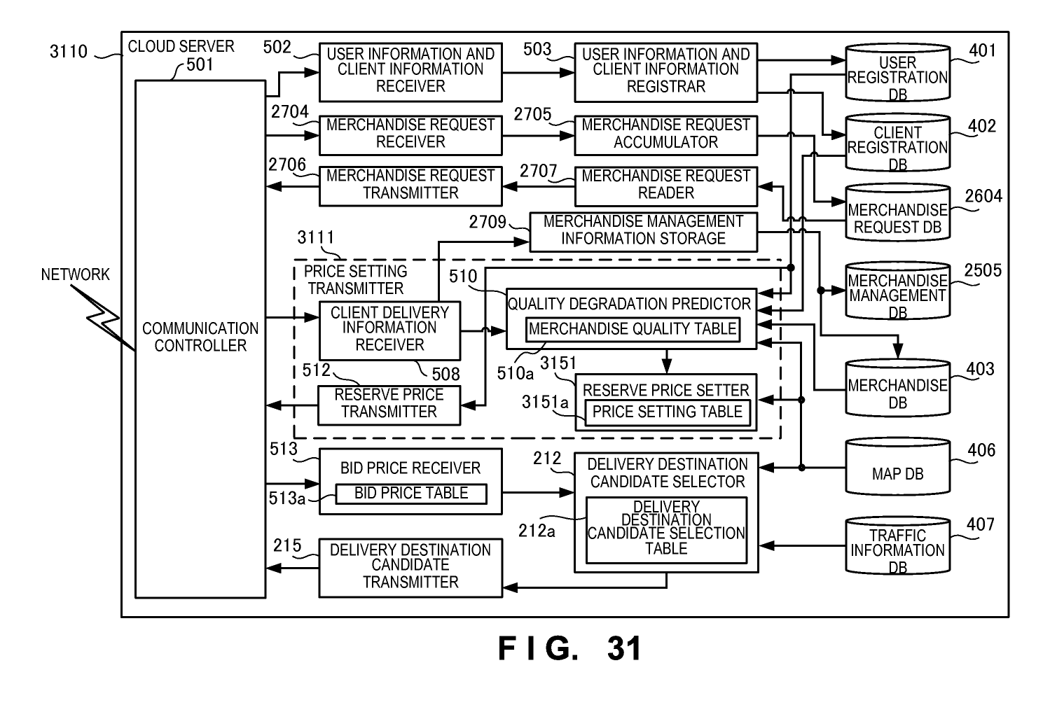

FIG. 31 is a block diagram showing the functional arrangement of a cloud server 3110 according to this embodiment. Note that the same reference numerals as in FIG. 5 or 27 denote the same functional components in FIG. 31, and a description thereof will be omitted.

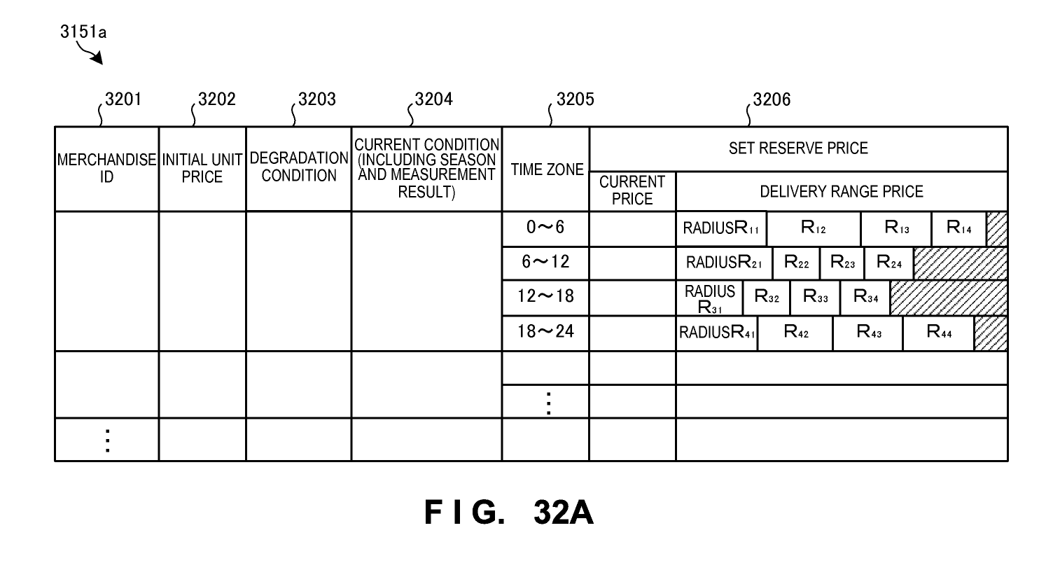

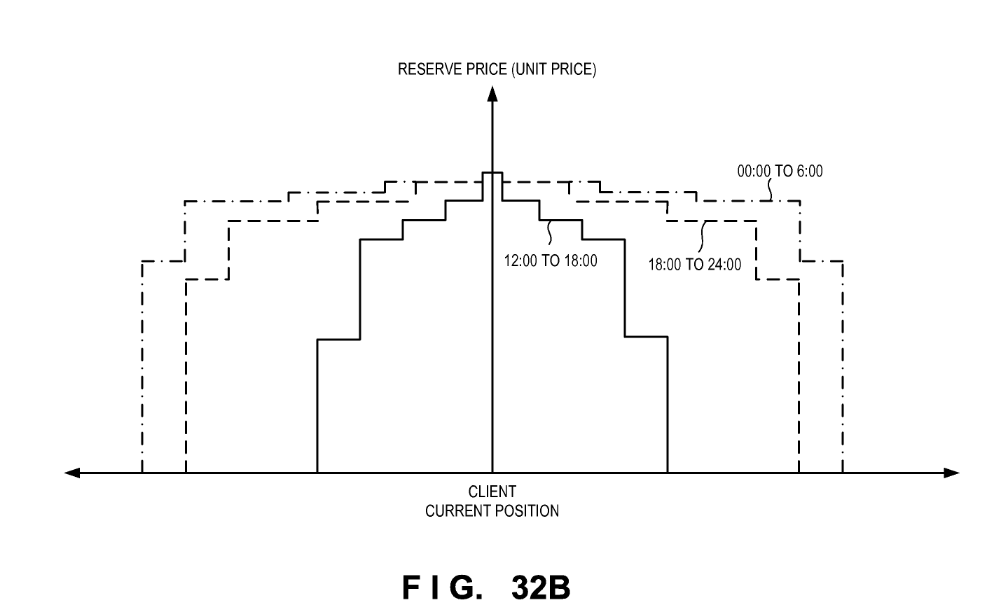

A price setting transmitter 3111 includes a reserve price setter 3151 including a price setting table 3151a (see FIG. 32A). The reserve price setter 3151 refers to the price setting table 3151a and sets a different reserve price in correspondence with quality degradation that changes depending on the season or time zone.

(Price Setting Table)

FIG. 32A is a view showing the arrangement of the price setting table 3151a according to this embodiment. The price setting table 3151a is used to set a reserve price that changes depending on the season or time zone. Note that FIG. 32A shows only setting of the reserve price that changes depending on the time zone. However, the same processing is applied to a variation in another factor of quality degradation.

The price setting table 3151a stores an initial unit price 3202 at the start of delivery of merchandise, a degradation condition (and degradation relaxation condition) 3203 from a merchandise DB 403, a current condition (measured temperature and the like) 3204, a time zone 3205 to set a reserve price, and a reserve price 3206 set depending on the time zone in consideration of the conditions in association with a merchandise ID 3201. The range or setting difference of the set reserve price 3206 changes depending on the time zone. For example, in the time zones of 00:00 to 6:00 and 18:00 to 24:00, the reserve price lowers moderately, and the region to allow a bid is wide. On the other hand, in the time zone of 6:00 to 12:00, and particularly, in the time zone of 12:00 to 18:00, the reserve price lowers steeply, and the region to allow a bid is narrow. Note that the time zone division and reserve price setting are not limited to FIG. 32A. In accordance with merchandise and the factor of quality degradation of the merchandise, time zone division and reserve price setting appropriate for the factor are performed.

FIG. 32B is a view for explaining the concept of the price setting table 3151a according to this embodiment. As is apparent from FIG. 32B, in the time zone of 12:00 to 18:00, since the temperature is high, quality degradation progresses quickly. Hence, the reserve price abruptly lowers, and the bid participation area is narrow. On the other hand, in the time zone of 00:00 to 6:00, since the temperature is low, quality degradation progresses slowly. Hence, the reserve price moderately lowers, and the bid participation area is wide. However, since the time zone of 00:00 to 6:00 is midnight, the labor cost is high although there is little traffic jam. In consideration of these conditions as well, the time zone of high profit is selected as the delivery time zone.

<<Processing Procedure of Cloud Server>>

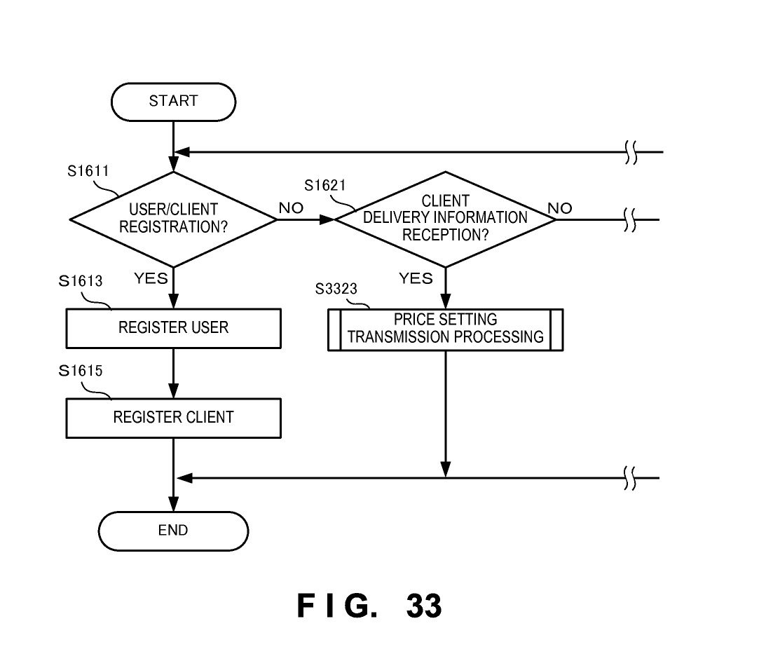

FIG. 33 is a flowchart showing the processing procedure of the cloud server 3110 according to this embodiment. Note that the same step numbers as in FIG. 16 denote the same steps in FIG. 33, and a description thereof will be omitted. The characteristic part of this embodiment is step S3323, and the remaining steps are omitted.

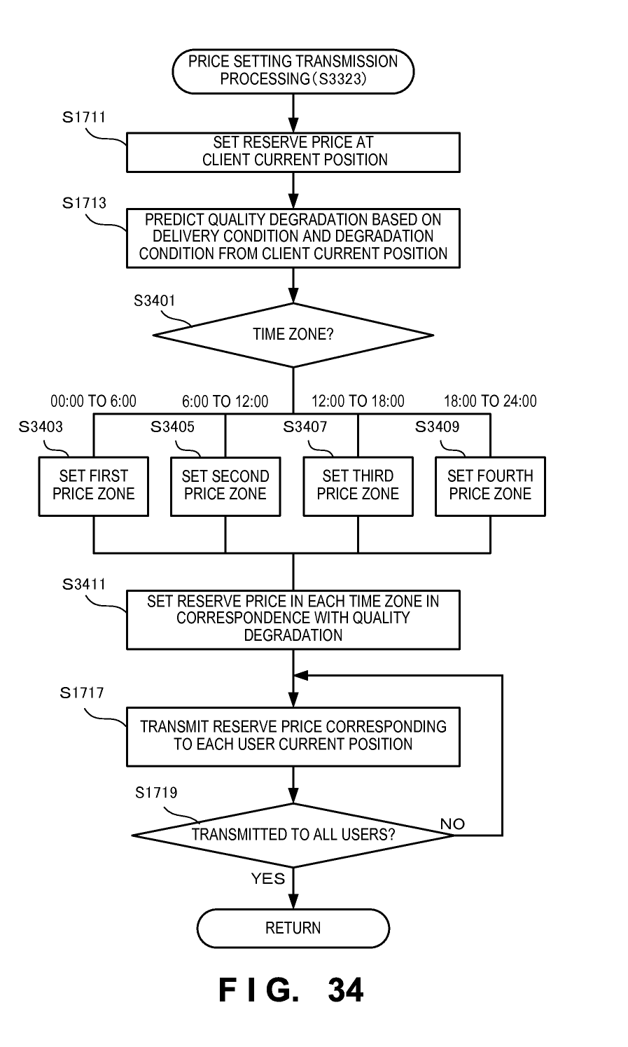

Upon determining in step S1621 to receive delivery information from the client, the cloud server 3110 advances to step S3323 and executes price setting transmission processing (see FIG. 34).

(Price Setting Transmission Processing)

FIG. 34 is a flowchart showing the procedure of price setting transmission processing (S3323) according to this embodiment. The same step numbers as in FIG. 17A denote the same steps in FIG. 34, and a description thereof will be omitted.

In step S3401, the cloud server 3110 determines the current time zone and braches the processing in correspondence with four time zones as shown in, for example, FIGS. 32A and 32B. In the time zone of 00:00 to 6:00, the cloud server 3110 advances to step S3403 and sets the first stage of FIG. 32A as the first time zone. In the time zone of 6:00 to 12:00, the cloud server 3110 advances to step S3405 and sets the second stage of FIG. 32A as the second time zone. In the time zone of 12:00 to 18:00, the cloud server 3110 advances to step S3407 and sets the third stage of FIG. 32A as the third time zone. In the time zone of 18:00 to 24:00, the cloud server 3110 advances to step S3409 and sets the fourth stage of FIG. 32A as the fourth time zone. In step S3411, the cloud server 3110 sets the reserve price corresponding to each time zone. Note that instead of using a preset reserve price, the reserve price may dynamically be set by detecting a factor such as temperature or predicting a change from a history.

### Seventh Embodiment

An information processing apparatus according to the seventh embodiment of the present invention will be described next. An information processing system according to this embodiment is different from the second to sixth embodiments in that the information processing apparatus for managing merchandise delivery is the client terminal of a merchandise delivery van. That is, in this embodiment, no cloud server exists. Note that the delivery management application may be downloaded from the cloud server to the client terminal of the merchandise delivery van. The rest of the components and operations is the same as in the second to sixth embodiments. Hence, the same reference numerals denote the same components and operations, and a detailed description thereof will be omitted.

According to this embodiment, individual merchandise delivery vans independently manage an auction and delivery of merchandise in consideration of quality degradation caused by delivery of the merchandise. This can implement both an increase in profit and an increase in delivery efficiency.

<<Concept of Information Processing System>>

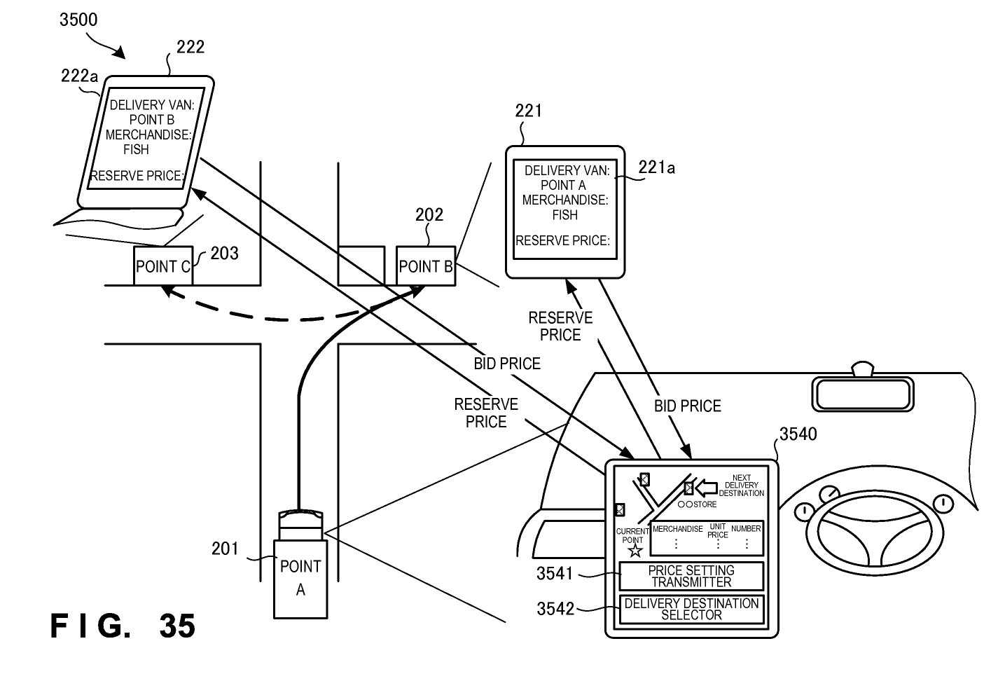

FIG. 35 is a view for explaining the concept of an information processing system 3500 according to this embodiment. Note that the same reference numerals as in FIG. 2A denote the same constituent elements in FIG. 35, and a description thereof will be omitted.

Referring to FIG. 35, a client terminal 3540 mounted on a client (merchandise delivery van) includes a price setting transmitter 3541 that sets a reserve price corresponding to quality degradation caused by merchandise delivery and transmits it to user terminals, and a delivery destination candidate selector 3542 that selects the next delivery destination based on bid prices from the user terminals. That is, in this embodiment, the client terminal 3540 serves as the information processing apparatus and replaces the cloud server 210. Note that the application may be downloaded from the cloud server 210 to the client terminal 3540.

<<Operation Procedure of Information Processing System>>

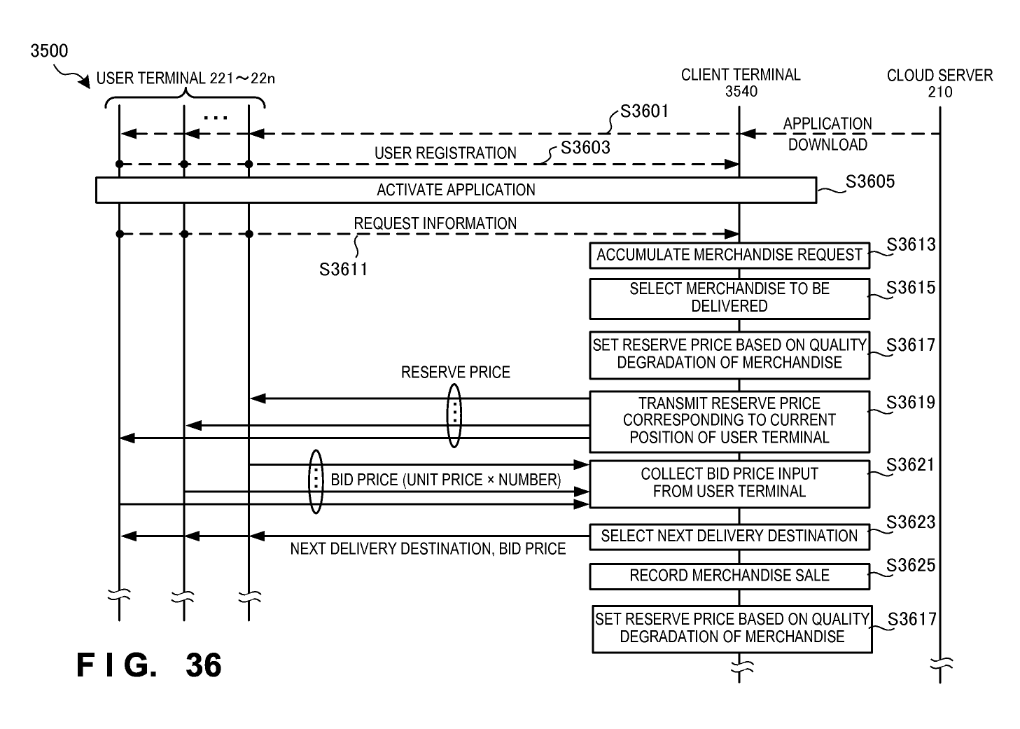

FIG. 36 is a sequence chart showing the operation procedure of the information processing system 3500 according to this embodiment. Referring to FIG. 36, the operation procedure of the cloud server 210 shown in FIG. 4, the cloud server 2510 shown in FIG. 26, or the like is executed by the client terminal 3540.

In step S3601, the cloud server 210 downloads the auction application of this embodiment to user terminals 221 to 22n and the client terminal 3540. In step S3603, the user terminals 221 to 22n of the users transmits user information to the client terminal 3540 of the merchandise delivery van. The client terminal 3540 registers the users in a user registration DB 3703. In step S3605, the client terminal 3540 activates the auction application.

In step S3611, the user terminals 221 to 22n transmit merchandise requests to the client terminal 3540. In step S3613, the client terminal 3540 accumulates the merchandise requests in a merchandise request DB 3706. In step S3615, the client terminal 3540 selects delivery merchandise in accordance with the input of the client. In step S3617, the client terminal 3540 predicts degradation of merchandise based on the current position of the client (merchandise delivery van) by referring to merchandise degradation conditions stored in a merchandise DB 3712, and sets the reserve price of the auction with respect to the current position as the center using a map DB 3713. In step S3619, the client terminal 3540 sets reserve prices corresponding to the current positions of the user terminals 221 to 22n and notifies them. Note that traffic situations such as the delivery route or a traffic jam during delivery are preferably taken into consideration by referring to a traffic information DB.

In step S3621, the client terminal 3540 collects bid prices as a unit price more than the reserve price, which are transmitted from the user terminals 221 to 22n. The bid price is the product of the merchandise unit price more than the reserve price and the number of merchandise. In step S3623, the client terminal 3540 compares the collected bid prices in consideration of the delivery expense and the like, selects the user of highest profit as the next delivery destination, and transmits the next delivery destination and its bid price to the user terminals 221 to 22n. The user terminals 221 to 22n make new bids with reference to reception of the next delivery destination and the bid price. At the same time, the client (merchandise delivery van) drives to the next delivery destination.

In step S3625, the client terminal 3540 performs merchandise sale recording including stock control of subtracting sold merchandise from the stock. The client terminal 3540 performs merchandise degradation prediction of step S3617 again, sets the reserve price of the auction with respect to the current position as the center, and continues the next auction.

<<Functional Arrangement of Client Terminal>>

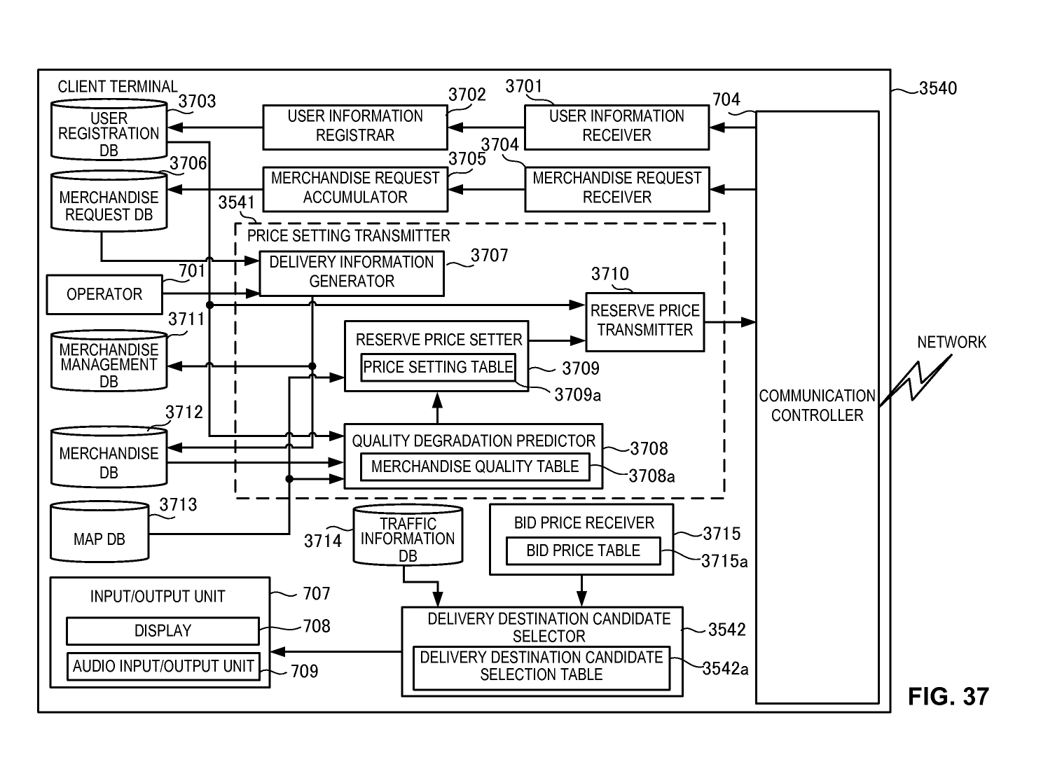

FIG. 37 is a block diagram showing the functional arrangement of the client terminal 3540 according to this embodiment. Note that the same reference numerals as in FIG. 7 denote the same functional components in FIG. 37, and a description thereof will be omitted. Referring to FIG. 37, the client terminal 3540 includes the functional components of the cloud server 210 in FIG. 5 or the cloud server 2510 in FIG. 27. The arrangements of functional components having the same names are the same as in the second or fifth embodiment except the reference numerals. A detailed description of the arrangement will be omitted.

A user information receiver 3701 receives user information such as a user ID and authentication information and user terminal information such as a user terminal ID and authentication information from a user terminal 220 via a communication controller 704. A user information registrar 3702 registers the user in a user registration DB 3703 based on the user information and the user terminal information (see FIG. 8A). A merchandise request receiver 3704 receives a merchandise request from the user terminal 220 via the communication controller 704. A merchandise request accumulator 3705 accumulates the merchandise request from the user terminal 220 in a merchandise request DB 3706 (see FIG. 9B).

The price setting transmitter 3541 includes a delivery information generator 3707, a quality degradation predictor 3708, a reserve price setter 3709, and a reserve price transmitter 3710. The delivery information generator 3707 generates information about merchandise to be delivered by the client (merchandise delivery van) based on the input of the client. The pieces of received information are stored in the merchandise DB 3712 that accumulates merchandise information and a merchandise management DB 3711 used to manage merchandise of the client (merchandise delivery van). The quality degradation predictor 3708 includes a merchandise quality table 3708a (see FIG. 15), and predicts merchandise quality at a position on the map by referring to the map DB 3713 as well. The reserve price setter 3709 includes a price setting table 3709a (see FIG. 12A), and sets a reserve price corresponding to the merchandise quality predicted at the position on the map. The reserve price transmitter 3710 refers to the reserve price set at the position on the map, and transmits the reserve price of the bid at the current position of each user to the user terminal.

A bid price receiver 3715 includes a bid price table 3715a (see FIG. 13A), and receives a bid price from each user terminal 220 via the communication controller 704. The delivery destination candidate selector 3542 includes a delivery destination candidate selection table 3542a (see FIG. 14), and selects the user of highest bid price as the delivery destination in consideration of the delivery expense and the like. The delivery expense is calculated by referring to the map DB 3713 or the traffic information DB (see FIG. 10). The selected next delivery destination is displayed on a display 708. It may be output as an audio. Note that although FIG. 37 does not illustrate an arrangement concerning sale destination decision, the arrangement of another embodiment described above is usable.

<<Processing Procedure of Client Terminal>>

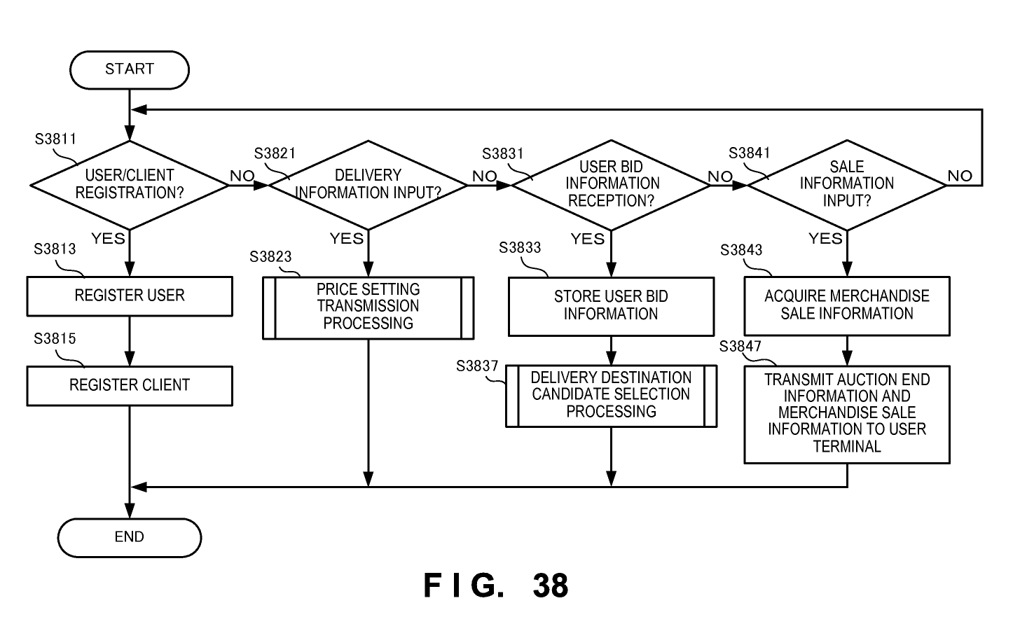

FIG. 38 is a flowchart showing the processing procedure of the client terminal 3540 according to this embodiment. This flowchart is executed by the CPU 2010 shown in FIG. 20 using the RAM 2040 and implements the functional components shown in FIG. 37. The procedure shown in FIG. 38 is similar to the processing procedure of the cloud server 210 according to the second embodiment. The detailed procedures of steps having the same names are the same as the processing procedure of the cloud server according to the second embodiment except the step numbers.

In step S3811, the client terminal 3540 determines whether to register a user or a client. In step S3821, the client terminal 3540 determines whether to input delivery information by a client. In step S3831, the client terminal 3540 determines whether to receive bid information of a user. In step S3841, the client terminal 3540 determines whether to input sale information by a client.

To register a user or a client, the client terminal 3540 advances to step S3813. When registering a user, the client terminal 3540 registers the user in the user registration DB 3703 in step S3813. When registering a client, the client terminal 3540 registers the client in a client registration DB in step S3815.

To input delivery information, the client terminal 3540 advances to step S3823, and executes price setting transmission processing of setting a reserve price considering quality degradation caused by delivery with respect to the current position of the merchandise delivery van as the center and transmitting it to user terminals (see FIG. 17A).

To receive bid information of a user, the client terminal 3540 advances to step S3833, and stores user bid information including a bid price to collet it. In step S3837, the client terminal 3540 executes delivery destination candidate selection processing of selecting, based on the profit, the delivery destination candidate from the bid prices collected so far (see FIG. 17B or 17C).

To input sale information, the client terminal 3540 advances to step S3843, and acquires merchandise sale information. The process advances to step S3847, and the client terminal 3540 transmits auction end information and the merchandise sale information to the user terminals 221 to 22n (client terminal 240).

Note that acquisition of the current position that sequentially changes is not illustrated in FIG. 38. The current position of the user or the current position of the client is transmitted from the user terminals 221 to 22n to the client terminal 3540 sequentially or at the time of information communication.

### Eighth Embodiment

An information processing system according to the eighth embodiment of the present invention will be described next. The information processing system according to this embodiment is different from the second to seventh embodiments in that merchandise delivery by a plurality of merchandise delivery vans is managed in accordance with the same merchandise delivery application. Note that in this embodiment, a case where the same merchandise provider delivers the same merchandise using a plurality of merchandise delivery vans will be described. The rest of the components and operations is the same as in the second to seventh embodiments. Hence, the same reference numerals denote the same components and operations, and a detailed description thereof will be omitted.

According to this embodiment, even in merchandise delivery using a plurality of merchandise delivery vans, the delivery destination is efficiently selected without overlap. It is therefore possible to implement both an increase in total profit and an increase in delivery efficiency by the plurality of merchandise delivery vans.

<<Concept of Information Processing System>>

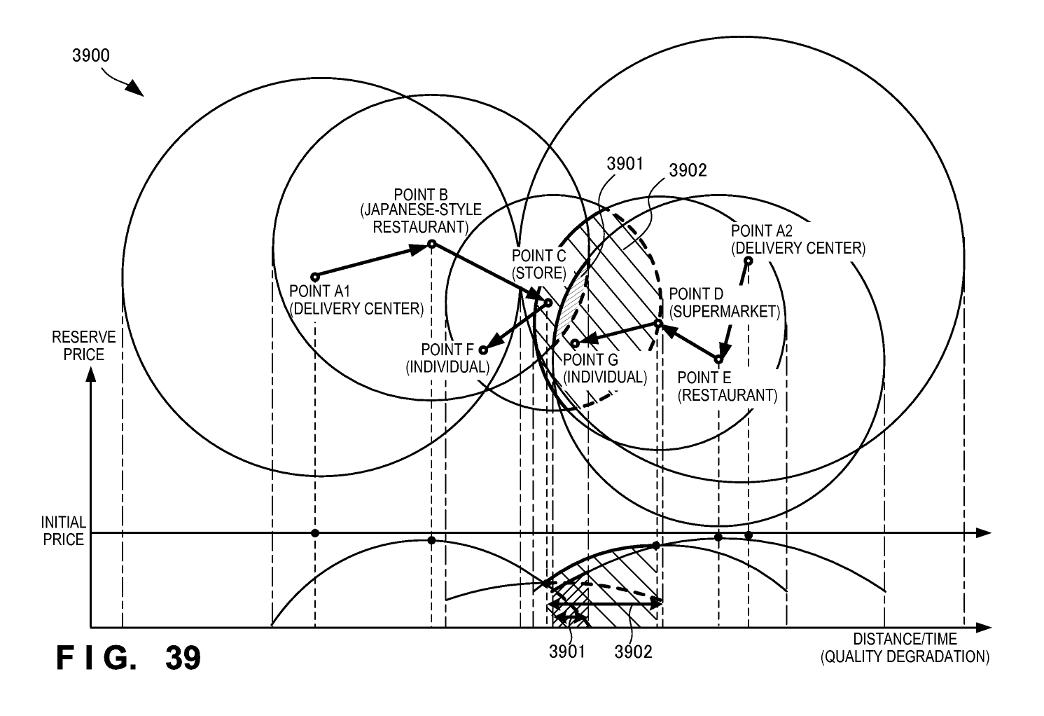

FIG. 39 is a view for explaining the concept of an information processing system 3900 according to this embodiment. Note that in FIG. 39, the bid enable range at the current position of each merchandise delivery van is set small for the descriptive convenience.

Referring to FIG. 39, assume that points A1 and A2 are provided as delivery centers, and one merchandise provider delivers the same merchandise using two merchandise delivery vans. Note that the quality of merchandise at the time of departure from the delivery centers is assumed to be the same. If the qualities are different at the time of departure, different reserve prices are set from the beginning.

The merchandise delivery van that has departed from the delivery center of the point A1 is assumed to select the Japanese-style restaurant of a point B as the first delivery destination. On the other hand, the merchandise delivery van that has departed from the delivery center of the point A2 is assumed to select the restaurant of a point E as the first delivery destination. The bid enable area with respect to the Japanese-style restaurant of the point B that is the current position of one merchandise delivery van as the center and the bid enable area with respect to the restaurant of the point E that is the current position of the other merchandise delivery van as the center overlap in an area 3901. At this time, selecting the destination such that both merchandise delivery vans drive to the same place is wasteful. Hence, in the area 3901, the reserve price set by the merchandise delivery van at the Japanese-style restaurant of the point B and the reserve price set by the merchandise delivery van at the restaurant of the point E are compared, and only the merchandise delivery van that has set the higher reserve price accepts bids of users in the area 3901. In the case of FIG. 39, since the reserve price set by the merchandise delivery van at the restaurant of the point E is higher, user terminals in the area 3901 are notified of only the reserve price corresponding to the merchandise delivery van at the restaurant of the point E. That is, the merchandise delivery van that has set the higher reserve price is predicted to be able to deliver merchandise of higher quality.

Next, the merchandise delivery van that has departed from the delivery center of the point A1 is assumed to select the store of a point C as the next delivery destination. On the other hand, the merchandise delivery van that has departed from the delivery center of the point A2 is assumed to select the supermarket of a point D as the next delivery destination. The bid enable area with respect to the store of the point C that is the current position of one merchandise delivery van as the center and the bid enable area with respect to the supermarket of the point D that is the current position of the other merchandise delivery van as the center overlap in an area 3902. At this time, selecting the destination such that both merchandise delivery vans drive to the same place is wasteful. Hence, in the area 3902, the reserve price set by the merchandise delivery van at the store of the point C and the reserve price set by the merchandise delivery van at the supermarket of the point D are compared, and only the merchandise delivery van that has set the higher reserve price accepts bids of users in the area 3902. In the case of FIG. 39, since the reserve price set by the merchandise delivery van at the supermarket of the point D is higher, user terminals in the area 3902 are notified of only the reserve price corresponding to the merchandise delivery van at the supermarket of the point D.

Since an individual at a point G in the area 3902 is thus excluded from the bid to decide the next delivery destination for the merchandise delivery van at the store of the point C, the merchandise delivery van drives to an individual at a point F in the area except the area 3902. On the other hand, the merchandise delivery van at the supermarket of the point D can drive to the individual at the point G in the area 3902. In this way, when two merchandise delivery vans deliver merchandise to the same user, a bid for the merchandise delivery van capable of delivering merchandise of higher quality is accepted. This makes it possible to increase the total profit while achieving a higher level of user satisfaction.

<<Operation Procedure of Information Processing System>>

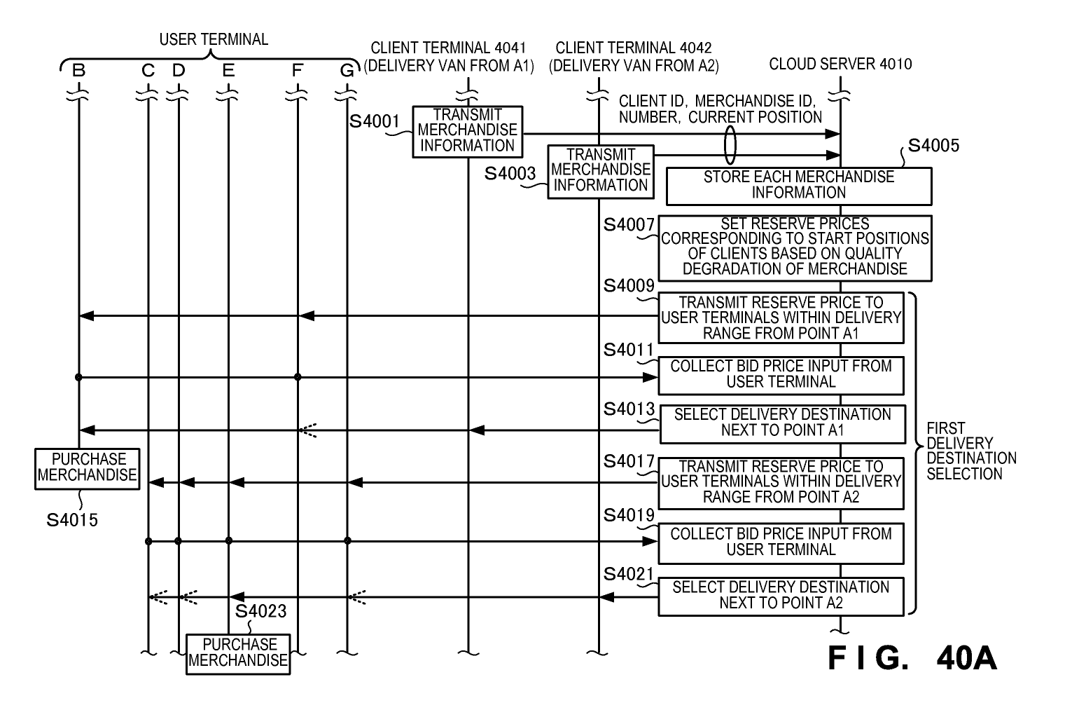

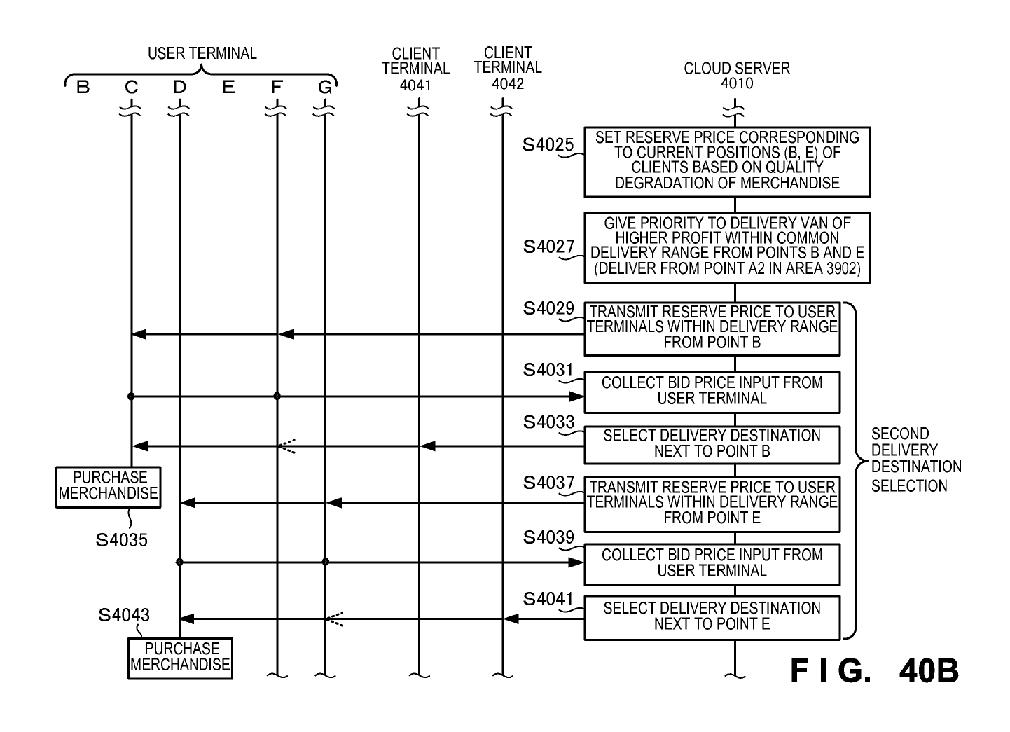

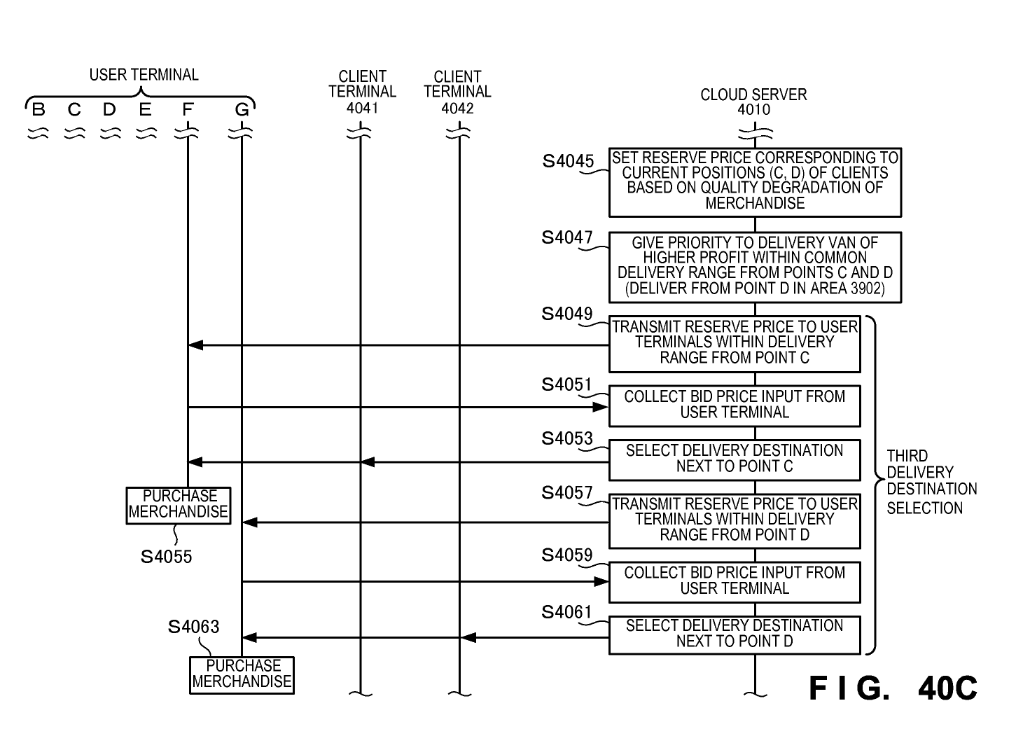

FIGS. 40A to 40C are sequence charts showing the operation procedure of the information processing system 3900 according to this embodiment. Note that FIG. 40A does not illustrate the processing before a bid shown in FIG. 4. Additionally, FIGS. 40A to 40C sequentially illustrate the delivery operation in FIG. 39 without repetition.

In step S4001, a client terminal 4041 mounted on the merchandise delivery van departing from the point A1 transmits merchandise information to a cloud server 4010. In step S4003, a client terminal 4042 mounted on the merchandise delivery van departing from the point A2 transmits merchandise information to the cloud server 4010. In step S4005, the cloud server 4010 stores each merchandise information. In step S4007, the cloud server 4010 sets a reserve price corresponding to the start positions of the clients based on merchandise degradation prediction. In this case, since the delivery enable areas do not overlap, all users in the delivery enable areas are notified of the reserve price.

In step S4009, the cloud server 4010 transmits the reserve price to the users in the delivery enable area from the point A1. At this point of time, the reserve price is transmitted to the user terminals at the points B and F, as shown in FIG. 39. In step S4011, the cloud server 4010 collects bid prices offered from the user terminals. In step S4013, the cloud server 4010 selects the delivery destination next to the point A1. In the example of FIG. 39, the Japanese-style restaurant of the point B is selected. In step S4015, the Japanese-style restaurant of the point B purchases the merchandise. On the other hand, in step S4017, the cloud server 4010 transmits the reserve price to the users in the delivery enable area from the point A2. At this point of time, the reserve price is transmitted to the user terminals at the points B, D, E, and G, as shown in FIG. 39. In step S4019, the cloud server 4010 collects bid prices offered from the user terminals. In step S4021, the cloud server 4010 selects the delivery destination next to the point A2. In the example of FIG. 39, the restaurant of the point E is selected. In step S4023, the restaurant of the point E purchases the merchandise.

The process advances to FIG. 40B. In step S4025, the cloud server 4010 sets reserve prices corresponding to the current positions (points B and E) of the clients based on merchandise degradation prediction. In this case, the delivery enable areas overlap. Hence, in step S4027, the cloud server 4010 compares the reserve prices in the area 3901 where the delivery enable areas overlap. The merchandise delivery van of higher reserve price can be predicted to offer higher quality and generate a higher profit. The user terminals in the area 3901 are notified of the reserve price to make a bid for the merchandise delivery van at the point E.

The processes of steps S4029 to S4043 of FIG. 40B are the same as steps S4009 to S4023 of FIG. 40A except that one bid is selected in the area 3901 where the delivery enable areas overlap. As a result, the points C and D are selected as the next delivery destinations.

The process advances to FIG. 40C. In step S4045, the cloud server 4010 sets reserve prices corresponding to the current positions (points C and D) of the clients based on merchandise degradation prediction. In this case, the delivery enable areas overlap. Hence, in step S4047, the cloud server 4010 compares the reserve prices in the area 3902 where the delivery enable areas overlap. The merchandise delivery van of higher reserve price can be predicted to offer higher quality and generate a higher profit. The user terminals in the area 3902 are notified of the reserve price to make a bid for the merchandise delivery van at the point D.

The processes of steps S4049 to S4063 of FIG. 40C are the same as steps S4009 to S4023 of FIG. 40A and steps S4029 to S4043 of FIG. 40B except that one bid is selected in the area 3902 where the delivery enable areas overlap. As a result, the points F and G are selected as the next delivery destinations.

The same processing as described above is repeated from then on, and the bid enable regions are managed such that the two merchandise delivery vans can sell merchandise of higher quality at higher prices. Note that in this example, two merchandise delivery vans are used. However, the same technique is applicable to delivery management of a plurality of merchandise delivery vans in larger number.

<<Functional Arrangement of Cloud Server>>

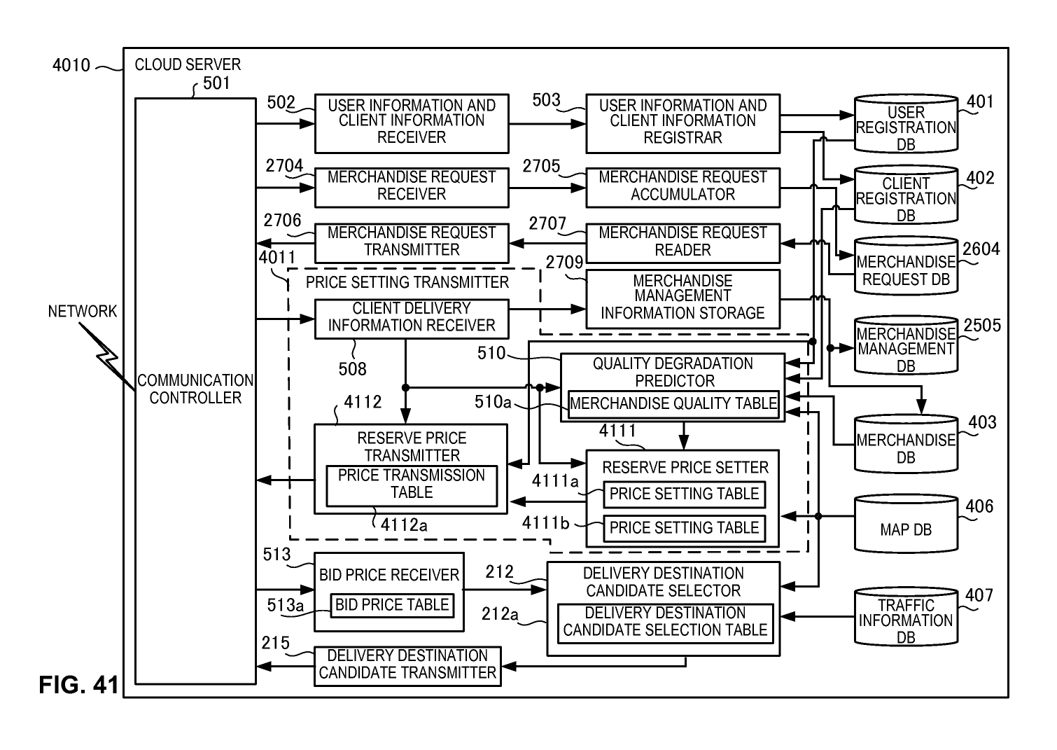

FIG. 41 is a block diagram showing the functional arrangement of the cloud server 4010 according to this embodiment. Note that the same reference numerals as in FIG. 5 or 27 denote the same functional components in FIG. 41, and a description thereof will be omitted.

A price setting transmitter 4011 includes a reserve price setter 4111 including a plurality of price setting tables 4111a, 4111b, . . . , and a reserve price transmitter 4112 including a price transmission table 4112a. The reserve price setter 4111 sets reserve prices based on the current positions of merchandise delivery vans by referring to the price setting tables 4111a, 4111b, . . . . The reserve price transmitter 4112 compares the reserve prices of the merchandise delivery vans set by the reserve price setter 4111, and transmits only the higher reserve price to users in the same area to enable bid.

Note that each of the price setting tables 4111a, 4111b, . . . corresponds to the price setting table 511a in FIG. 12A, and a detailed description of the arrangement will be omitted.

(Price Transmission Table)

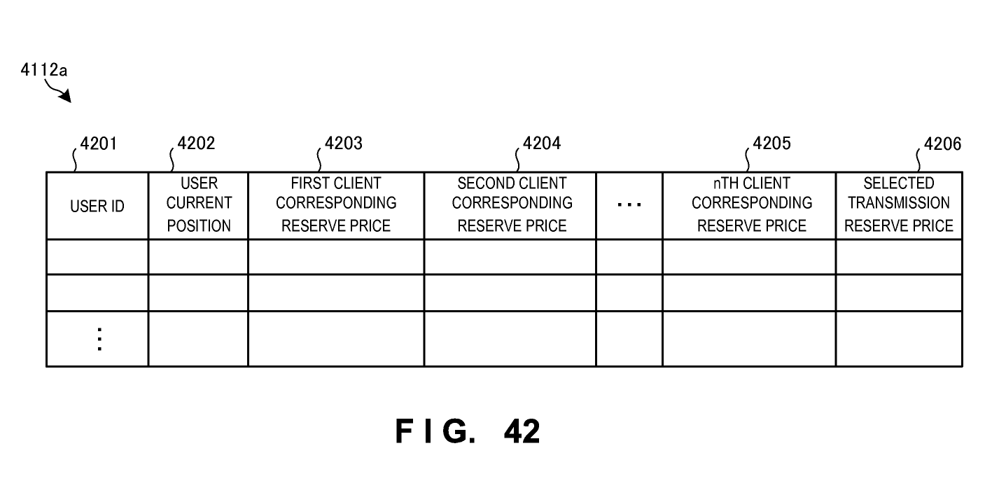

FIG. 42 is a view showing the arrangement of the price transmission table 4112a according to this embodiment. The price transmission table 4112a is used to control reserve price transmission to users so as to avoid the same user from participating in a plurality of different bids and allow the users to make bids for only a merchandise delivery van predicted to offer higher quality and generate a higher profit.

The price transmission table 4112a stores a user current position 4202, a first client (merchandise delivery van) corresponding reserve price 4203, a second client (merchandise delivery van) corresponding reserve price 4204, . . . , and an nth client (merchandise delivery van) corresponding reserve price 4205 in association with a user ID 4201. The price transmission table 4112a stores a higher reserve price selected from the reserve prices as a transmission reserve price 4206.

<<Processing Procedure of Cloud Server>>

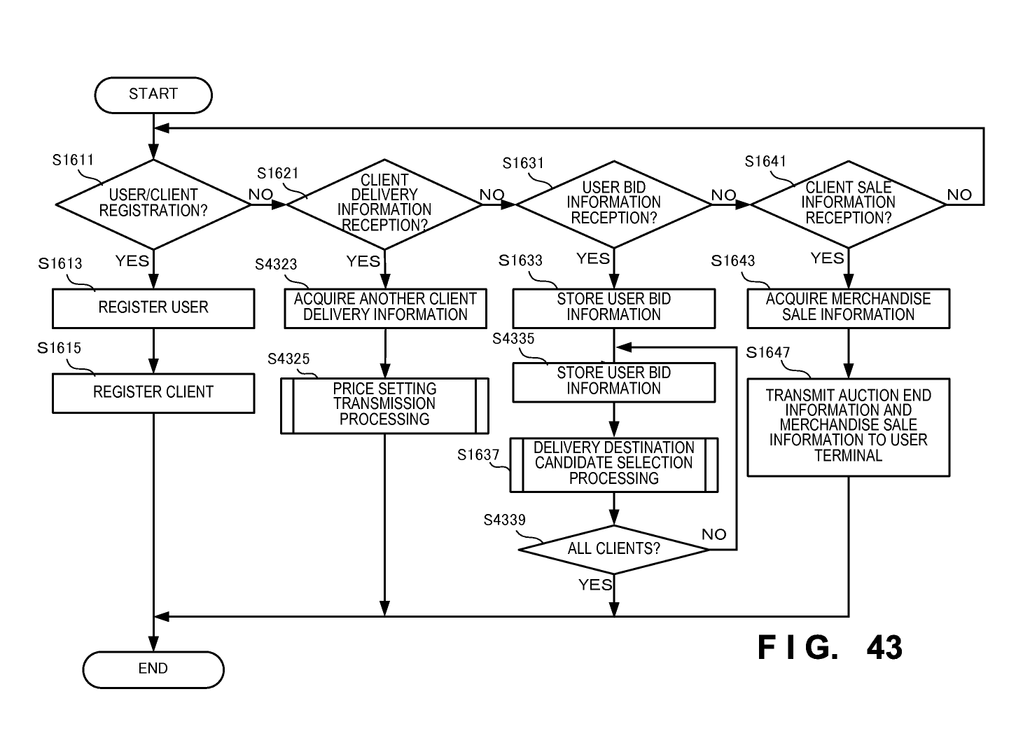

FIG. 43 is a flowchart showing the processing procedure of the cloud server 4010 according to this embodiment. Note that the same step numbers as in FIG. 16 denote the same steps in FIG. 43, and a description thereof will be omitted.

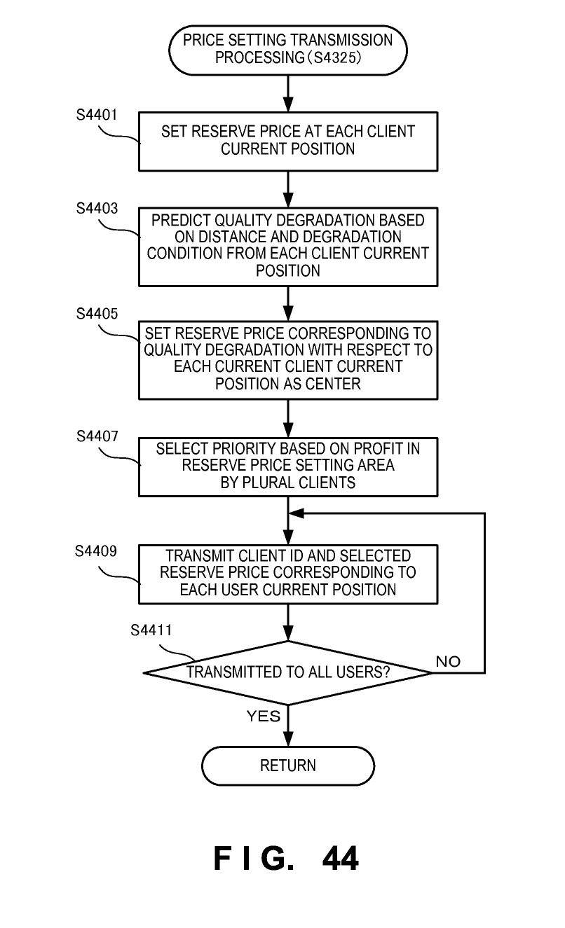

Upon determining in step S1621 to receive delivery information from a client, the cloud server 4010 advances to step S4323 and acquires the delivery information of another client (merchandise delivery van) that delivers the same merchandise. In step S4325, the cloud server 4010 executes price setting transmission processing according to this embodiment (see FIG. 44).

Upon determining to receive user bid information from a user terminal, the cloud server 4010 selects one client (merchandise delivery van) and performs delivery destination candidate selection processing (S1637) in step S4335. In step S4339, the cloud server 4010 repeats the delivery destination selection processing for the remaining clients (merchandise delivery vans) and ends the processing when the processing has ended for all clients (merchandise delivery vans) involved in the delivery of the merchandise.

(Price Setting Transmission Processing)

FIG. 44 is a flowchart showing the procedure of price setting transmission processing (S4325) according to this embodiment. Note that FIG. 44 is similar to FIG. 17A except that there exist a plurality of clients.

In step S4401, the cloud server 4010 sets a reserve price at the current position of each client (merchandise delivery van). In step S4403, the cloud server 4010 predicts quality degradation in the region or at each point based on the delivery conditions and the degradation conditions from the current position of each client. The delivery conditions include the distance and delivery time from the current position of each client. In step S4405, the cloud server 4010 sets a reserve price considering the quality degradation with respect to the current position of each client as the center. In step S4407, the cloud server 4010 sets priority based on the profit in the reserve price setting area by the plurality of clients. That is, a priority on a bid in that area is given to the client (merchandise delivery van) of higher reserve price. In step S4409, the cloud server 4010 transmits the reserve price corresponding to the current position of each user, which is given the priority, to the user terminal. In step S4411, the cloud server 4010 controls to transmit the corresponding reserve price to each user in step S4409 until the reserve price is transmitted to all users capable of making a bid.

### Ninth Embodiment

An information processing system according to the ninth embodiment of the present invention will be described next. The information processing system according to this embodiment is different from the eighth embodiment in that merchandise delivery in a case where a plurality of merchandise delivery vans of different merchandise providers deliver merchandise is managed. Note that in this embodiment, a case in which the same merchandise having the same quality are delivered based on different initial prices (reserve prices at the start of delivery) will be described. The rest of the components and operations is the same as in the eighth embodiment. Hence, the same reference numerals denote the same components and operations, and a detailed description thereof will be omitted.

According to this embodiment, even in merchandise delivery by a plurality of merchandise providers, the delivery destination is efficiently selected without overlap. It is therefore possible to implement both an increase in each other's profit and an increase in delivery efficiency while achieving a higher level of user satisfaction.

<<Concept of Information Processing System>>

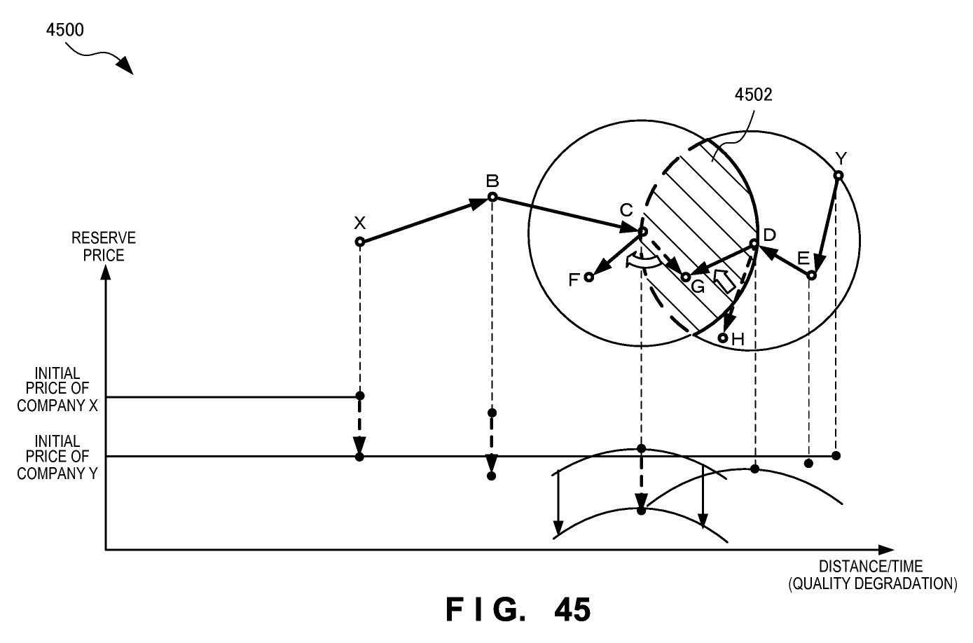

FIG. 45 is a view for explaining the concept of an information processing system 4500 according to this embodiment.

Referring to FIG. 45, assume that companies X and Y are provided as delivery centers each of which delivers the same merchandise using one merchandise delivery van. Note that the quality of merchandise at the time of departure from the delivery centers is assumed to be the same.

The merchandise delivery van that has departed from the delivery center of the company X is assumed to select a point C via a point B. On the other hand, the merchandise delivery van that has departed from the delivery center of the company Y is assumed to select a point D via a point E. The bid enable area with respect to the point C that is the current position of the merchandise delivery van of the company X as the center and the bid enable area with respect to the point D that is the current position of the merchandise delivery van of the company Y as the center overlap in an area 4502. At this time, selecting the destination such that the merchandise delivery vans of both companies drive to the same place is wasteful from the viewpoint of the total user satisfaction level and profit or the delivery expense, and does not contribute to CO₂ reduction.

However, since the merchandise delivery vans do not belong to the same company, unlike the eighth embodiment, different reserve prices may be set even when the quality is the same. Hence, in this embodiment, the reserve prices at the departure points of the companies X and Y are standardized and converted such that the same reserve price is set for the same quality, and the bid in which users in the overlap area 3502 should participate is selected. After standardizing the reserve prices, in the area 4502, the reserve price set by the merchandise delivery van at the point C and the reserve price set by the merchandise delivery van at the point D are compared, and only the merchandise delivery van that has set the higher reserve price accepts bids of users in the area 4502. In the case of FIG. 45, since the standardized reserve price set by the merchandise delivery van at the point D is higher, user terminals in the area 4502 are notified of only the reserve price corresponding to the merchandise delivery van at the point D.

Since a point G in the area 4502 is thus excluded from the bid to decide the next delivery destination for the merchandise delivery van of the company X at the point C, the merchandise delivery van drives to a point F in the area except the area 4502. On the other hand, the merchandise delivery van of the company Y at the point D can drive to the point G in the area 4502. In this way, when the merchandise delivery vans of two companies deliver merchandise to the same user, only a bid for the merchandise delivery van capable of delivering merchandise of higher quality is accepted. This makes it possible to eliminate waste and contribute to CO₂ reduction while achieving a higher level of user satisfaction.

<<Operation Procedure of Information Processing System>>

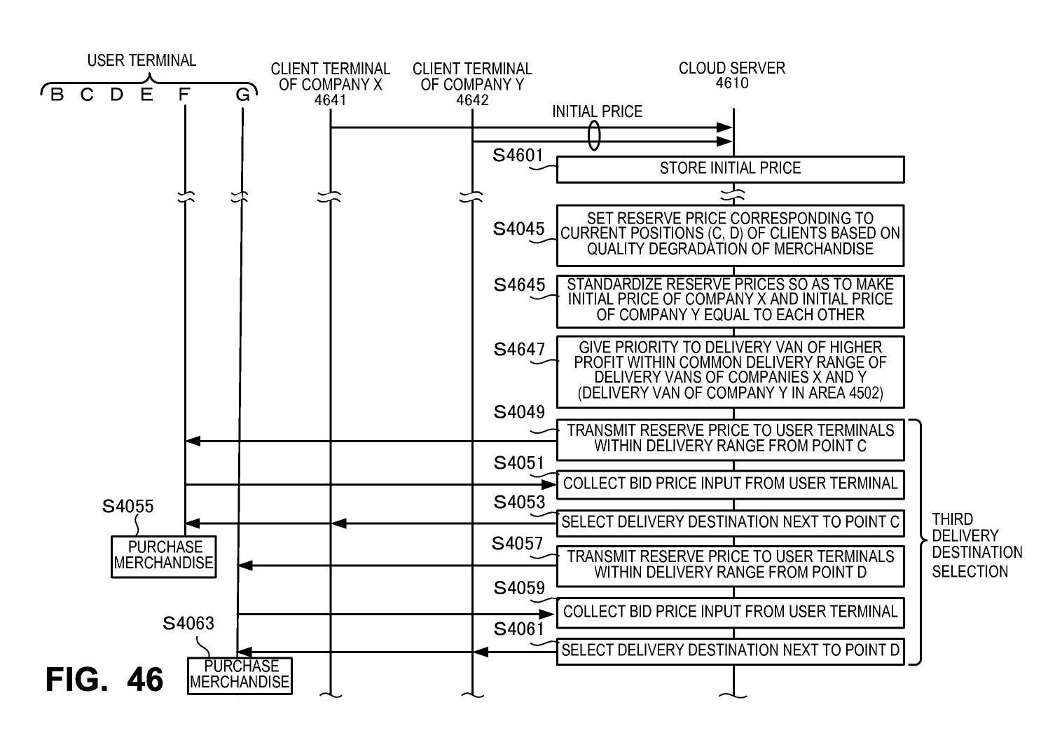

FIG. 46 is a sequence chart showing the operation procedure of the information processing system 4500 according to this embodiment. Note that FIG. 46 shows an operation procedure corresponding to FIG. 40C of the eighth embodiment. The same step numbers as in FIG. 40C denote the same steps in FIG. 46, and a description thereof will be omitted.

In step S4645, a cloud server 4610 standardizes the current reserve prices such that the initial price of the company X and the initial price of the company equal each other. In step S4647, the cloud server 4610 gives priority to the merchandise delivery van of higher profit (and higher quality) in the common delivery range of the merchandise delivery van of the company X and the merchandise delivery van of the company Y. That is, the area 4502 in FIG. 45 is the bid area of the merchandise delivery van of the company Y.

<<Functional Arrangement of Cloud Server>>

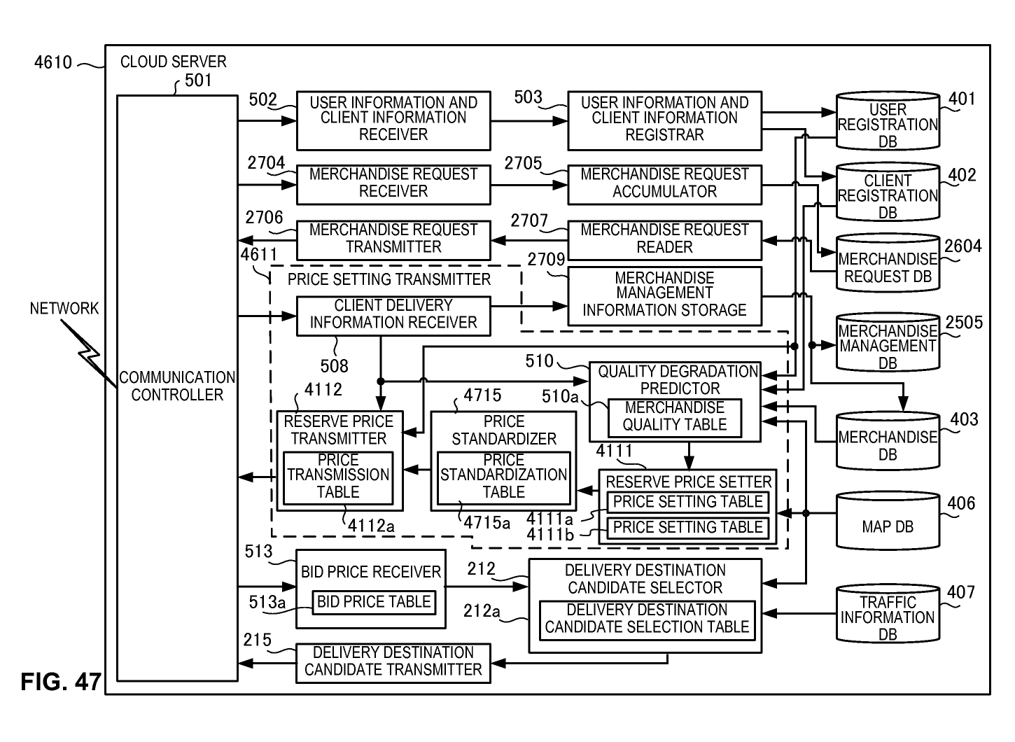

FIG. 47 is a block diagram showing the functional arrangement of the cloud server 4610 according to this embodiment. Note that the same reference numerals as in FIG. 41 denote the same functional components in FIG. 47, and a description thereof will be omitted.

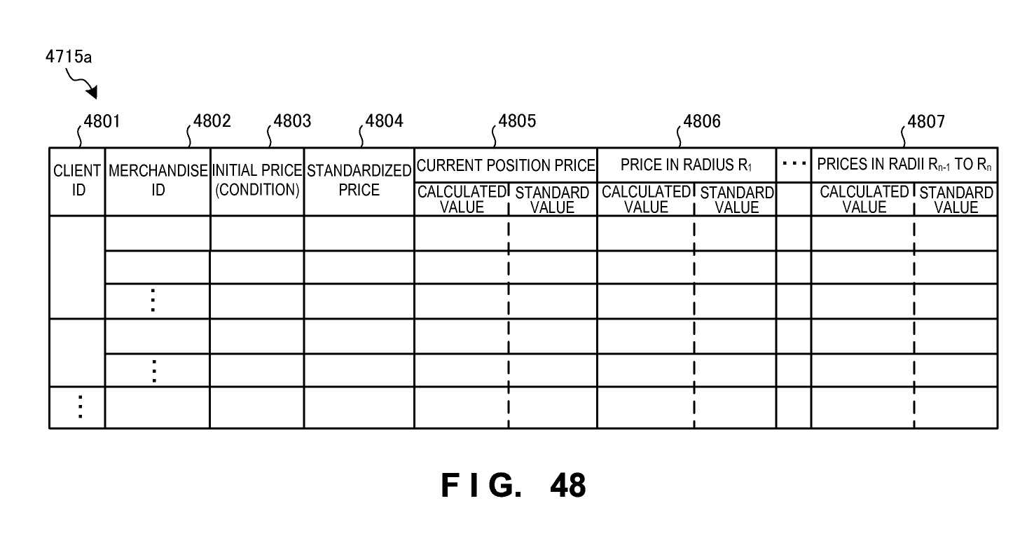

In a price setting transmitter 4611 shown in FIG. 47, a price standardizer 4715 including a price standardization table 4715a (see FIG. 48) is added to the arrangement of FIG. 41. The price standardizer 4715 performs standardization for reserve prices set for a plurality of merchandise delivery vans by a reserve price setter 4111 so that the same price is set when quality at the time of departure is the same, and controls reserve price transmission destination selection by a reserve price transmitter 4112 such that the user can obtain merchandise of higher quality.

(Price Standardization Table)

FIG. 48 is a view showing the arrangement of the price standardization table 4715a according to this embodiment. The price standardization table 4715a is used to normalize reserve prices set for a plurality of clients of different companies so as to compare them under the same condition.

The price standardization table 4715a stores a merchandise ID 4802 in correspondence with a client ID 4801. The price standardization table 4715a stores an initial price 4803 and a standardized price 4804 that makes the initial prices match in association with each merchandise ID 4802. The price standardization table 4715a also stores a calculated value and a standard value obtained by standardizing the initial price into a standardized price for each of a current position price 4805, a price 4806 within a radius R1, . . . , and prices within radii Rn−1 to Rn.

The reserve price transmitter 4112 of the cloud server 4610 compares the standard values, selects the transmission destination user, and transmits the calculated value to the transmission destination user.

<<Processing Procedure of Cloud Server>>

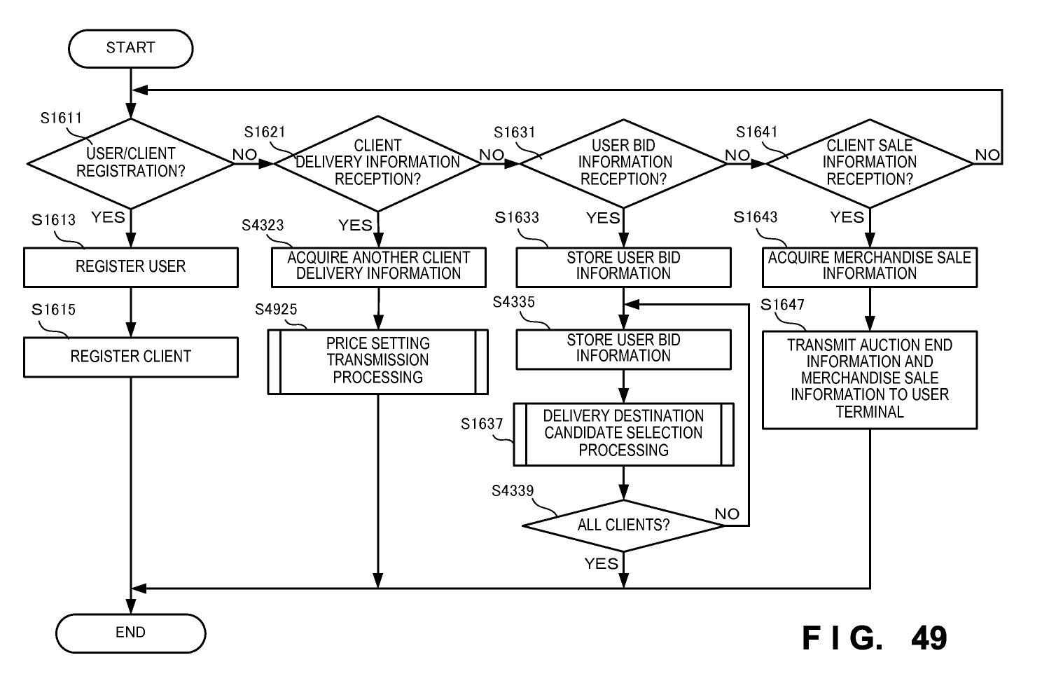

FIG. 49 is a flowchart showing the processing procedure of the cloud server 4610 according to this embodiment. Note that the same step numbers as in FIGS. 16 and 43 denote the same steps in FIG. 49, and a description thereof will be omitted.

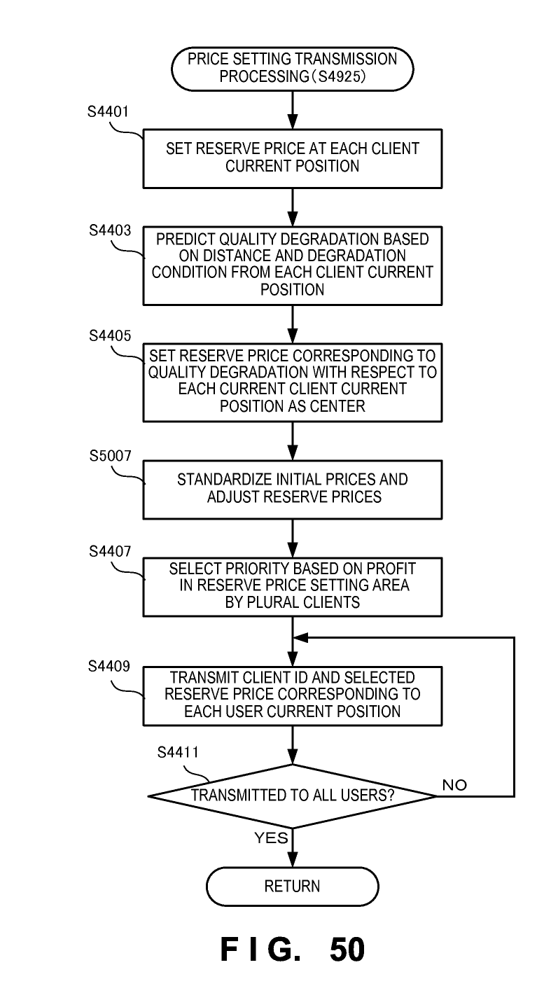

Upon determining to receive delivery information from a client, the cloud server 4610 acquires the delivery information of another client (merchandise delivery van) that delivers the same merchandise in step S4323. In step S4925, the cloud server 4610 executes price setting transmission processing according to this embodiment (see FIG. 50).

(Price Standardization Processing)

FIG. 50 is a flowchart showing the procedure of price setting transmission processing (S4925) according to this embodiment. The same step numbers as in FIG. 44 denote the same steps in FIG. 50, and a description thereof will be omitted.

In step S5007, the cloud server 4610 standardizes initial prices and adjusts the reserve prices. In step S4407, the cloud server 4610 selects priority of a plurality of clients of different companies.

### 10th Embodiment

An information processing system according to the 10th embodiment of the present invention will be described next. The information processing system according to this embodiment is different from the second to ninth embodiments in that a user can participates simultaneously in the auctions of a plurality of merchandise delivery vans or merchandise providers. The rest of the components and operations is the same as in the second to ninth embodiments. Hence, the same reference numerals denote the same components and operations, and a detailed description thereof will be omitted.

According to this embodiment, since the user can make a bid by combining the balances between a desired prices and qualities while selecting a plurality of auctions, it is possible to do merchandise delivery that meets the user's request and achieves a higher level of satisfaction.

<<Concept of Information Processing System>>

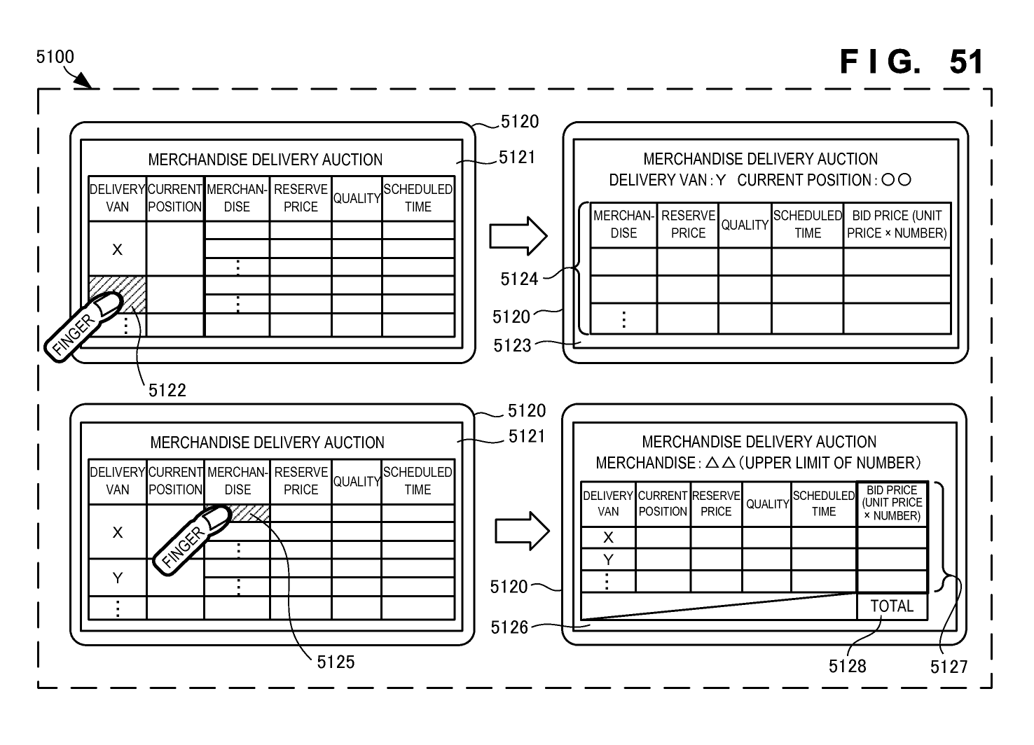

FIG. 51 is a view for explaining the concept of an auction in an information processing system 5100 according to this embodiment.

Referring to FIG. 51, the upper stage shows an example in which when the auctions of a plurality of merchandise delivery vans are displayed on a user terminal 5120, the user selects a merchandise delivery van and participates in the auctions of a plurality of pieces of merchandise. On the other hand, the lower stage shows an example in which when the user selects merchandise and participates in the auctions of a plurality of merchandise delivery vans.

In the left view of the upper stage of FIG. 51, a display screen 5121 of the user terminal 5120 presents information necessary to make bids in the auctions of a plurality of pieces of merchandise by a plurality of merchandise delivery vans. When a finger 5122 of the user touches one of the merchandise delivery vans, a display screen 5123 displays the list of auction bid conditions 5124 of merchandise loaded on the selected merchandise delivery van (Y in this example), as shown in the right view of the upper stage, and the user inputs a bid price and participates in the auction. In this example, the user can select a more reliable merchandise delivery van.

In the left view of the lower stage of FIG. 51, the display screen 5121 of the user terminal 5120 presents information necessary to make bids in the auctions of a plurality of pieces of merchandise by a plurality of merchandise delivery vans, like the upper stage. When a finger 5125 of the user touches one of the pieces of merchandise, the list of auction bid conditions 5127 is displayed for the plurality of merchandise delivery vans on which the selected merchandise is loaded, as shown in the right view of the lower stage, and the user inputs a bid price and participates in the auction. The user can also acquire a desired number of merchandise by changing quality or price. A total 5128 is displayed to prevent the user from making a bid for merchandise more than necessary. In this example, the user can select merchandise of not the same quality but various qualities in accordance with the application purpose.

<<Functional Arrangement of Cloud Server>>

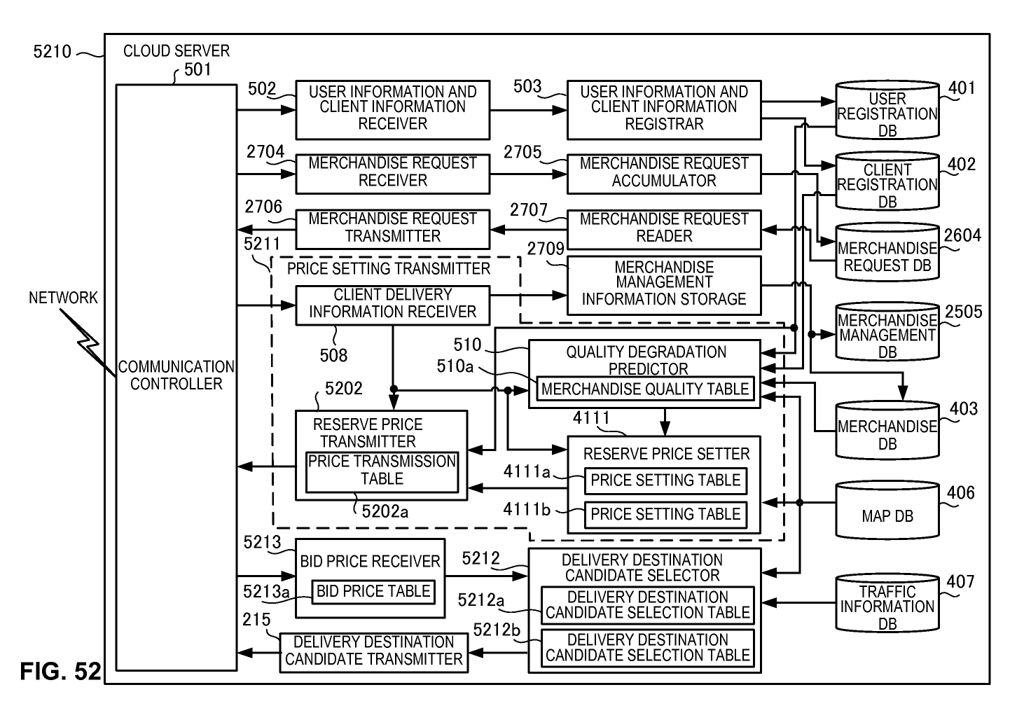

FIG. 52 is a block diagram showing the functional arrangement of the cloud server 5210 according to this embodiment. Note that the same reference numerals as in FIG. 41 denote the same functional components in FIG. 52, and a description thereof will be omitted.

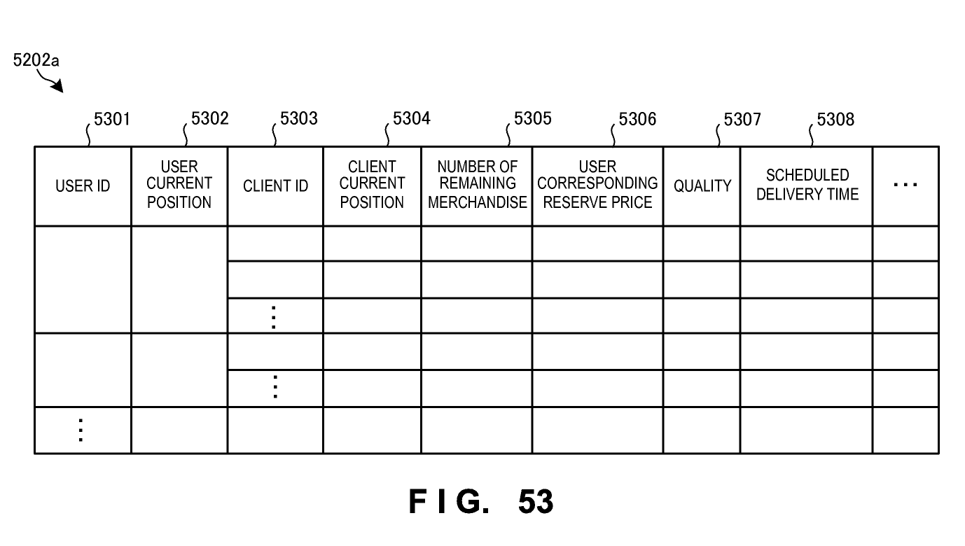

A price setting receiver 5211 includes a reserve price transmitter 5202 including a price transmission table 5202a (see FIG. 53). The price setting receiver 5211 transmits all reserve prices set for a user by a reserve price setter 4111 to the user on the basis of merchandise delivery vans and merchandise.

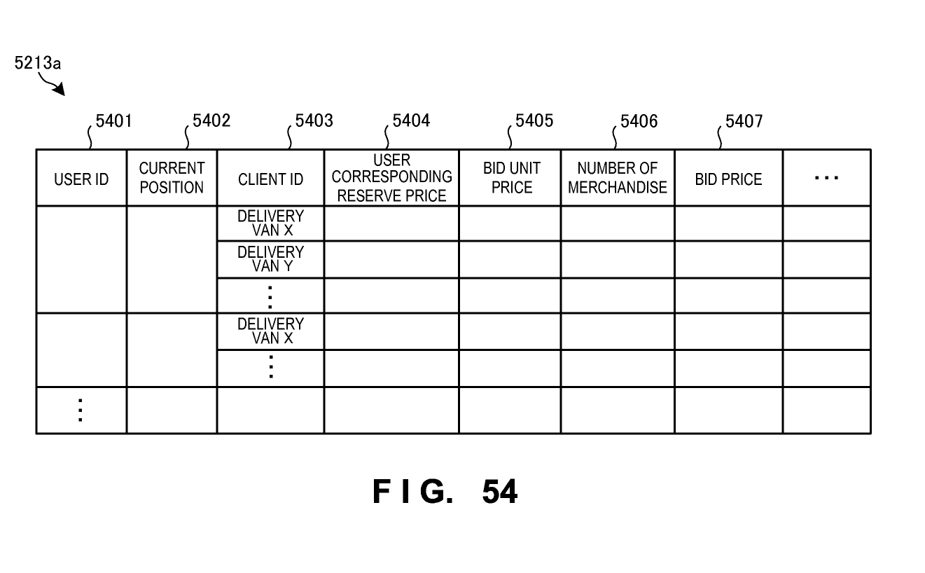

A bid price receiver 5213 includes a bid price table 5213a (see FIG. 54). The bid price receiver 5213 stores bids from a plurality of users to a plurality of merchandise delivery vans and sends them to a delivery destination candidate selector 5212. The delivery destination candidate selector 5212 includes a plurality of delivery destination candidate selection tables 5212a, 5212b, . . . , corresponding to the plurality of merchandise delivery vans, and selects the delivery destination candidates of the merchandise delivery vans in parallel. Note that the individual delivery destination candidate selection tables are similar to that in FIG. 14 and are not illustrated here.

(Price Transmission Table)

FIG. 53 is a view showing the arrangement of the price transmission table 5202a according to this embodiment. The price transmission table 5202a is used to allow each user to make bids for a plurality of clients.

The price transmission table 5202a stores a plurality of client IDs 5303 in association with a user ID 5301 and a user current position 5302. The price transmission table 5202a stores a client current position 5304, a number 5305 of remaining merchandise, a reserve price 5306 corresponding to the user, quality 5307 of merchandise, and a scheduled delivery time 5308 in association with each client ID 5303. This information is displayed on, for example, the display screen 5121 in FIG. 52.

(Bid Price Table)

FIG. 54 is a view showing the arrangement of the bid price table 5213a according to this embodiment. The bid price table 5213a is used to accept bids from each user to a plurality of clients in correspondence with the price transmission table 5202a.

The bid price table 5213a stores a plurality of client IDs 5403 in association with a user ID 5401 and a user current position 5402. The bid price table 5213a stores a reserve price 5404 corresponding to the user, a bid unit price 5405, a number 5406 of merchandise, and a bid price 5407 in association with each client ID 5403. Note that the bid price 5407 is the product of the input unit price 5405 and the number 5406 of merchandise. The bid unit price 5405 needs to exceed the reserve price 5404.

### 11th Embodiment

An information processing system according to the 11th embodiment of the present invention will be described next. The information processing system according to this embodiment is different from the second to 10th embodiments in that a price setting history and a bid and highest bid price history according to this embodiment are accumulated, and a region where inexpensive high-quality merchandise can be acquired is selected. The rest of the components and operations is the same as in the second or fifth embodiment. Hence, the same reference numerals denote the same components and operations, and a detailed description thereof will be omitted.

According to this embodiment, it is possible to propose an appropriate location to a user who wants inexpensive high-quality merchandise, as in the food service industry, based on the price setting history and the bid and highest bid price history according to this embodiment.

<<Explanation of Information Processing System>>

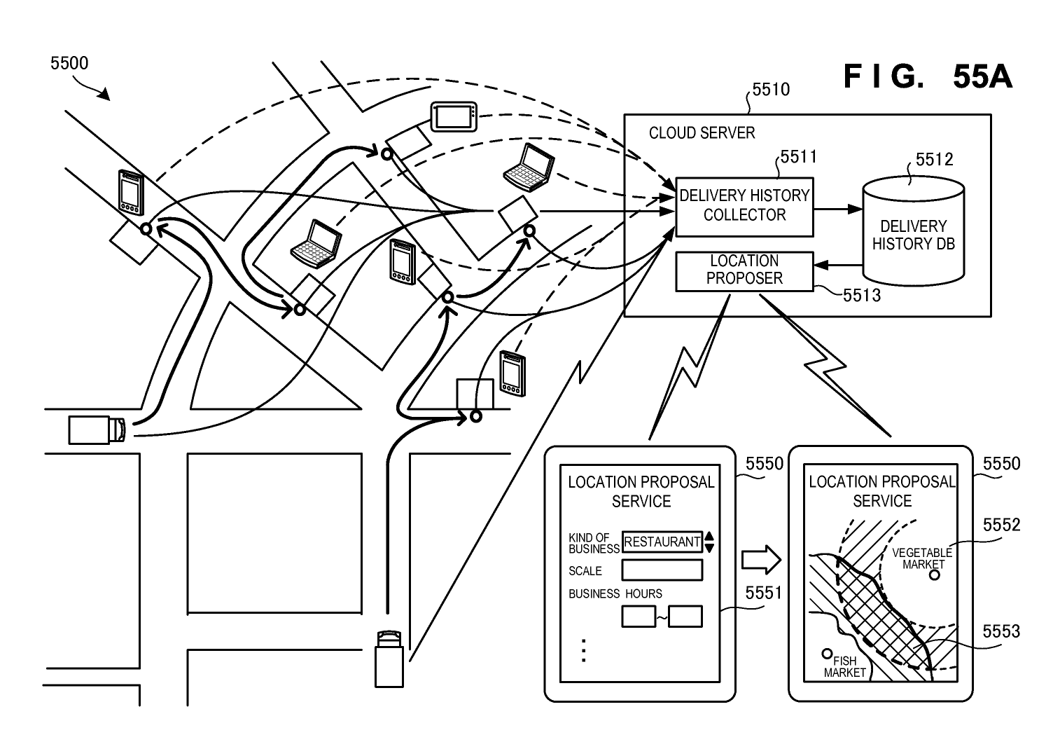

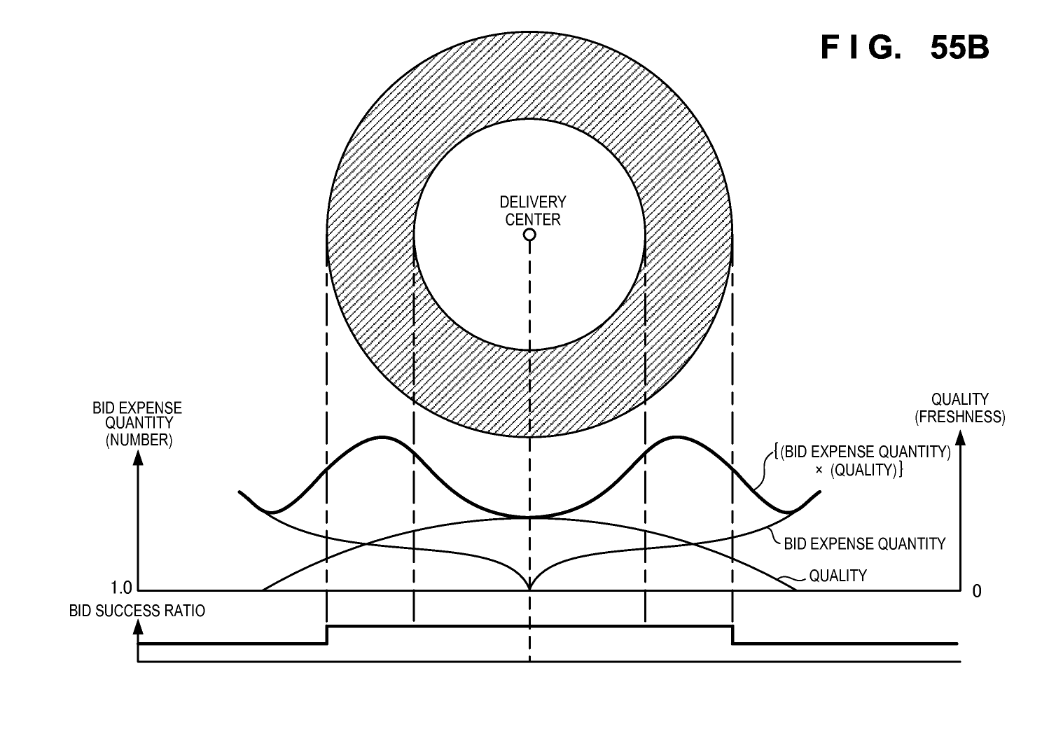

The information processing system according to this embodiment will be described below with reference to FIGS. 55A and 55B.

(Concept of Information Processing System)

FIG. 55A is a view for explaining the concept of an information processing system 5500 according to this embodiment.

In the information processing system 5500, a cloud server 5510 executes the above-described merchandise delivery auction and causes a delivery history collector 5511 to accumulate a delivery history during that time in a delivery history DB 5512. When consulted by a user terminal 5550 about an industrial location where merchandise that causes quality degradation is used, the information processing system refers to the delivery history DB 5512 and causes a location proposer 5513 to propose a location condition to the user terminal 5550.

Referring to FIG. 55A, the cloud server 5510 is consulted about the location condition of a “family restaurant from a display screen 5551 of the user terminal 5550. The family restaurant uses many foods (meat, sea foods, vegetables, fruits, and the like) that cause quality degradation. In response to the consultation, the location proposer 5513 of the cloud server 5510 returns a display screen 5552 of location proposal to the user terminal 5550. The display screen 5552 displays a fish market and a vegetable market each serving as a delivery center on a map, and presents a region obtained from the delivery history where high-quality merchandise can be obtained at a low cost. Here, a region 5553 where suitable areas from both the delivery center of the fish market and that of the vegetable market overlap is displayed as a preferable location range. Note that the area where high-quality merchandise can be obtained at a low cost is not limited to the shape shown in FIG. 55A.

(Location Condition)

FIG. 55B is a view for explaining a location condition in the information processing system 5500 according to this embodiment. Note that FIG. 55B is a sensual illustration, and the shape and the like are not limited to FIG. 55B. According to the merchandise delivery auction of this embodiment, there exists an area where high-quality merchandise can be obtained inexpensively.

FIG. 55B shows quality based on the history of merchandise for which a successful bid has been made, the amount (number) of merchandise that can be obtained by the bid expense, and the bid success ratio with respect to a delivery center as the center. As can be seen obviously, in the auction according to this embodiment, the reserve price is high in a place close to the delivery center. Hence, a bid more than quality is necessary. On the other hand, in a place far apart from the delivery center, the merchandise is available at a low cost, although the quality degrades more. In addition, the delivery expense is included, and the merchandise is delivered to a user of high profit for the client (merchandise delivery van). Hence, the merchandise is delivered to a user who is located not so far apart from the delivery center.

Considering these conditions, there exists a doughnut-shaped area about the delivery center where high-quality merchandise can be obtained at a low cost, as shown in FIG. 55B. The shape can be presented more finely by collecting the histories accumulated in the delivery history DB 5512.

<<Arrangement of Information Processing System>>

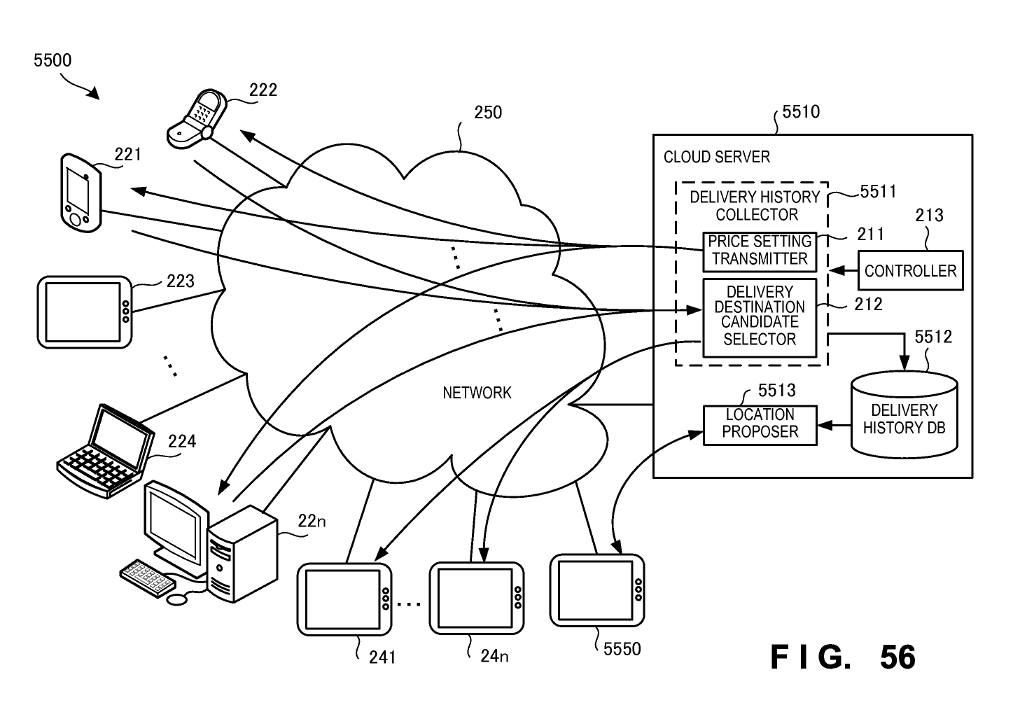

FIG. 56 is a block diagram showing the arrangement of the information processing system 5500 according to this embodiment. The same reference numerals as in FIG. 3 denote the same functional elements in FIG. 56, and a description thereof will be omitted.

The cloud server 5510 includes the delivery history collector 5511 including a price setting transmitter 211 and a delivery destination selector 212 shown in FIG. 2A. The cloud server 5510 also includes a controller 213. The cloud server 5510 also includes the delivery history DB 5512 that accumulates a delivery history. The cloud server 5510 also includes the location proposer 5513. The user terminal 5550 that queries the cloud server 5510 about location information via a network 250 is provided.

<<Operation Procedure of Information Processing System>>

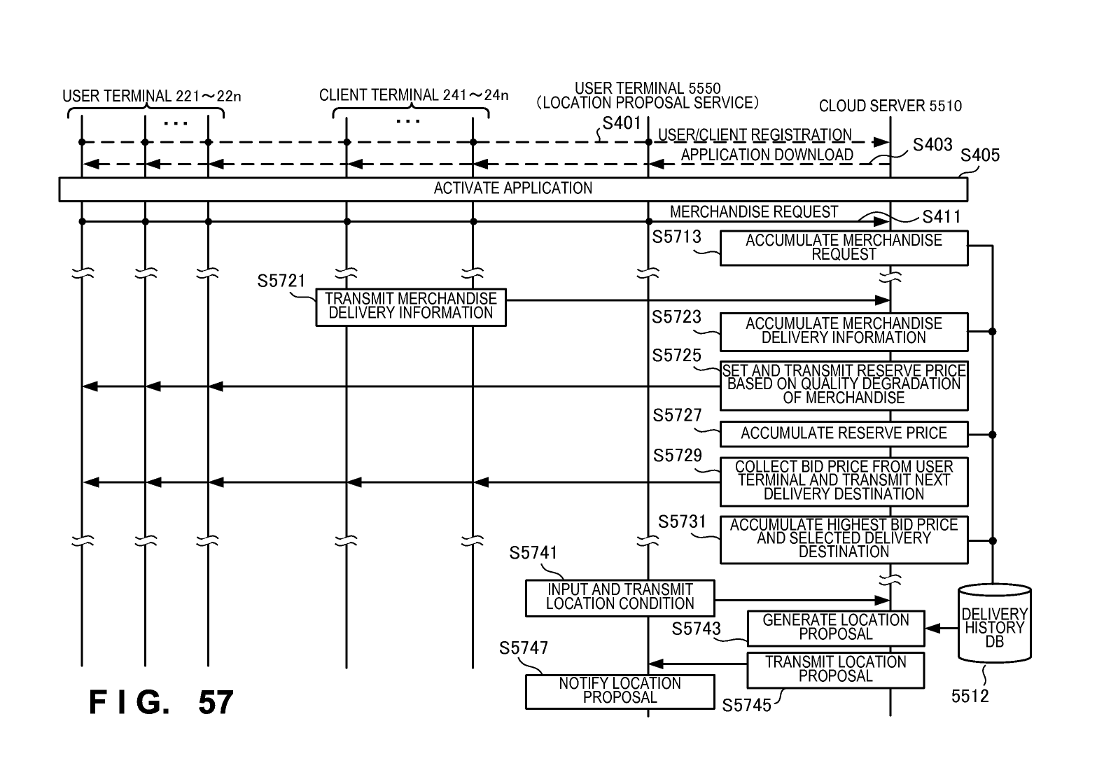

FIG. 57 is a sequence chart showing the operation procedure of the information processing system 5500 according to this embodiment. Note that in FIG. 57, the operation procedures of merchandise delivery bid and auction illustrated in FIGS. 4A to 4D and other sequence charts are simplified.

In step S5713, the cloud server 5510 accumulates a merchandise request from the user in the delivery history DB 5512. When a plurality of client terminals 241 to 24n transmit merchandise delivery information to the cloud server 5510 in step S5721, the cloud server 5510 accumulates the merchandise delivery information in the delivery history DB 5512 in step S5723. In step S5725, the cloud server 5510 sets and transmits a reserve price based on merchandise degradation prediction. In step S5727, the cloud server 5510 accumulates the reserve price in the delivery history DB 5512. In step S5729, the cloud server 5510 collects bid prices from user terminals 221 to 22n, selects the next delivery destination, and transmits it. In step S5731, the cloud server 5510 accumulates the highest bid price and the selected delivery destination in the delivery history DB 5512.

After that, in step S5741, the user terminal 5550 inputs a location condition and transmits it to the cloud server 5510. In step S5743, the cloud server 5510 generates a location proposal by referring to the information accumulated in the delivery history DB 5512. In step S5745, the cloud server 5510 transmits the location proposal to the user terminal 5550. In step S5747, the user terminal 5550 notifies the user of the location proposal received from the cloud server 5510.

<<Functional Arrangement of Cloud Server>>

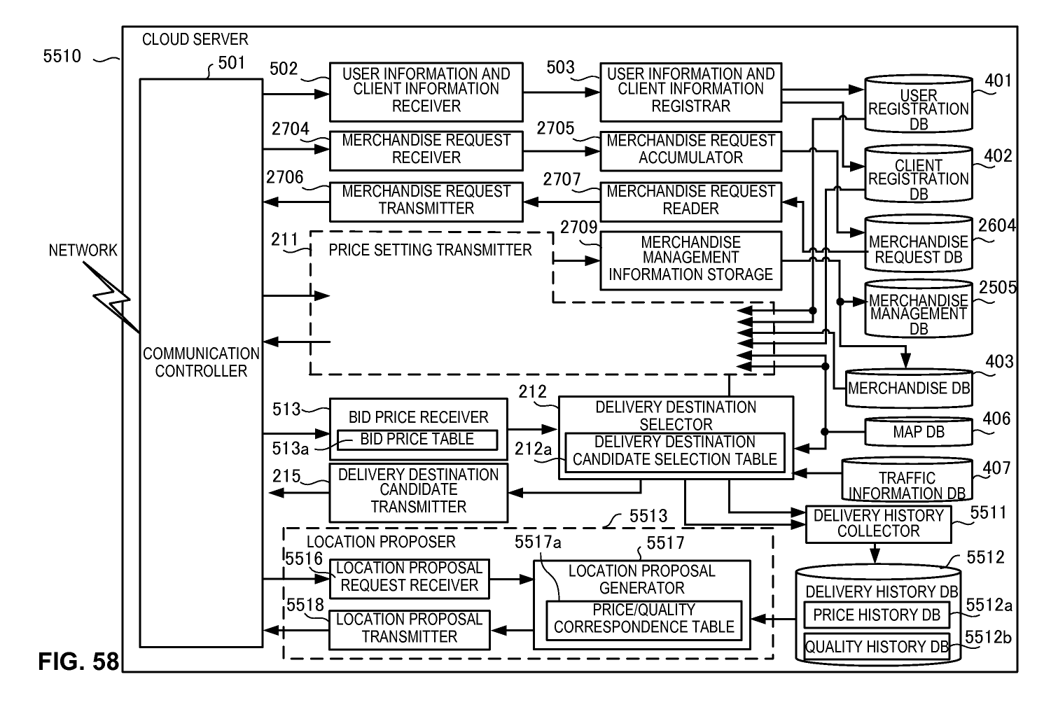

FIG. 58 is a block diagram showing the functional arrangement of the cloud server 5510 according to this embodiment. The same reference numerals as in FIG. 5 or 27 denote the same functional components in FIG. 58, and a description thereof will be omitted. Note that in FIG. 58, the functional components illustrated in FIG. 5 are simplified.

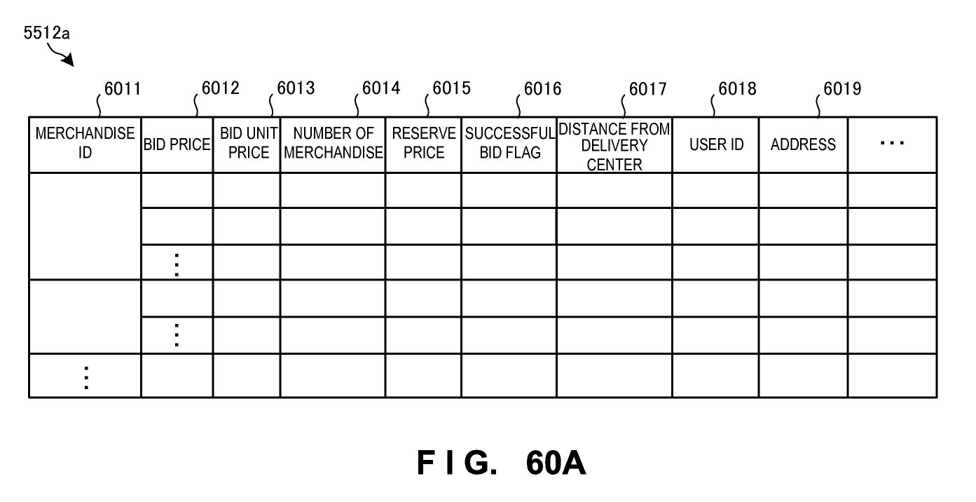

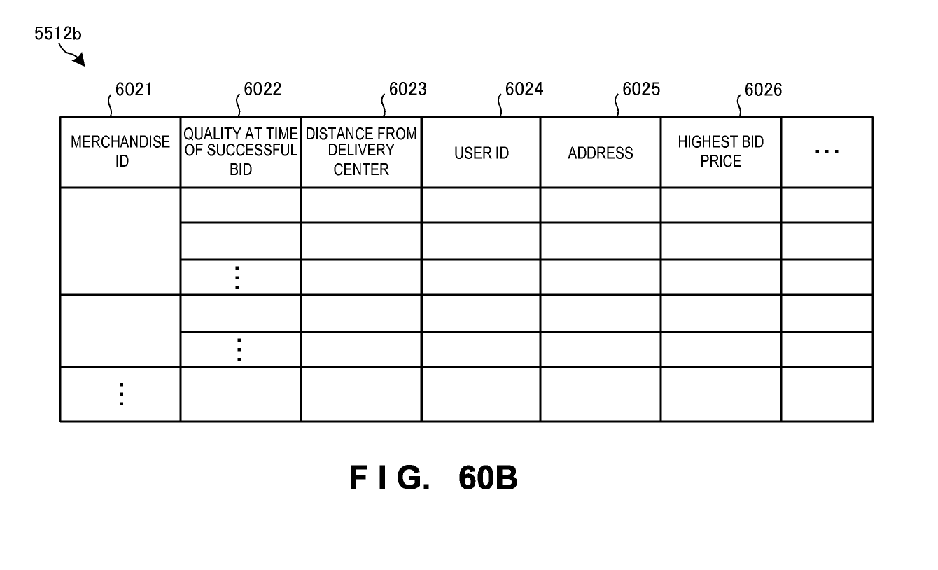

The delivery history collector 5511 collects delivery histories from the price setting transmitter 211 and the delivery destination selector 212 and accumulates them in the delivery history DB 5512. The delivery history DB 5512 accumulates at least a price history DB 5512a (see FIG. 60A) and a quality history DB 5512b (see FIG. 60B) in association with each other.

The location proposer 5513 includes a location proposal request receiver 5516, a location proposal generator 5517 including a price/quality correspondence table 5517a, and a location proposal transmitter 5518. The location proposal request receiver 5516 receives a location proposal request from the user terminal 5550 via a communication controller 501. The location proposal generator 5517 generates a location proposal responding to the location proposal request using the price/quality correspondence table 5517a while referring to the delivery history DB 5512. The location proposal transmitter 5518 transmits the location proposal generated by the location proposal generator 5517 to the user terminal 5550.

<<Functional Arrangement of User Terminal>>

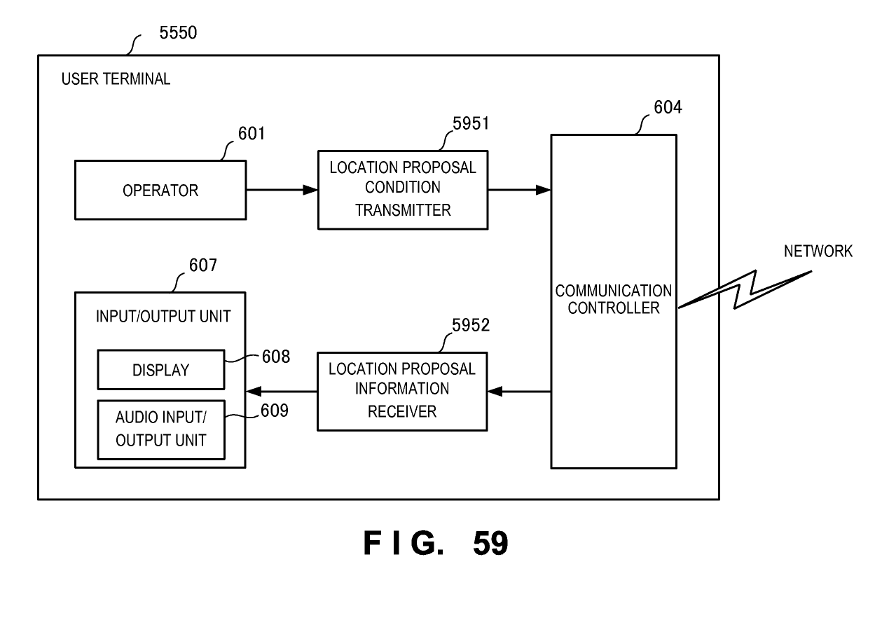

FIG. 59 is a block diagram showing the functional arrangement of the user terminal 5550 according to this embodiment. Note that the same reference numerals as in FIG. 6 denote the same functional components in FIG. 59, and a description thereof will be omitted.

A location proposal condition transmitter 5951 transmits a location proposal condition as a location proposal request to the cloud server 5510 via a communication controller 604 in accordance with an operation from an operator 601. A location proposal information receiver 5952 receives location proposal information transmitted from the cloud server 5510 via the communication controller 604 and displays it on a display 608.

(Price History DB)

FIG. 60A is a view showing the arrangement of the price history DB 5512a according to this embodiment. Note that the arrangement of the price history DB 5512a is not limited to FIG. 60A.

The price history DB 5512a stores a plurality of bid prices 6012 in correspondence with a merchandise ID 6011. The price history DB 5512a stores an bid unit price 6013, a number 6014 of merchandise, a reserve price 6015, a successful bid flag 6016 representing whether the bid has succeeded, a distance 6017 from the delivery center, a user ID 6018, an address 6019, and the like in association with each bid price 6012.

(Quality History DB)

FIG. 60B is a view showing the arrangement of the quality history DB 5512b according to this embodiment. Note that the arrangement of the quality history DB 5512b is not limited to FIG. 60B.

The quality history DB 5512b stores a plurality of qualities 6022 at the time of successful bid in correspondence with a merchandise ID 6021. The quality history DB 5512b stores a distance 6023 from the delivery center, a user ID 6024, an address 6025, a highest bid price 6026, and the like in association with each quality 6022 at the time of successful bid.

(Price/Quality Correspondence Table)

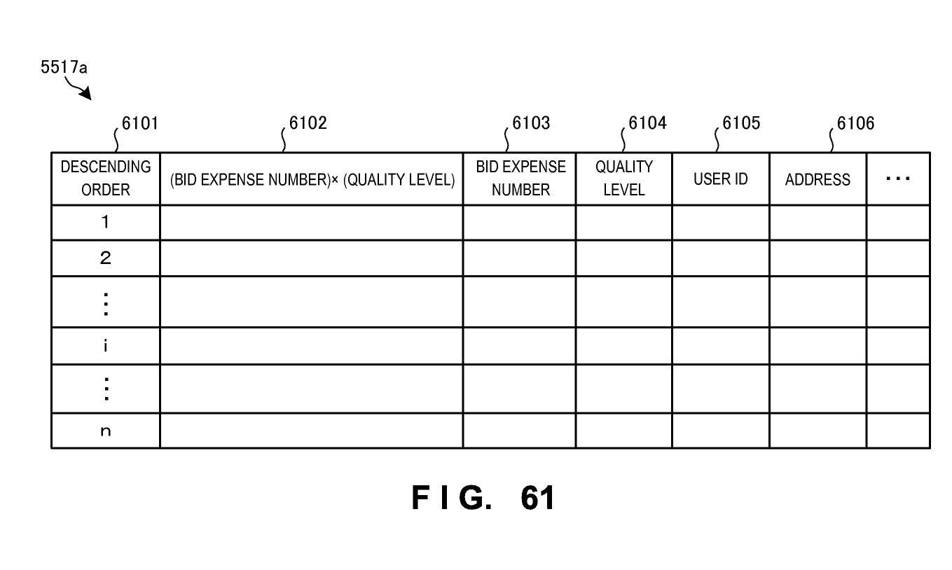

FIG. 61 is a view showing the arrangement of the price/quality correspondence table 5517a according to this embodiment. The price/quality correspondence table 5517a is used to sort indices representing that the user makes a successful bid for sufficient quality at a low cost in descending order and determine which region has a large index.

The price/quality correspondence table 5517a stores a value 6102 of (bid expense number)×(quality level), which is sorted in descending order 6101. Note that the index is merely an example and is not limited to this. The bid expense number is a numerical value the number of merchandise that can be purchased by the bid expense. The price/quality correspondence table 5517a stores a bid expense number 6103, a quality level 6104, a user ID 6105, an address 6106, and the like.

<<Processing Procedure of Cloud Server>>

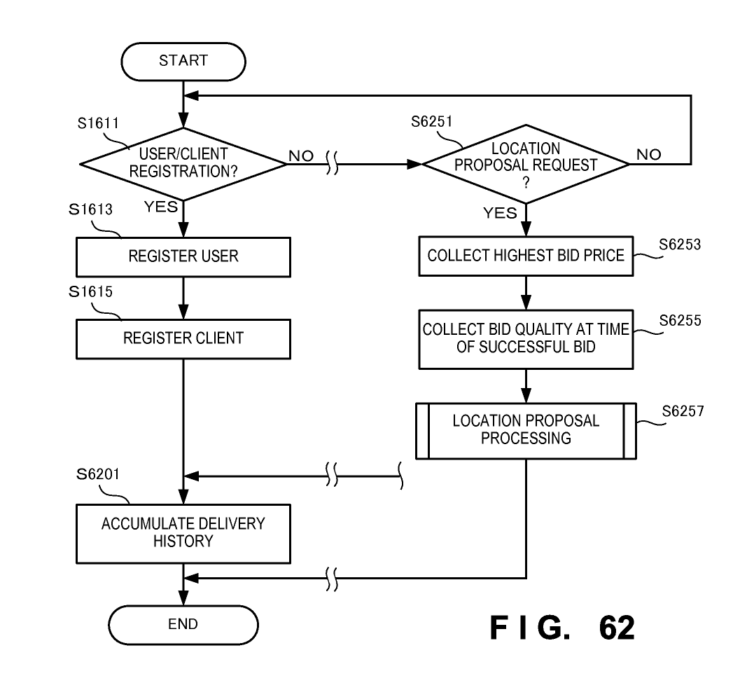

FIG. 62 is a flowchart showing the processing procedure of the cloud server 5510 according to this embodiment. Note that the same step numbers as in FIG. 16 denote the same steps in FIG. 62, and a description thereof will be omitted. In addition, the procedure of merchandise request, delivery information reception, or the like is the same as in FIG. 16, and are not illustrated in FIG. 62.

After exchange of each information, the cloud server 5510 accumulates each information in the delivery history DB 5512 as a delivery history in step S6201.

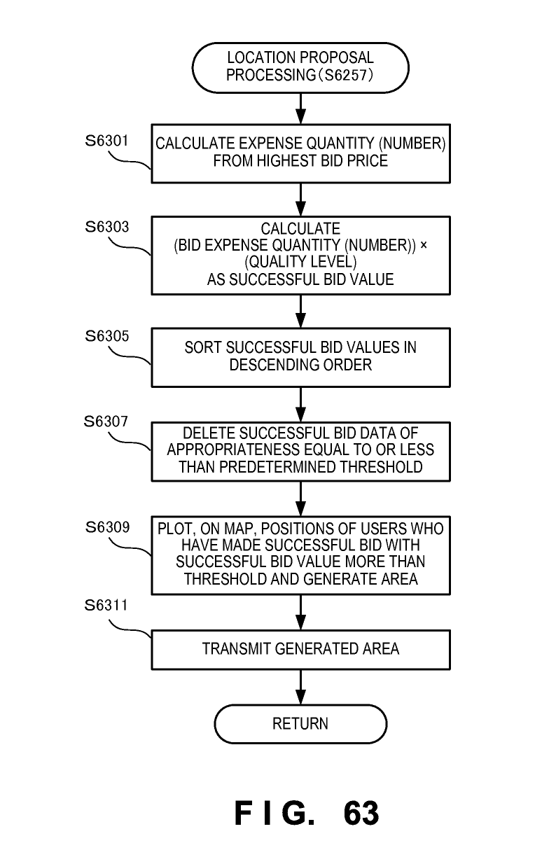

In step S6251, the cloud server 5510 determines whether to receive a location proposal request. To receive a location proposal request, the cloud server 5510 advances to step S6253 and collects a highest bid price from the delivery history DB 5512. In step S6255, the cloud server 5510 collects bid quality at the time of successful bid from the delivery history DB 5512. In step S6257, the cloud server 5510 executes location proposal processing (see FIG. 63).

(Location Proposal Processing)

FIG. 63 is a flowchart showing the procedure of location proposal processing (S6257) according to this embodiment.

In step S6301, the cloud server 5510 calculates an expense quantity (number) from the highest bid price as one index. In step S6303, the cloud server 5510 calculates (bid expense number (quantity))×(quality level) as an appropriate numerical value (successful bid value) that can satisfy the user. In step S6305, the cloud server 5510 sorts the successful bid values in descending order. Next, the cloud server 5510 deletes successful bid data of successful bid values equal to or less than a predetermined threshold. In step S6309, the cloud server 5510 plots, on a map, the positions of users who have made a successful bid with a successful bid value more than the threshold. The cloud server 5510 generates an area where the points are densely plotted as a location proposal area. In step S6311, the cloud server 5510 transmits the generated area to the user terminal 5550 together with the map data.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when a control program for implementing the functions of the embodiments is supplied to the system or apparatus directly or from a remote site. Hence, the present invention also incorporates the control program installed in a computer to implement the functions of the present invention on the computer, a medium storing the control program, and a WWW (World Wide Web) server that causes a user to download the control program.

This application claims the benefit of Japanese Patent Application No. 2012-156934 filed on Jul. 12, 2012, which is hereby incorporated by reference herein in its entirety.

What is claimed is:

1. An information processing apparatus comprising:
a first receiver that receives a current position of merchandise from a communication terminal used for delivery of the merchandise;
a first transmitter that transmits, to a communication terminal of each user, a reserve price representing a lower limit of a bid price according to prediction of quality degradation caused by delivery of the merchandise predicted based on a current position of each user and the received current position of the merchandise;
a selector that receives bid prices for the merchandise from communication terminals of a plurality of users and selects a delivery destination candidate; and
a second transmitter that transmits the selected delivery destination candidate to the communication terminal located at the current position of the merchandise.

2. The information processing apparatus according to claim 1, further comprising a controller that controls to repeat, along an elapse of delivery time, reception of the current position of the merchandise by said first receiver, transmission of the reserve price by said first transmitter, selection of the delivery destination candidate by said selector, and transmission of the delivery destination candidate by said second transmitter.

3. The information processing apparatus according to claim 1, wherein said selector selects, as the delivery destination candidate, the current position of the user providing largest predicted profit obtained by subtracting at least a cost price and a delivery expense of the merchandise from the bid price.

4. The information processing apparatus according to claim 1, wherein said first transmitter performs the prediction of quality degradation of the merchandise, based on a kind of the merchandise, an environment surrounding the merchandise, and prediction of the delivery time from the current position of the merchandise to the current position of the user, using quality at the current position of the merchandise as a reference, and sets the reserve price lower as the predicted delivery time becomes longer.

5. The information processing apparatus according to claim 4, wherein said first transmitter performs the prediction of quality degradation of the merchandise in consideration of a traffic situation of a delivery route from the current position of the merchandise to the current position of the user.

6. The information processing apparatus according to claim 4, further comprising a second receiver that receives a quality of the merchandise from the communication terminal used for delivery of the merchandise,
wherein the quality of the merchandise at the current position is the quality received by said second receiver.

7. The information processing apparatus according to claim 2, wherein said selector does not change the delivery destination candidate when a newly selected delivery destination candidate is spaced apart from the delivery route of the merchandise to the delivery destination candidate by a distance more than a first threshold.

8. The information processing apparatus according to claim 2, wherein said controller decides the delivery destination candidate as a sale destination and notifies the user of stop of a bid, when a delivery distance to the delivery destination candidate is shorter than a second threshold or when the predicted delivery time to the delivery destination candidate is shorter than a third threshold.

9. The information processing apparatus according to claim 1, wherein said first transmitter controls not to transmit the reserve price to the communication terminal of the user located at a position where the quality of the merchandise is predicted not to be higher than a fourth threshold.

10. The information processing apparatus according to claim 2, wherein when the merchandise comprises a plurality of pieces of merchandise, or when the merchandise is sold on a quantity basis,
said controller stops repetition, notifies the user of the stop of the bid, deletes the bid price of the delivery destination candidate set as the sale destination, and resumes repetition based on a new current position of the merchandise, in a case where the delivery destination candidate is set as the sale destination of the merchandise.

11. The information processing apparatus according to claim 10, wherein the reserve price set by said first transmitter is one of a unit price of the merchandise and a price of a unit quantity, and
the bid price of the merchandise received by said selector is one of a price obtained by integrating the unit price of the merchandise and the number of merchandise and a price of a purchased quantity of the merchandise.

12. The information processing apparatus according to claim 1, wherein when pieces of merchandise are located at a plurality of different current positions,
said first transmitter sets a plurality of reserve prices for each user based on the plurality of current positions and the quality of the merchandise, but controls not to transmit the reserve price set lower to the user.

13. The information processing apparatus according to claim 1, further comprising:
an accumulator that accumulates at least a history of the bid price of the merchandise transmitted from the communication terminal of the user of the delivery destination selected by said selector and a history of the quality of the merchandise purchased by the user in association with each other;
a calculator that calculates a successful bid value of the merchandise in association with a position on a map based on the history of the bid price of the merchandise and the history of the quality of the merchandise; and
a generator that generates an area on the map where the successful bid value of the merchandise exceeds a fifth threshold.

14. A control method of an information processing apparatus, comprising:
receiving a current position of merchandise from a communication terminal used for delivery of the merchandise;
transmitting, to a communication terminal of each user, a reserve price representing a lower limit of a bid price according to prediction of quality degradation caused by delivery of the merchandise predicted based on a current position of each user and the received current position of the merchandise;
receiving bid prices for the merchandise from communication terminals of a plurality of users and selecting a delivery destination candidate; and
transmitting the selected delivery destination candidate to the communication terminal located at the current position of the merchandise.

15. A storage medium storing a control program of an information processing apparatus, which causes a computer to execute:
receiving a current position of merchandise from a communication terminal used for delivery of the merchandise;
transmitting, to a communication terminal of each user, a reserve price representing a lower limit of a bid price according to prediction of quality degradation caused by delivery of the merchandise predicted based on a current position of each user and the received current position of the merchandise;
receiving bid prices for the merchandise from communication terminals of a plurality of users and selecting a delivery destination candidate; and
transmitting the selected delivery destination candidate to the communication terminal located at the current position of the merchandise.

16. An information processing apparatus comprising:
an acquirer that acquires a current position of merchandise under delivery;
a transmitter that sets a first reserve price representing a lower limit of a bid price in accordance with quality degradation of the merchandise caused by delivery, which is predicted based on a current position of each user and the acquired current position of the merchandise and transmits the first reserve price to a communication terminal of each user;
a selector that receives bid prices for the merchandise from communication terminals of a plurality of users and selects a delivery destination candidate based on the bid prices; and
a notifier that notifies the selected delivery destination candidate.

17. The information processing apparatus according to claim 16, further comprising a controller that controls to repeat acquisition of the current position of the merchandise by said acquirer, transmission of the reserve price by said transmitter, selection of the delivery destination candidate by said selector, and notification of the delivery destination candidate by said notifier.

18. The information processing apparatus according to claim 16, further comprising a detector that detects quality of the merchandise,
wherein said transmitter predicts quality degradation caused by delivery of the merchandise using a quality of the merchandise detected by said detector as a reference.

19. The information processing apparatus according to claim 16, further comprising a receiver that receives, from an information processing apparatus different from the information processing apparatus, a second reserve price representing the lower limit of the bid price set in accordance with another current position of the merchandise in association with the current position of each user,
wherein said transmitter controls not to transmit the first reserve price to the communication terminal of the user when the first reserve price is lower than the second reserve price received by said receiver.

20. A control method of an information processing apparatus, comprising:
acquiring a current position of merchandise under delivery;
setting a first reserve price representing a lower limit of a bid price in accordance with quality degradation of the merchandise caused by delivery, which is predicted based on a current position of each user and the acquired current position of the merchandise and transmitting the first reserve price to a communication terminal of each user;
receiving bid prices for the merchandise from communication terminals of a plurality of users and selecting a delivery destination candidate based on the bid prices; and
notifying the selected delivery destination candidate.

21. A storage medium storing control program of an information processing apparatus, which causes a computer to execute:
acquiring a current position of merchandise under delivery;
setting a first reserve price representing a lower limit of a bid price in accordance with quality degradation of the merchandise caused by delivery, which is predicted based on a current position of each user and the acquired current position of the merchandise and transmitting the first reserve price to a communication terminal of each user;
receiving bid prices for the merchandise from communication terminals of a plurality of users and selecting a delivery destination candidate based on the bid prices; and
notifying the selected delivery destination candidate.

22. An information processing system including communication terminals of a plurality of users, a communication terminal used for delivery of merchandise, and an information processing apparatus configured to manage delivery of the merchandise,
said information processing apparatus comprising:
a first receiver that receives a current position of the merchandise from said communication terminal used for delivery of the merchandise;
a first transmitter that transmits, to a communication terminal of each user, a reserve price representing a lower limit of a bid price according to prediction of quality degradation caused by delivery of the merchandise predicted based on a current position of each user and the received current position of the merchandise;
a selector that receives bid prices for the merchandise from said communication terminals of the plurality of users and selects a delivery destination candidate; and
a second transmitter that transmits the selected delivery destination candidate to said communication terminal located at the current position of the merchandise,
said communication terminal used for delivery of the merchandise comprising:
a third transmitter that transmits the current position of the merchandise to said information processing apparatus; and
a second receiver that receives the delivery destination candidate selected by said selector from said information processing apparatus, and
each of said communication terminals of the plurality of users comprising:
a third receiver that receives the set reserve price from said information processing apparatus; and
a fourth transmitter that transmits the bid price input by the user to said information processing apparatus.

23. An information processing method of an information processing system including communication terminals of a plurality of users, a communication terminal used for delivery of merchandise, and an information processing apparatus configured to manage delivery of the merchandise,
the information processing apparatus comprising:
receiving a current position of the merchandise from the communication terminal used for delivery of the merchandise;
transmitting, to a communication terminal of each user, a reserve price representing a lower limit of a bid price according to prediction of quality degradation caused by delivery of the merchandise predicted based on a current position of each user and the received current position of the merchandise;
receiving bid prices for the merchandise from the communication terminals of the plurality of users and selecting a delivery destination candidate; and
transmitting the selected delivery destination candidate to the communication terminal located at the current position of the merchandise,
the communication terminal used for delivery of the merchandise comprising:
transmitting the current position of the merchandise to the information processing apparatus; and
receiving the delivery destination candidate selected by the selector from the information processing apparatus, and
each of the communication terminals of the plurality of users comprising:
receiving the set reserve price from the information processing apparatus; and
transmitting the bid price input by the user to the information processing apparatus.

24. An information processing system including communication terminals of a plurality of users, and an information processing apparatus used for delivery of merchandise and configured to manage delivery of the merchandise,
said information processing apparatus comprising:
an acquirer that acquires a current position of the merchandise under delivery;
a transmitter that sets a first reserve price representing a lower limit of a bid price in accordance with quality degradation of the merchandise caused by delivery, which is predicted based on a current position of each user and the acquired current position of the merchandise and transmits the first reserve price to a communication terminal of each user;
a selector that receives bid prices for the merchandise from said communication terminals of the plurality of users and selects a delivery destination candidate based on the bid prices; and
a notifier that notifies the selected delivery destination candidate, and
each of said communication terminals of the plurality of users comprising:
a second receiver that receives the set reserve price from said information processing apparatus; and
a third transmitter that transmits the bid price input by the user to said information processing apparatus.

25. An information processing method of an information processing system including communication terminals of a plurality of users, and an information processing apparatus used for delivery of merchandise and configured to manage delivery of the merchandise,
the information processing apparatus comprising:
acquiring a current position of the merchandise under delivery;
setting a first reserve price representing a lower limit of a bid price in accordance with quality degradation of the merchandise caused by delivery, which is predicted based on a current position of each user and the acquired current position of the merchandise and transmitting the first reserve price to a communication terminal of each user;
receiving bid prices for the merchandise from the communication terminals of the plurality of users and selecting a delivery destination candidate based on the bid prices; and
notifying the selected delivery destination candidate, and
each of the communication terminals of the plurality of users comprising:
receiving the set reserve price from the information processing apparatus; and
transmitting the bid price input by the user to the information processing apparatus.
